(19) United States
(12) Patent Application Publication
(10) Pub. No.: US 2008/0033775 A1
(43) Pub. Date: Feb. 7, 2008

(54) Method and apparatus for managing risk, such as compliance risk, in an organization

(75) Inventors: Michael A. Dawson, London (GB); Bradley E. Wears, Washington, DC (US)

Correspondence Address: FORTKORT & HOUSTON P.C., 9442 N. CAPITAL OF TEXAS HIGHWAY, ARBORETUM PLAZA ONE, SUITE 500, AUSTIN, TX, 78759, US

(73) Assignee: Promontory Compliance Solutions, LLC

(21) Appl. No.: 11/888,373

(22) Filed: Jul. 31, 2007

Related U.S. Application Data
(60) Provisional application No. 60/834,371, filed on Jul. 31, 2006.

(51) Int. Cl. G06F 9/44

(52) U.S. Cl. 705/7

(57) ABSTRACT

An apparatus for managing risk within an organization includes four modules. An enterprise builder module enables a user to enter and store data regarding one or more reporting entities within the organization. A products and services catalog module enables a user to enter and store data regarding one or more products or services within the organization and to associate each of the one or more products or services with at least one of the one or more reporting entities defined in the enterprise builder module. A compliance obligation inventory module enables a user to enter and store data regarding one or more compliance obligations and to relate each of the one or more compliance obligations to at least one product or service of the one or more products or services defined in the products and services catalog module. A compliance risk assessment module enables a user to conduct a risk assessment for unique combinations of products or services, compliance obligations and reporting units; aggregate risk assessments over an entire reporting unit; and consolidate risk assessments over multiple reporting units.

### FIELD OF THE INVENTION

The present invention relates generally to methods and apparatuses for assessing risk, such as risk associated with compliance with various laws, regulations, standards, and codes of conduct (“compliance obligations”), and more particularly to a method and apparatuses for assessing risk, such as compliance risk, associated with certain obligations in the financial services industry.

### BACKGROUND OF THE INVENTION

In recent years, financial institutions and other organizations have experienced heightened regulatory scrutiny, negative media attention, reputational damage, legal liability, and other sanctions for violations of compliance obligations and other breakdowns in controls. This, in turn, has given rise to an increased attention by regulators and corporations on the role of compliance, particularly in large, complex organizations. In addition, regulators and Boards of Directors have required corporations to increase the amount of resources they devote to compliance risk management.

Notwithstanding this increase in resources, compliance risk management is still a relatively immature discipline. Some major financial institutions, for example, have only recently created a global compliance function charged with managing compliance risk across the entire institution. As another example, some financial institutions have only recently created a “compliance committee” of the Board of Directors similar to an “audit committee,” but dedicated to overseeing compliance risk management. As still another example, the Basel Committee on Banking Supervision only recently published a final version of a high-level paper on “Compliance and the Compliance Function in Banks,” that seeks to explain the roles of Senior Management and the compliance function in managing compliance risk within a banking organization. A core aspect of compliance risk management is assessing compliance risk in an organization over time.

At the same time, compliance risk management has gotten more challenging. First, the number of compliance obligations his proliferated. Examples of proliferating regulators include the Privacy and Information Security Compliance Obligations of the Gramm-Leach-Bliley Act and the European Commission's Data Protection Directive, the Anti-Money Laundering and Counter-Terrorist Financing Obligations of the USA PATRIOT ACT and the European Commission's Third Anti-Money Laundering Directive. Second, the size range of organizations has increased as companies grow to take advantage of opportunities in a global economy and to realize economies of scale. Many organizations have tens of thousands of employees. Some have over one hundred thousand. Managing compliance obligations in such a large organization can be a significant challenge. Third, the complexity of organizations has increased. For example, the Gramm-Leach-Bliley Act repealed provisions of the Glass-Steagall Act, which prevented banks from engaging in securities businesses and vice versa. Now, however, diversified financial services companies may operate banks, broker-dealers, insurance companies, investment companies, investment advisors, and other entities, each of which is subject to differing compliance obligations. Fourth, organizations are increasingly global in their operations, increasing the number of countries with whose compliance requirements the organization must comply.

As the importance and difficulty of managing compliance risk increases, organizations have a need to better and more systematically manage their compliance obligations. This has proven difficult, as demonstrated by the large number of enforcement actions that have been brought in recent years against financial institutions and other organizations for failure to manage compliance risk. Current methods of managing compliance risks seek to overcome this difficulty by focusing on inputs. In a common method, organizations “benchmark” the amount of money they are spending, and the number of people they are hiring and training, against the amounts spent and numbers hired and trained by other organizations of similar nature and size. Other methods of managing compliance risk include directing individual business units to compile inventories of compliance obligations and to rate the risks associated with each. This method has proven unsatisfactory, however, for several reasons. First, the output is not comparable across multiple business units. This is particularly true if the organization has business units that are subject to different compliance obligations because it operates different businesses or in different geographies. This limits the usefulness of the product for regulators, senior management, or boards of directors who may be consumers of the information the risk assessment process generates. Second, the output produces results that are very difficult to quality assure. The primary way in which quality assurance can be conducted is to re-conduct the process for a sample of compliance obligations. This is time-intensive and expensive. Another limitation of the existing methods for conducting compliance risk assessments is that they rely on “flat” two-dimensional lists or databases. For example, they list compliance obligations and assess compliance risk with respect to those obligations with respect to different business units or different products, services, or activities. This provides only a limited view and imprecise view of compliance risks. These flat files or lists also make it difficult to keep track of the work papers that are associated with each compliance risk assessment component.

What is missing from current approaches to compliance risk management is a method for assessing compliance risk that facilitates a multi-dimensional assessment of compliance risk and allows compliance risks to be assessed on a consolidated basis across different categories such as business units, products, clients, customer segments, geographies, etc.

The present invention is therefore directed to the problem of developing a method and apparatus for assessing compliance risk in an organization that enables a multi-dimensional assessment of compliance risk as well as a consolidation of risk across different categories, such as business units, products, clients, customer segments, geographies and the like.

### SUMMARY OF THE INVENTION

The present invention solves these and other problems associated with assessing compliance risk in an organization by providing, inter alia, a method for assessing compliance risks that facilitates a multi-dimensional assessment of compliance risk by building an organization in a structured approach in a database, taking into account products/services as well as organizational entities, and relating in the database various compliance obligations to the appropriate entities within the organization, thereby allowing compliance risks to be assessed on a consolidated basis across different categories, such as business units, products, clients, customer segments, geographies, etc.

According to one aspect of the present invention, an apparatus for managing risk in an organization employs a relational database to store data associated with the organization and a computer-based graphical user interface to enable a user to enter data to store in the database that enables a compliance officer to evaluate the various compliance risks in the organization in a methodical and organized basis and to enter and store the evaluations along with explanatory comments. The data includes one or more risks in the organization in combination with one or more reporting entities and one or more products, services or processes.

Still other aspects of the present invention will be apparent to those of skill in this art based on the following detailed description and in light of the following drawings.

### BRIEF DESCRIPTION OF THE DRAWINGS

FIGS. 1-71 depict various screens used in an exemplary embodiment of a graphical user interface for managing compliance risk in an organization according to a first aspect of the present invention.

FIGS. 72-73 depict block diagrams for use in explaining certain aspects of the present invention.

FIGS. 74-75 depict exemplary embodiments of apparatuses for managing compliance risk in an organization according to another aspect of the present invention.

### DETAILED DESCRIPTION

It is worthy to note that any reference herein to “one embodiment” or “an embodiment” means that a particular feature, structure, or characteristic described in connection with the embodiment is included in at least one embodiment of the present invention. The appearances of the phrase “in one embodiment” in various places in the specification are not necessarily all referring to the same embodiment.

Although various embodiments are specifically illustrated and described herein, it will be appreciated that modifications and variations of the present invention are covered by the above teachings and within the purview of the appended claims without departing from the spirit and intended scope of the invention.

Managing compliance risk is difficult. Even relatively small organizations such as community banks find it challenging to keep track of their compliance obligations and accurately to assess their effectiveness over time. This is demonstrated by recent enforcement actions against community banks for compliance violations including the action against Riggs Bank, N.A., and other community banks. The problem is even more difficult for larger organizations with more diverse operations, more complicated legal organizational structures, multiple regulation by local, state, federal, regulators and by foreign regulators. Efforts to manage these risks have proven cumbersome and ineffective. Organizations need an effective way to manage compliance risk.

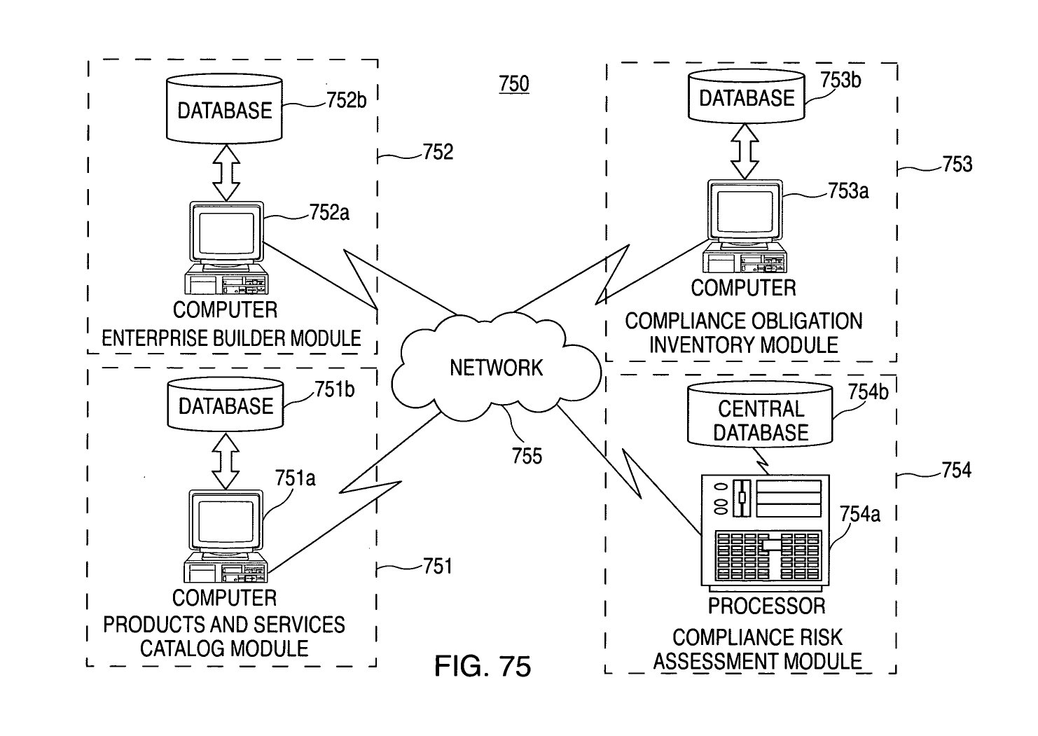

Referring to FIG. 75, according to one aspect of the present invention, an exemplary embodiment 750 of an apparatus for managing any risk, but in particular compliance risk, includes one or more of the following elements: an enterprise builder module 752; a product and services catalogue module 751; and a compliance obligation inventory module 753, which includes a method for mapping compliance obligations onto an organization. The system 750 should also include a method for assessing compliance risks, and a method for managing compliance risks by: identifying controls to mitigate compliance risks; assigning responsibility for maintaining the effectiveness of the controls, including monitoring and testing of control effectiveness; assessing the effectiveness of controls; and presenting information about a compliance program graphically to a user.

Each of the above-mentioned modules 751-753 may be included in a separate computer software program that operates on cine or more different computers in association with a database, or they may be combined into one or more programs executing on one or more computers in association with one or more databases. For simplicity purposes, FIG. 75 shows a separate computer and database for each of these modules coupled together via a network 755 to a compliance risk assessment module 754, which includes a relational database 754b and a processor 754a. Any standard computer capable of displaying and interacting with web pages will suffice as the processor in each of the above modules. Any standard relational database capable of storing and relating data items will suffice for the databases in the above modules.

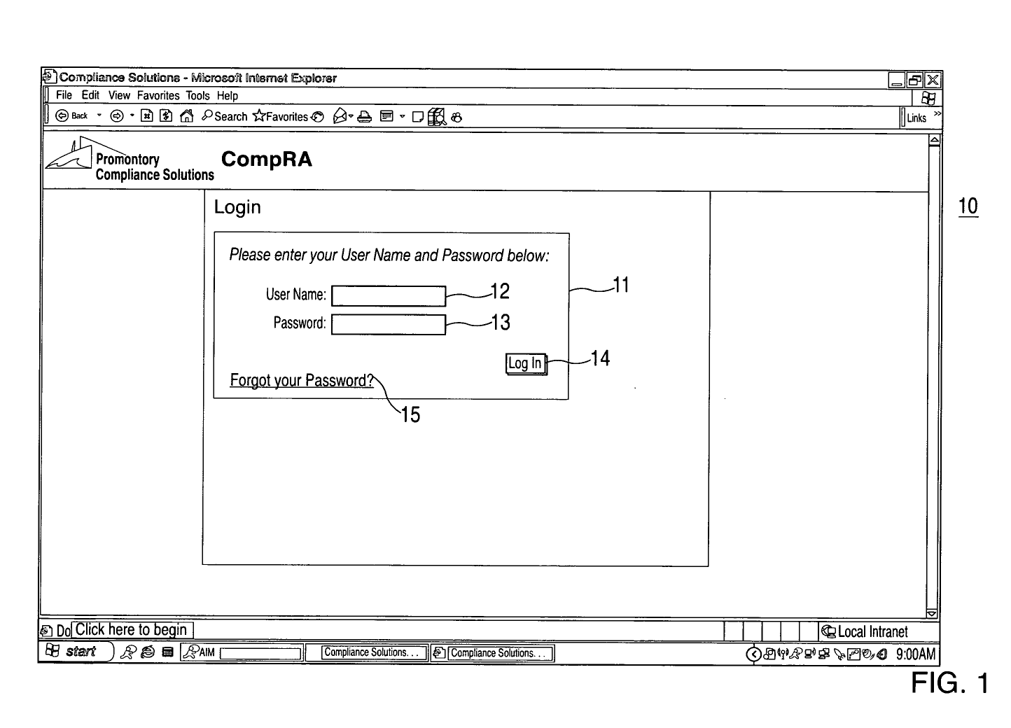

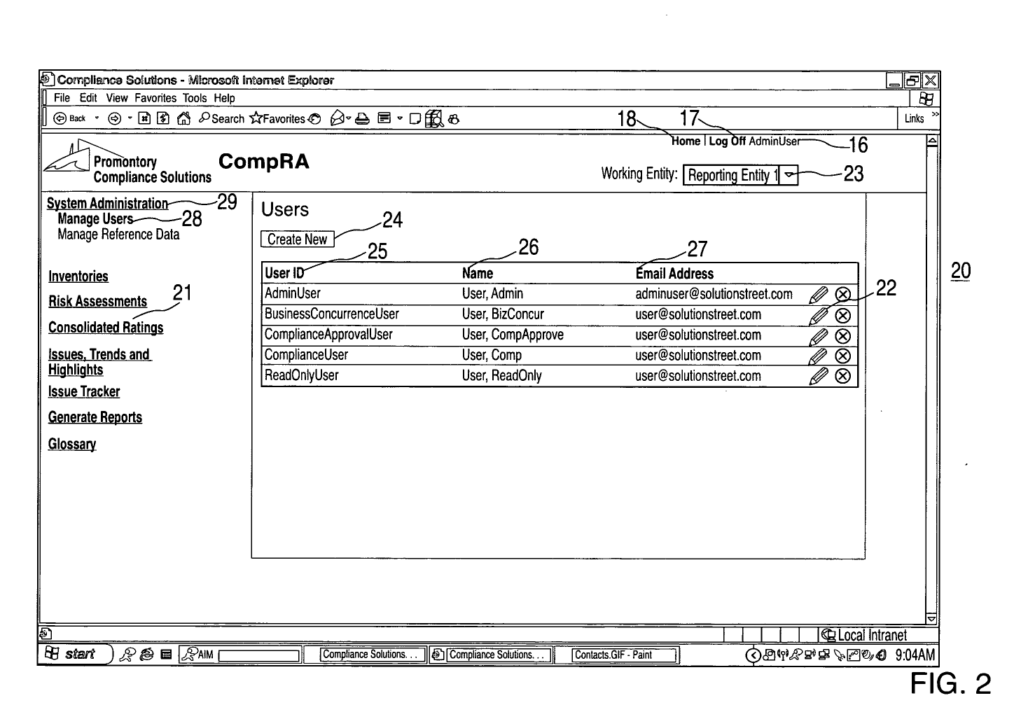

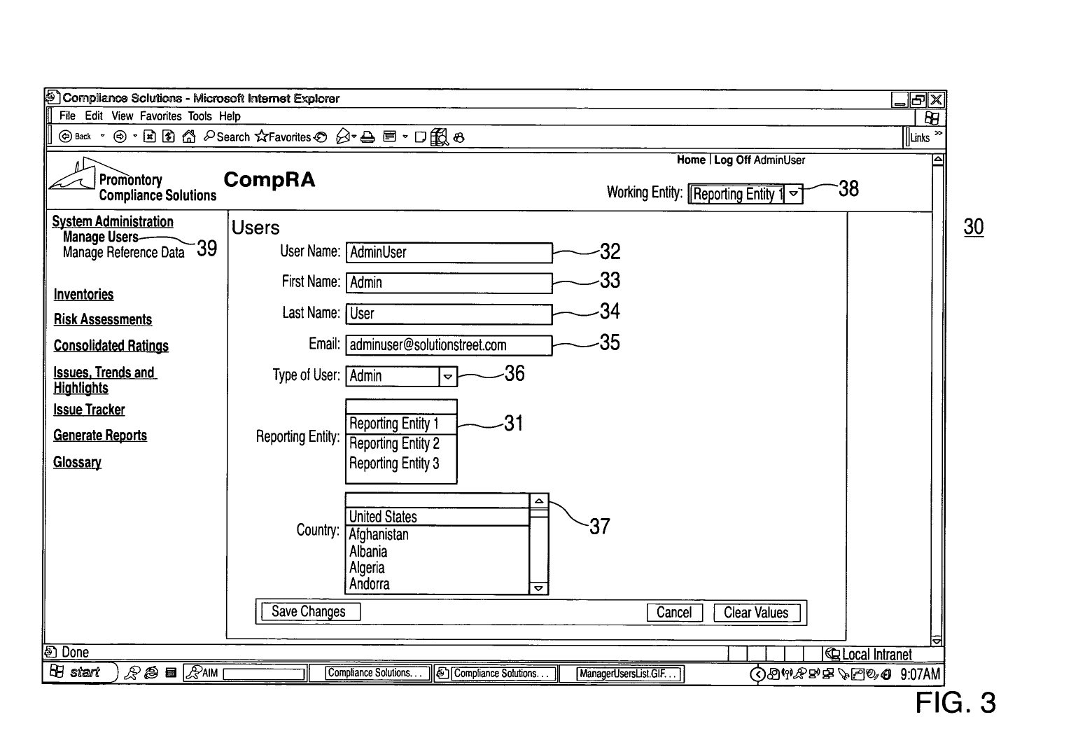

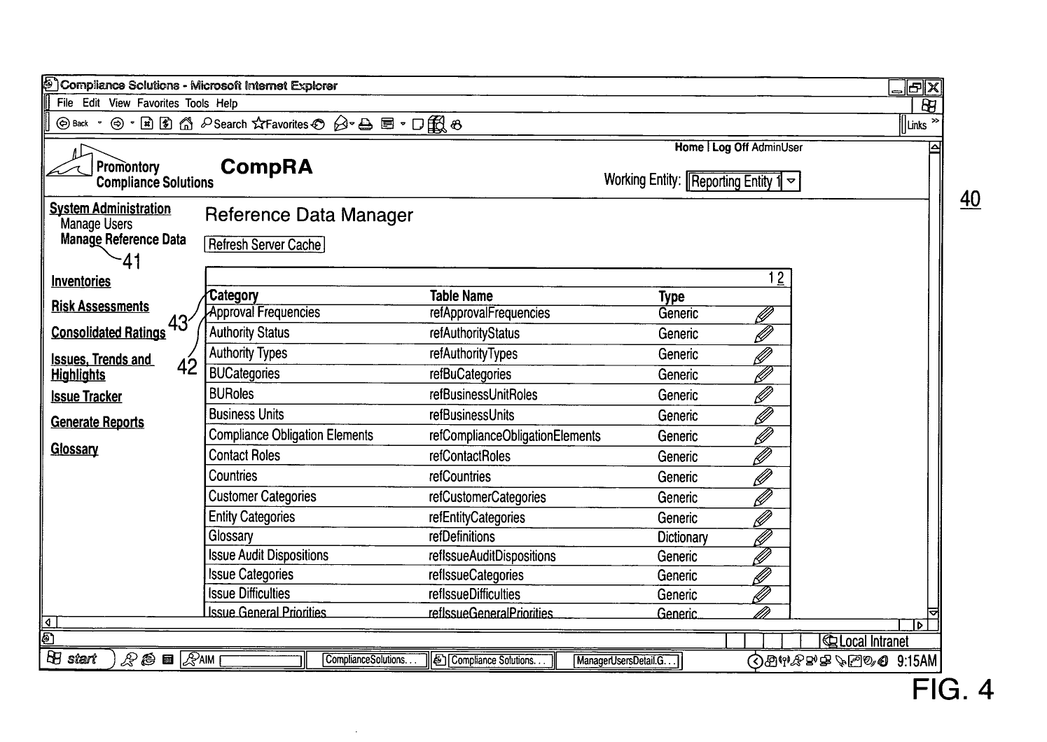

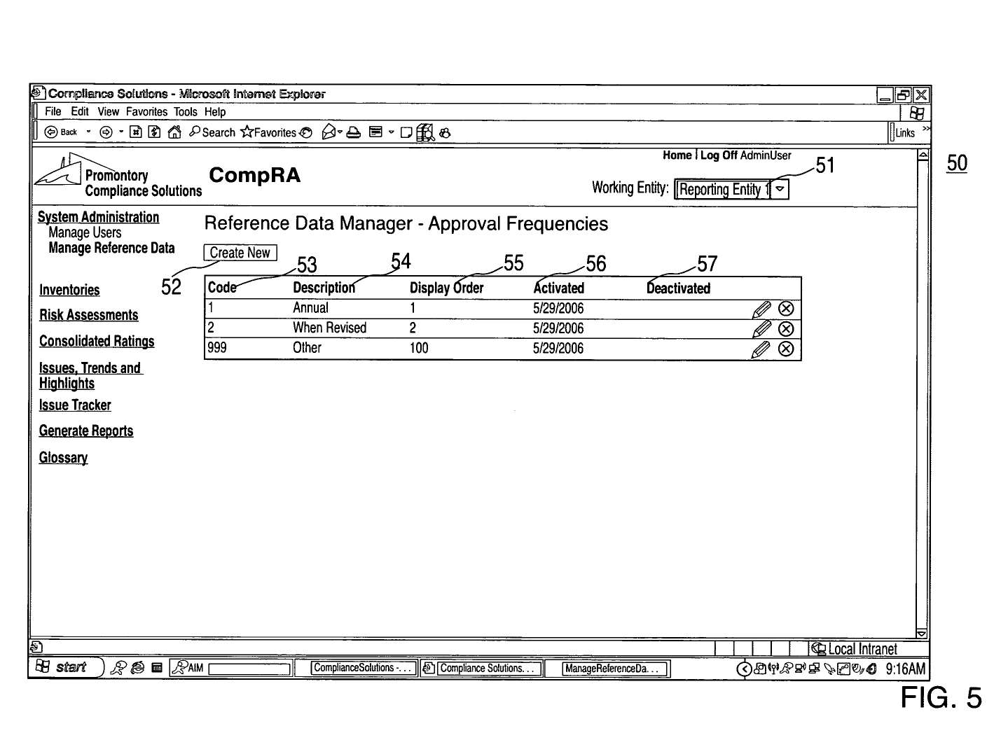

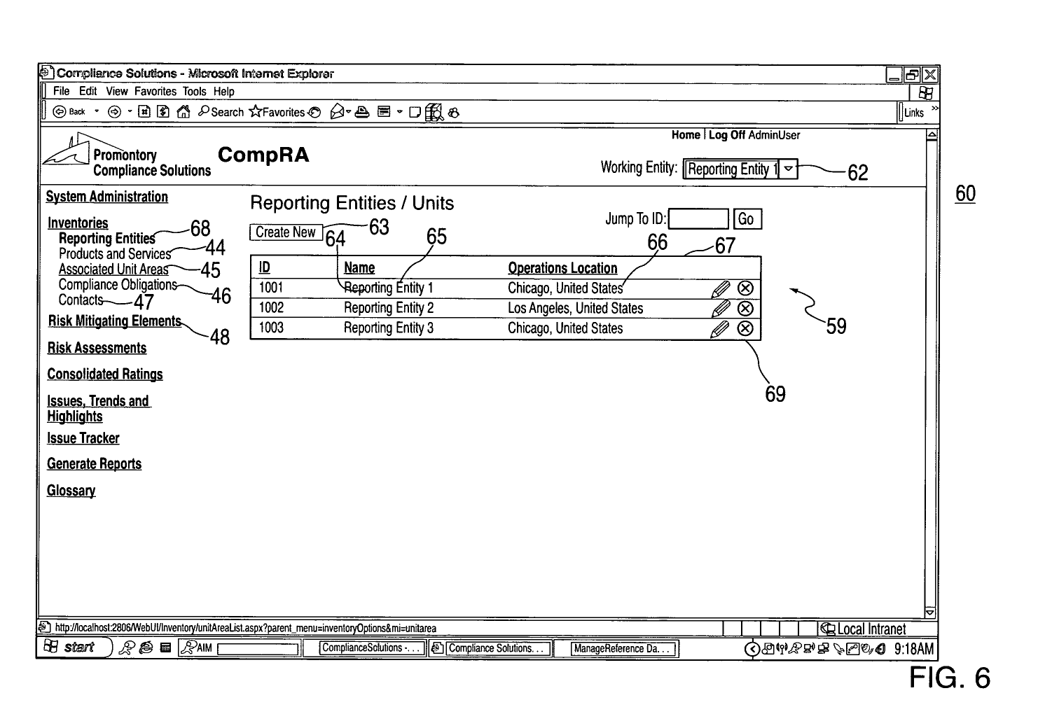

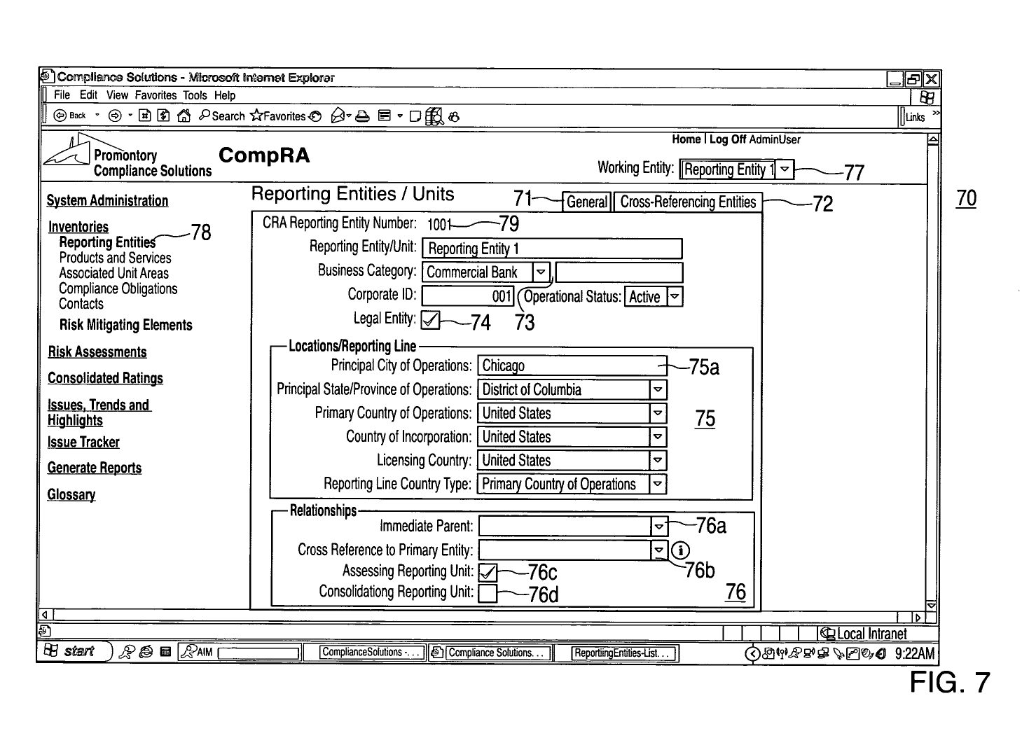

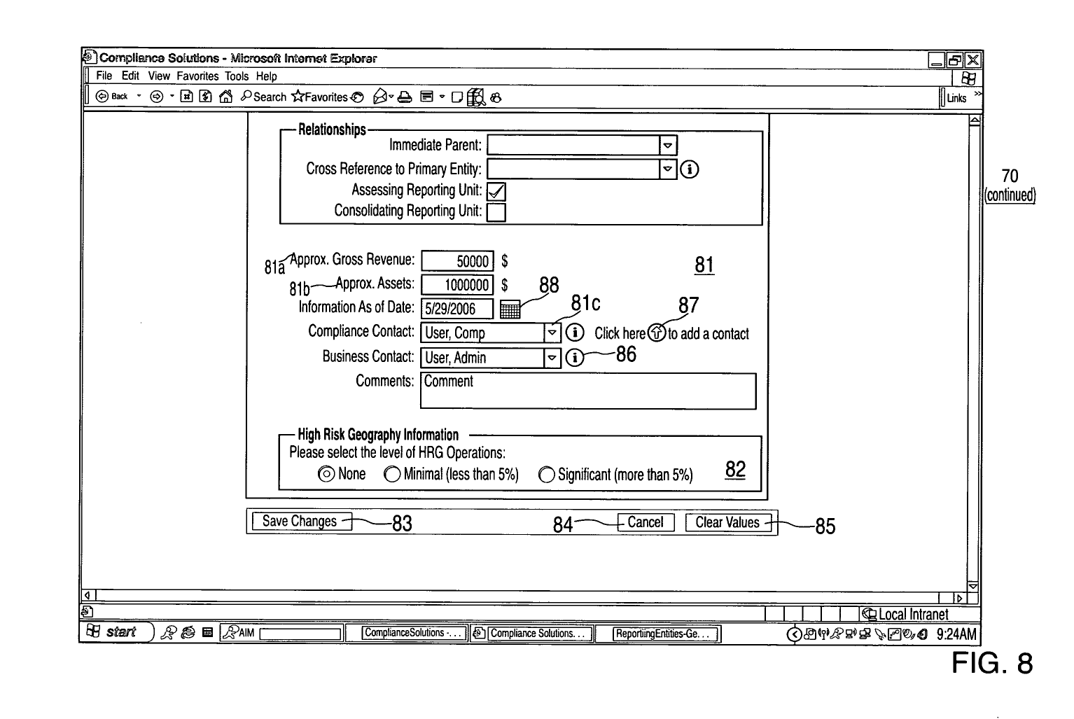

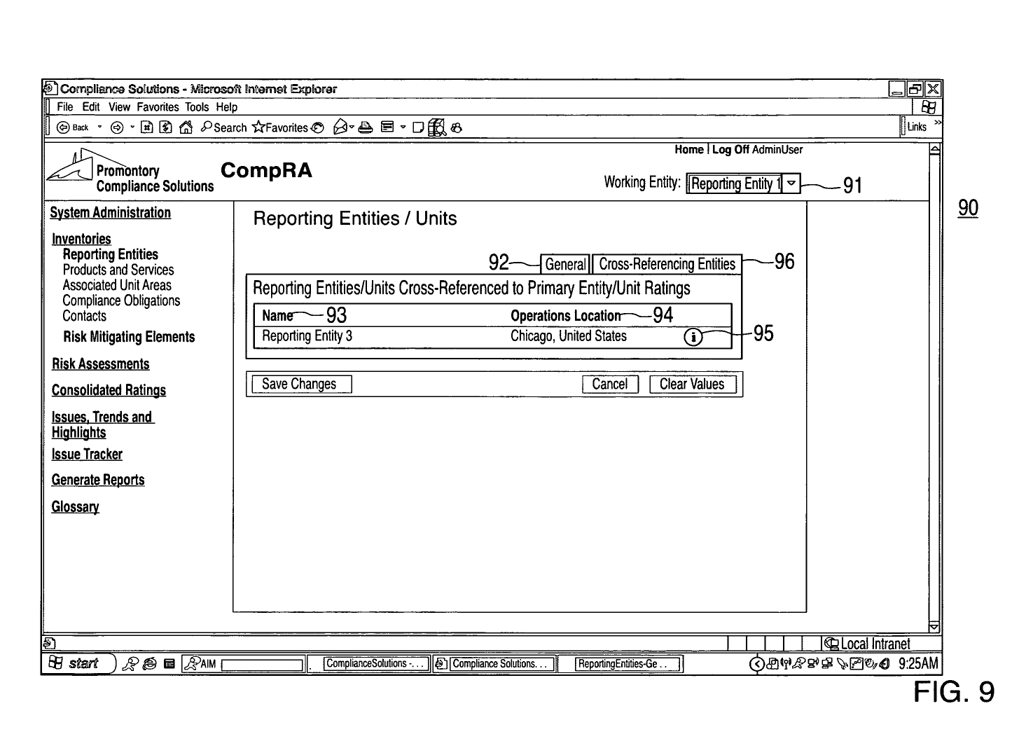

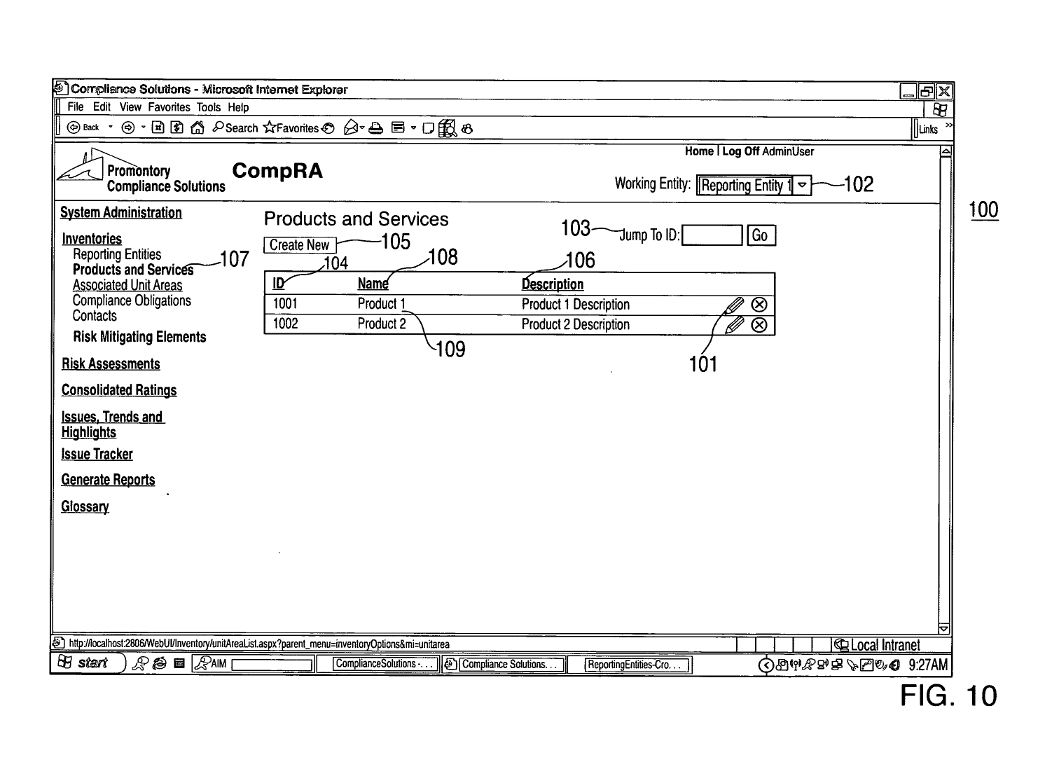

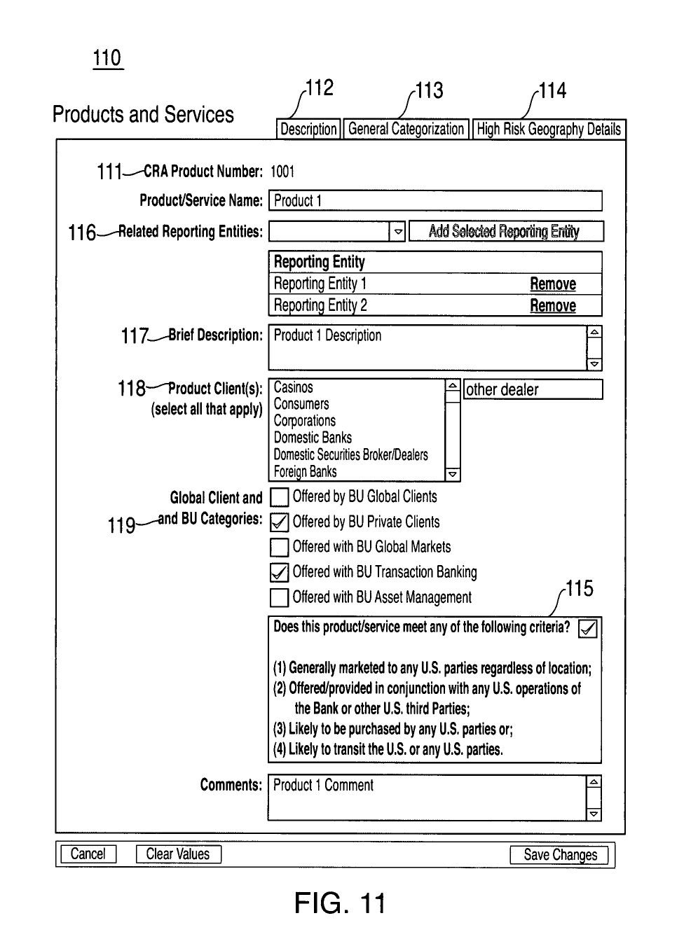

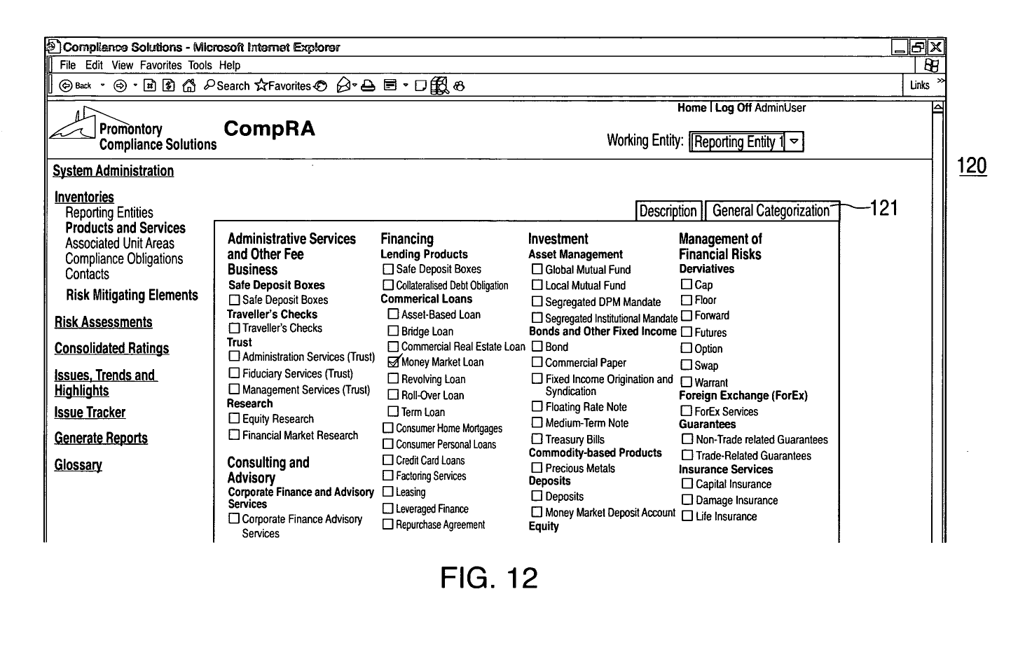

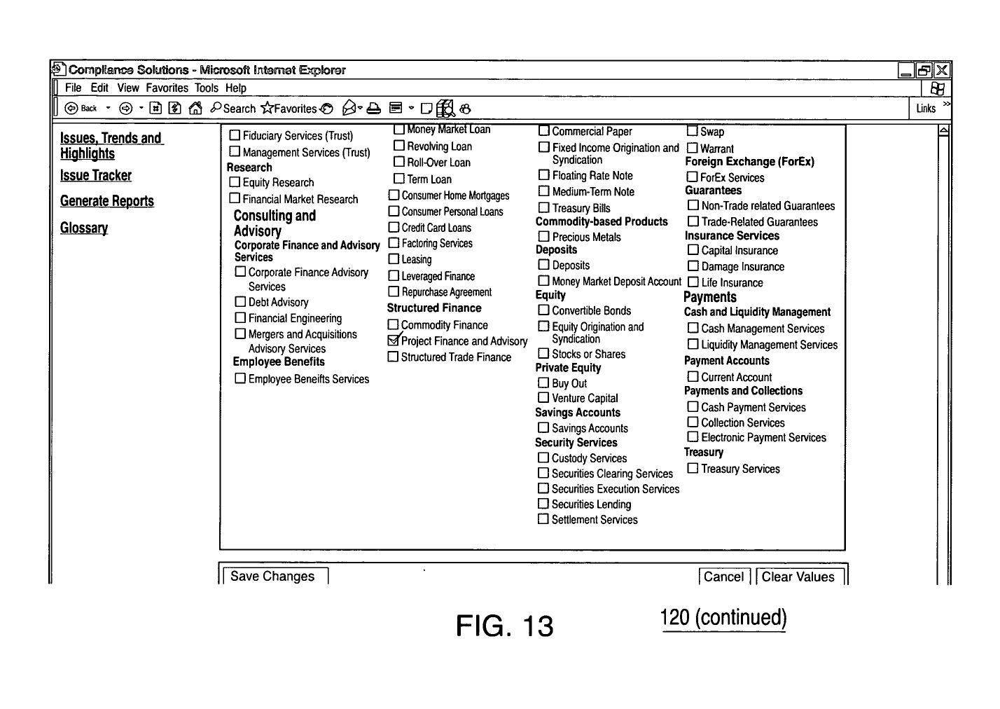

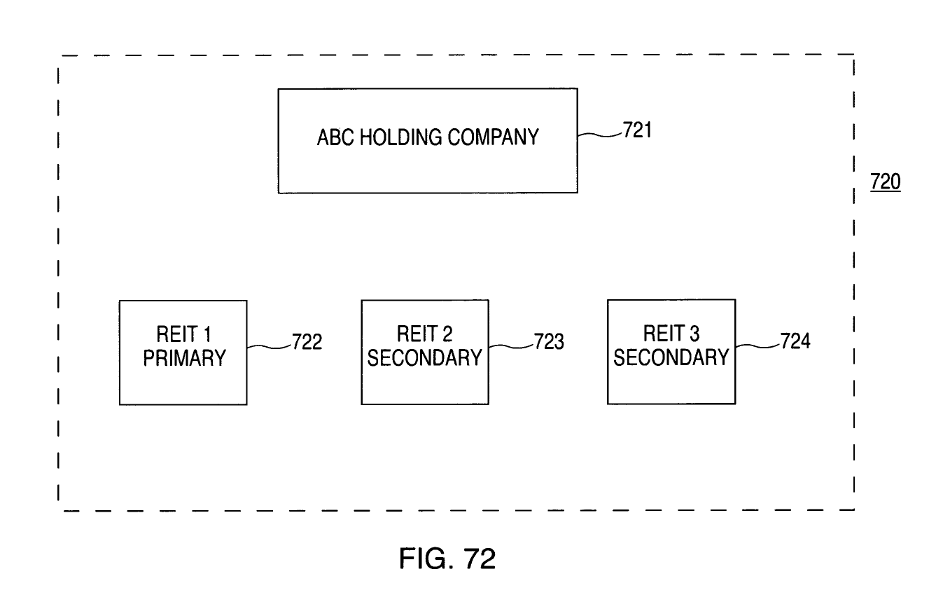

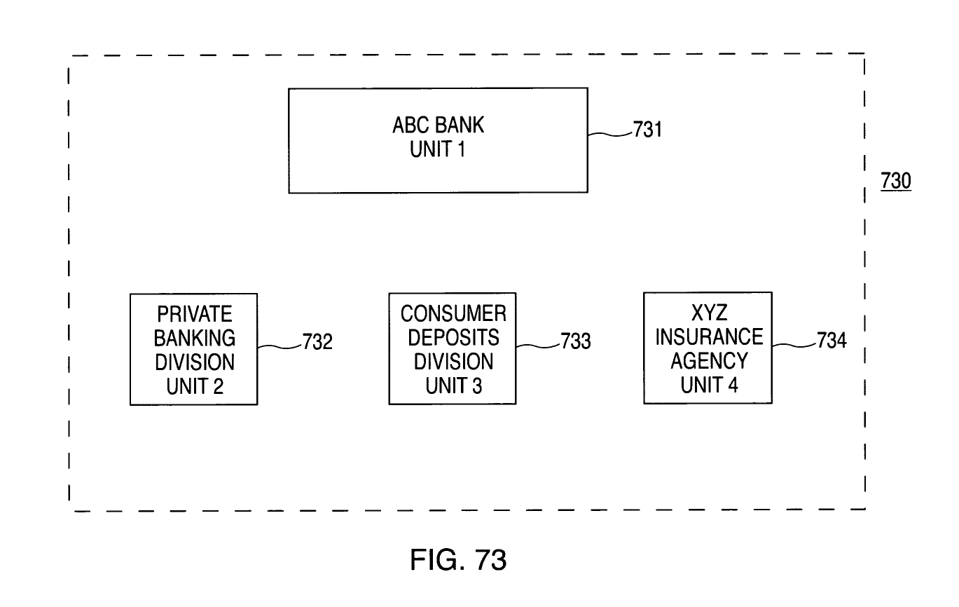

Each of the modules 751-754 may be interacted with by one or more users via a graphical user interface, which will be described in conjunction with FIGS. 1-72. The enterprise builder module 752 enables a user to create and store data describing the organization, as well as the relationships between the various parts/entities within the organization. By building the organization in a structured approach, and storing the data in a relational database, a large complex organization can be created over time that enables a multi-dimensional analysis of various aspects of the organization, including compliance risk.

The products and services catalogue module 751 enables one or more users to specify the various products and services of a complex organization and relate those products and services to the various entities within the organization. By storing the data in a relational database, products and services within a very large complex organization can be related to multiple entities within the organization, as well as to one or more compliance obligations that may be related to the products and services or to the organizational entity.

The compliance obligation inventory module 753 enables one or more users to relate the various compliance obligations for an organization to the appropriate products, services or entities. By storing these in a relational database, complex relationships of compliance obligations can be created and managed.

The compliance risk assessment module 754 enables one or more users to perform risk assessments on unique combinations of organizational entities, products/services and compliance obligations. Moreover, the compliance risk assessment module 754 enables the user to consolidate the risk assessments across multiple products, services and entities.

Enterprise Builder

An initial difficulty in managing compliance risk is gaining an accurate understanding of the scope of the organization whose compliance risks are sought to be managed. Even relatively small and simple organizations can be sufficiently complex that very few people accurately and completely understand its entire organization. The legal structure of a bank holding company, for example, can include hundreds of legal entities. The problem is compounded by increasingly international nature of operations and by the sometimes rapid rate of change within an organization. The problem is further compounded by the fact compliance risk often cannot be managed by a one-dimensional view of an organization. For example, some compliance risks attach to client segments, which may be serviced by many different legal entities within a bank holding company. As another example, some compliance risks attach to product or services that may be offered to different client segments by different business units and legal entities within a bank holding company. Two-dimensional models of organizations, such as through conventional organizational charts have proven inadequate to the problem of compliance risk management. There is a need for an easy way to build a multi-dimensional model of an organization. The present invention solves this problem by providing a graphical user interface coupled to a database that enables a user to specify the organization and relate the various entities within the organization to each other as well as to products and services and compliance obligations.

This aspect of the present invention turns on an insight that any organization can be mapped unto multi-dimensional space as a series of vectors. Any one point in the organization can be defined by a vector, v=(x, y, z, etc.) where x, y, and z are variables representing legal entity, geographic location, customer type, product type, and the like.

The organization builder allows the user to create multi-dimensional maps of an organization. The user can decide how many dimensions to use to model the organization. In one manifestation of the organization builder, the following dimensions are recommended: legal entity, parent legal entity, business unit, place of incorporation, location, primary regulator, product, client, and markets.

Once the model is built, the user can view the organization in any combination of dimensions. This allows the user to see the compliance risks faced by an organization according to, for example, its legal status, its places of incorporation, its locations, its regulator, its products, or its clients.

Some dimensions can be pre-populated with readily available information about the enterprise. For example, the legal entity information can be downloaded from a website of information maintained by the Federal Reserve and up-loaded into the enterprise builder.

The module can be updated over time. Also, additional dimensions can be added over time. This is important for organizations that need to immediately install a compliance risk management system, but who want the system to get better over time. It could also be important for an organization that changes its organizational structure after the product is installed. For example, a financial institution that switches from a primarily line of business structure to a geographic or client segment-based structure could accommodate the change simply by adding another dimension to the enterprise builder.

Products and Services Catalogue

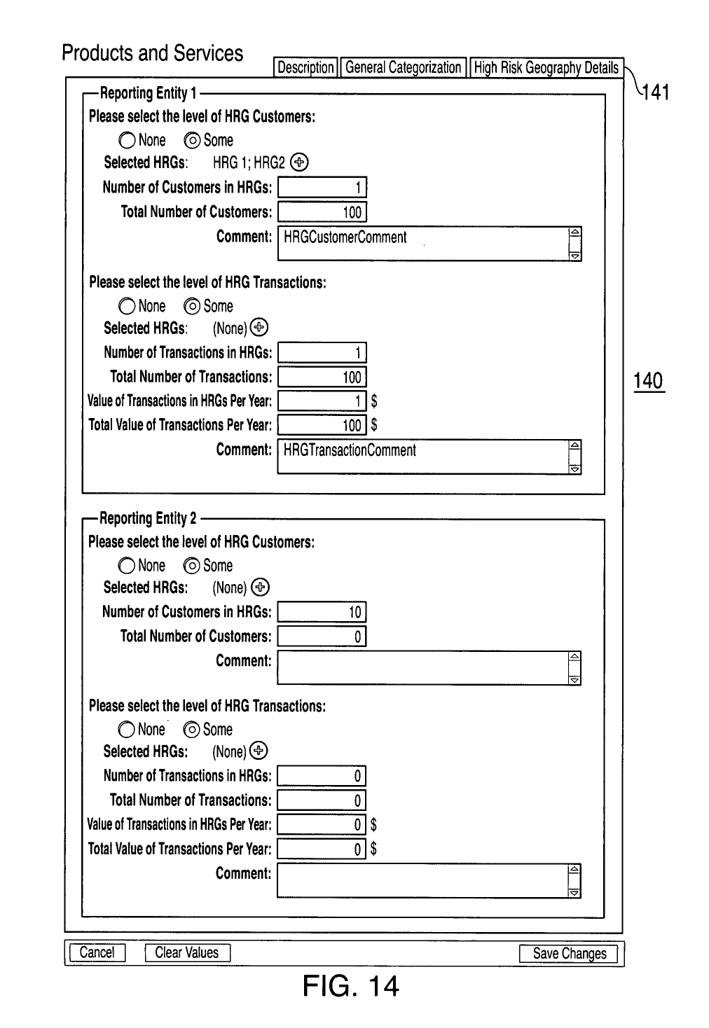

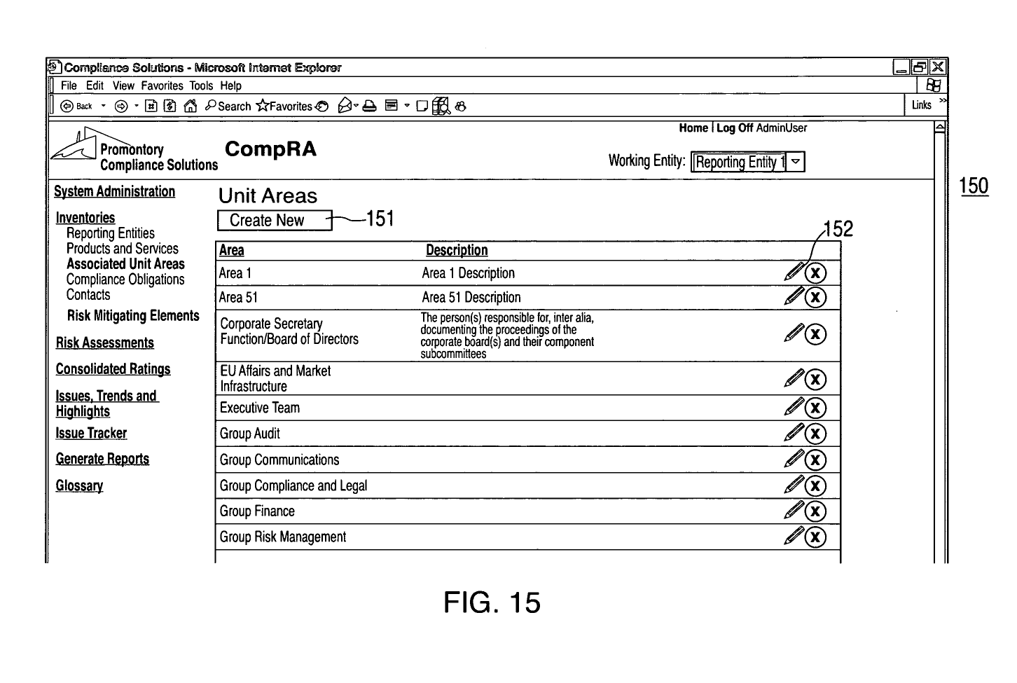

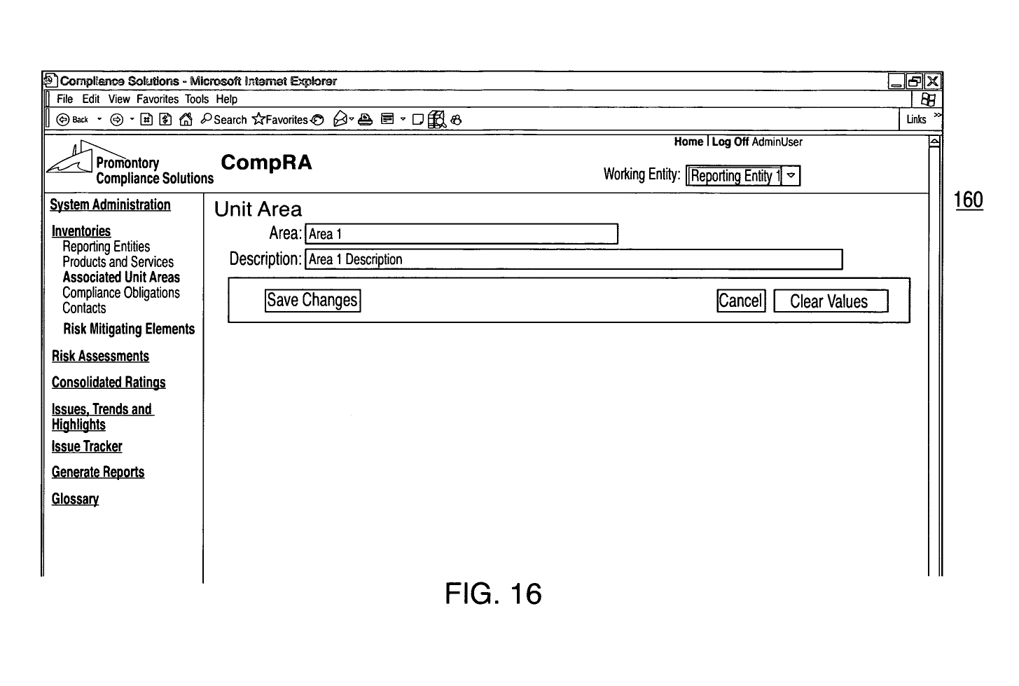

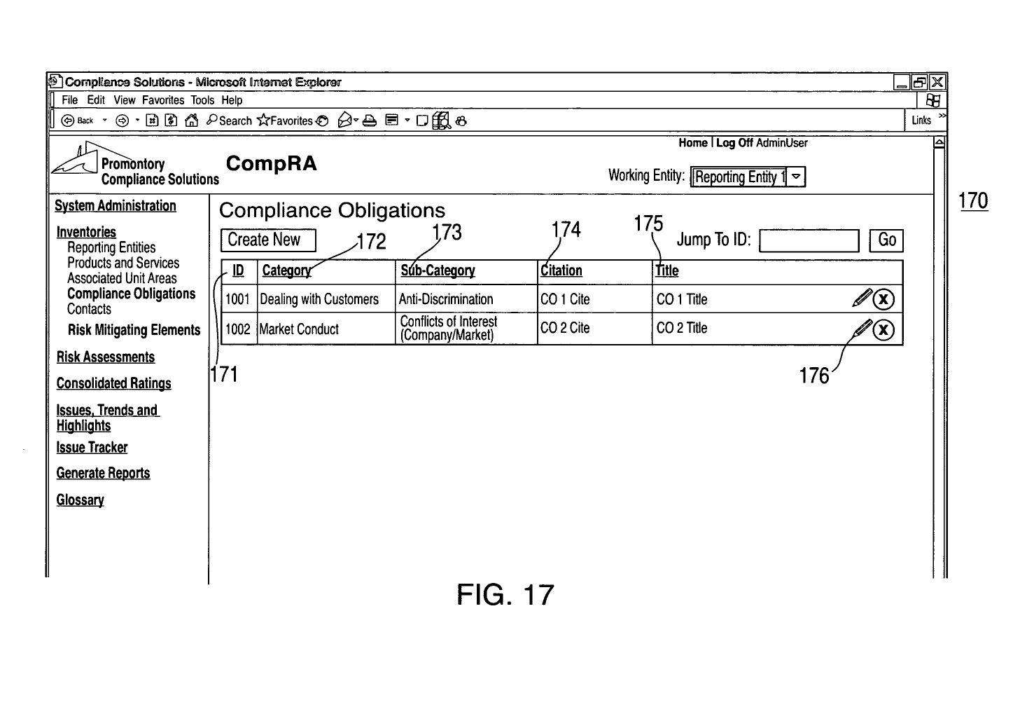

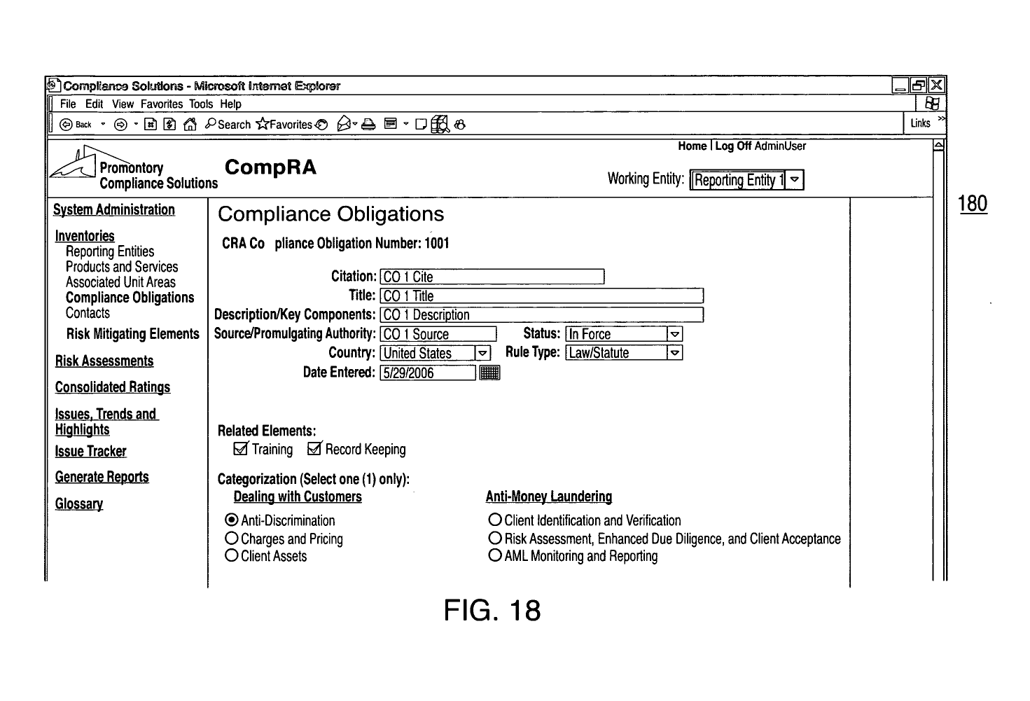

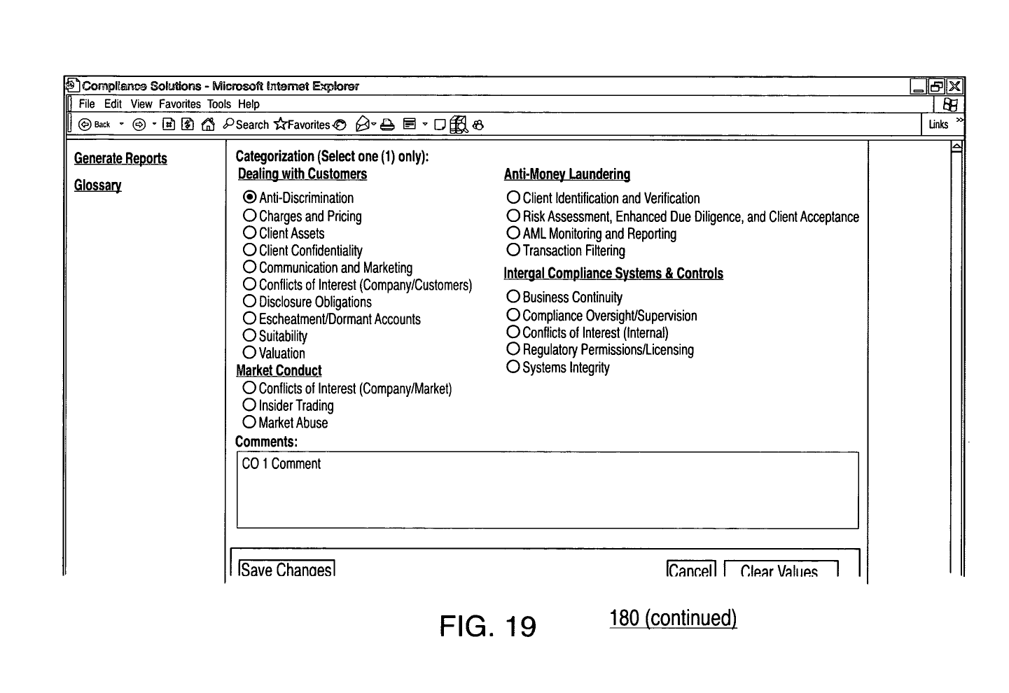

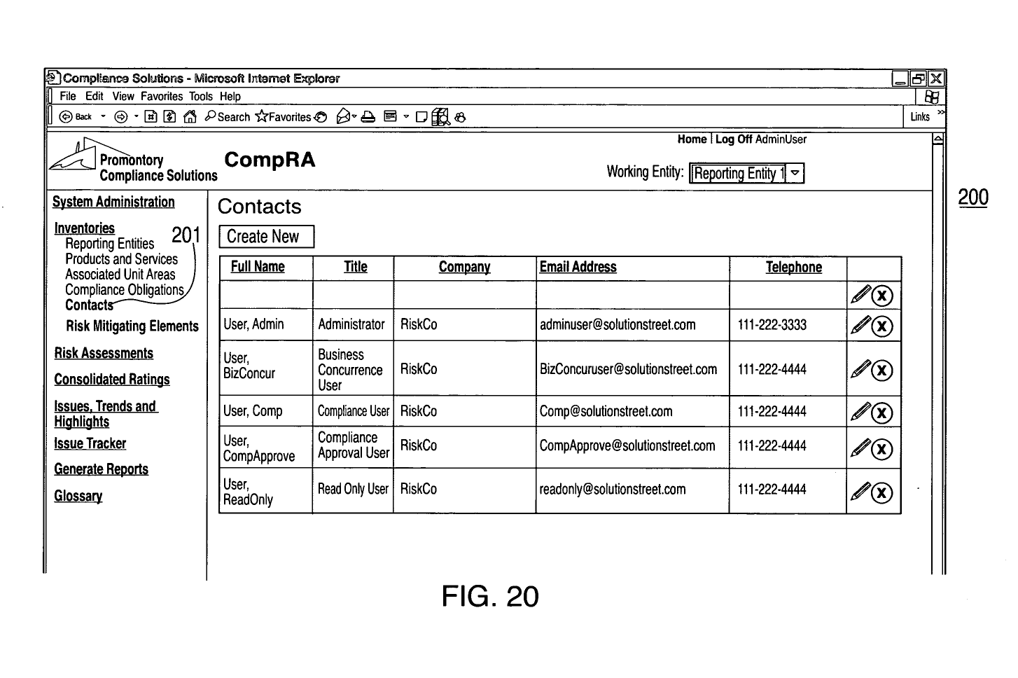

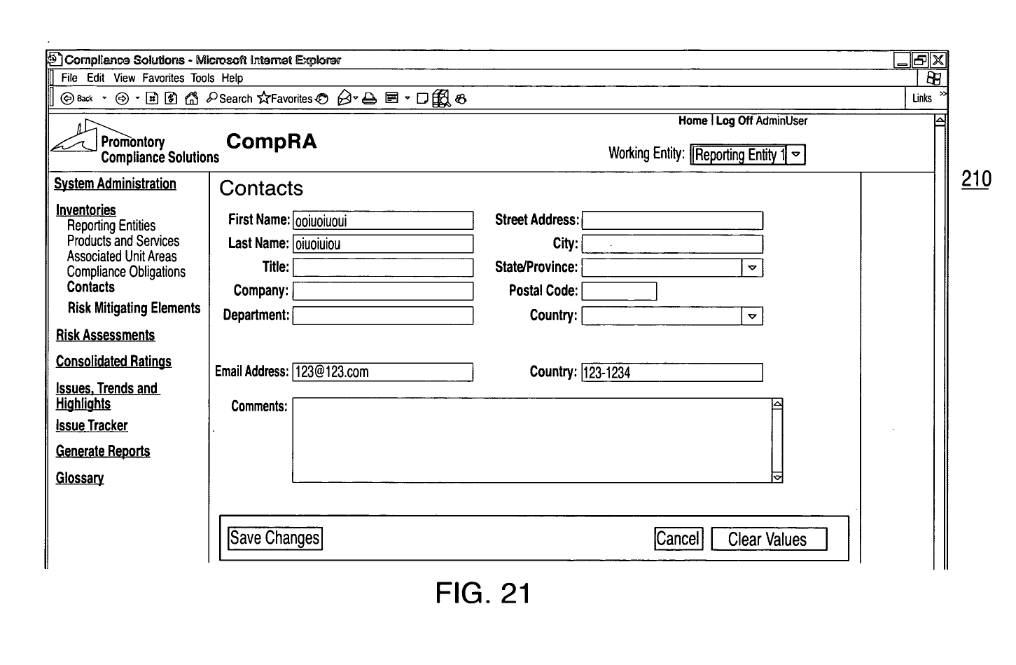

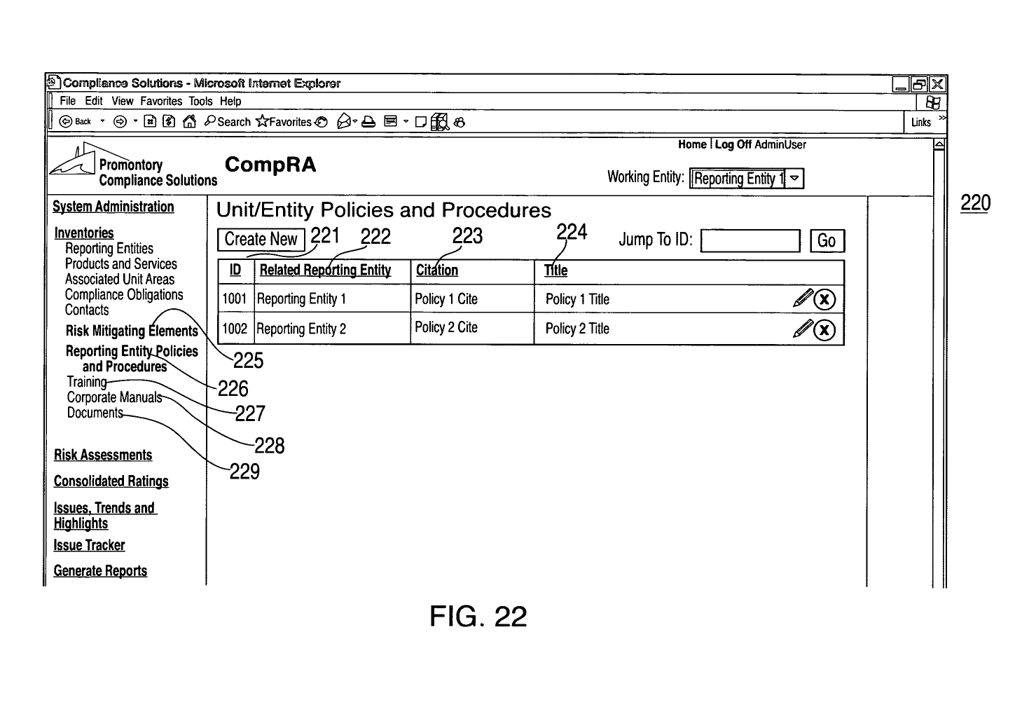

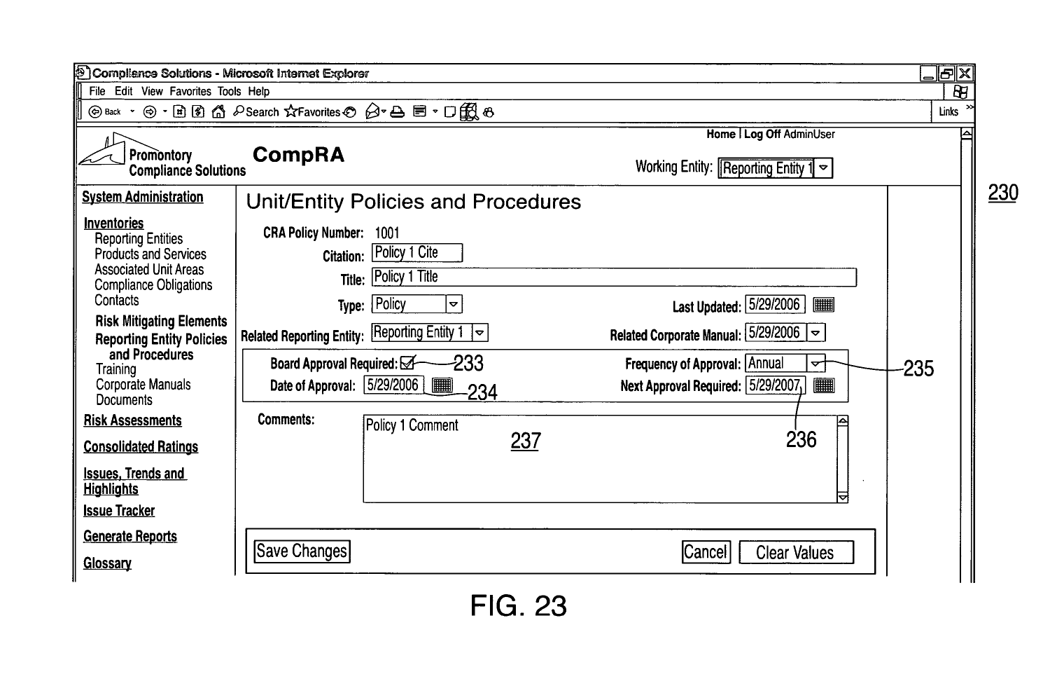

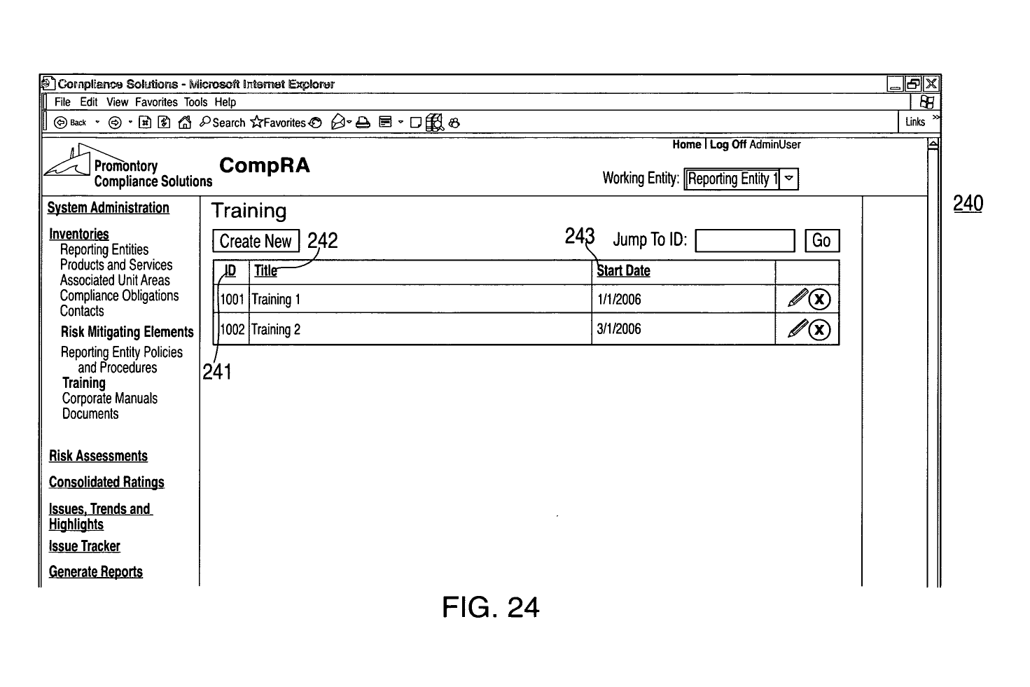

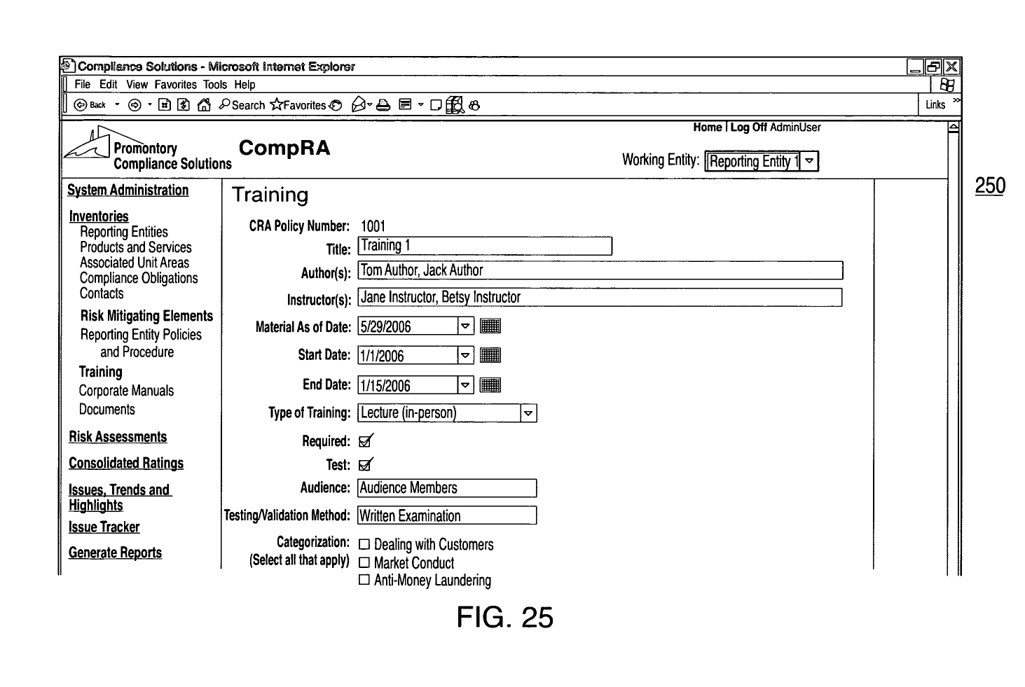

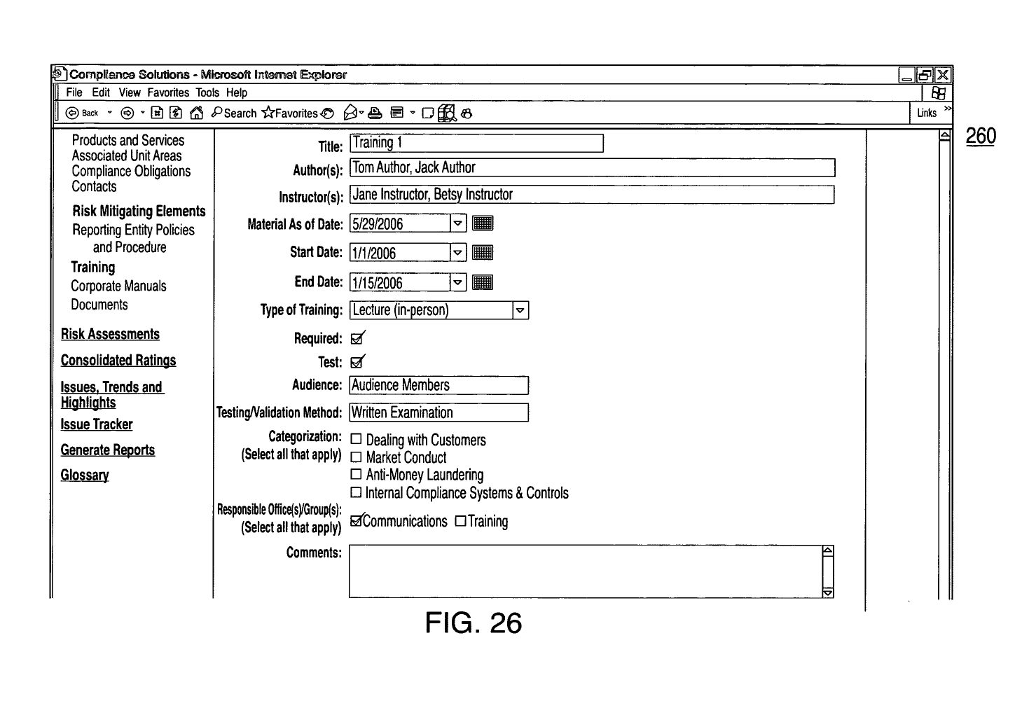

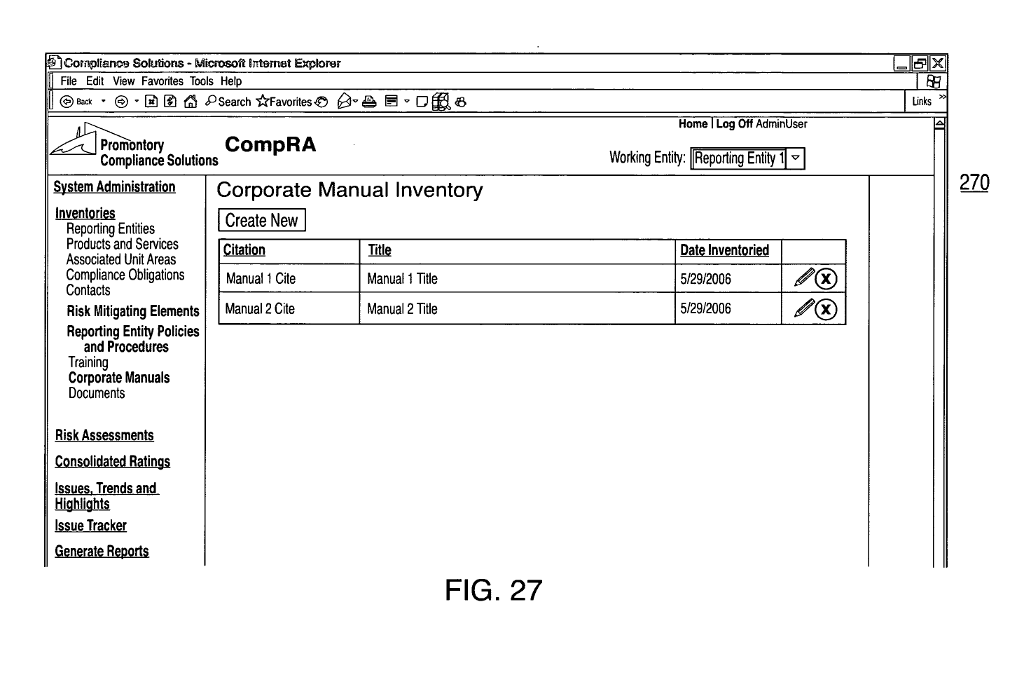

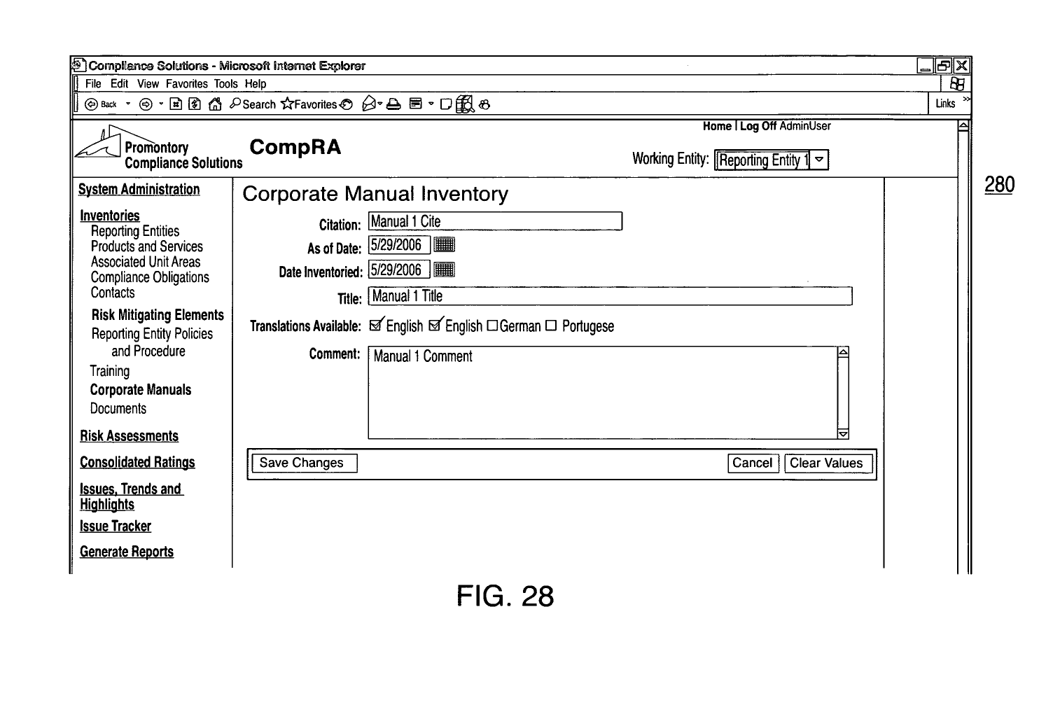

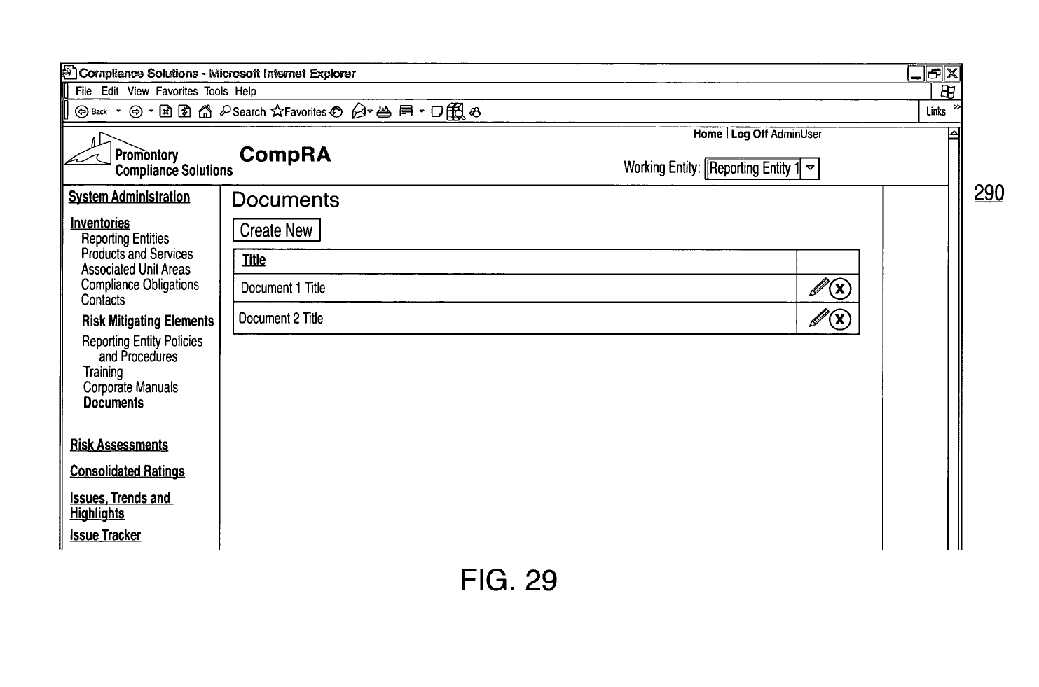

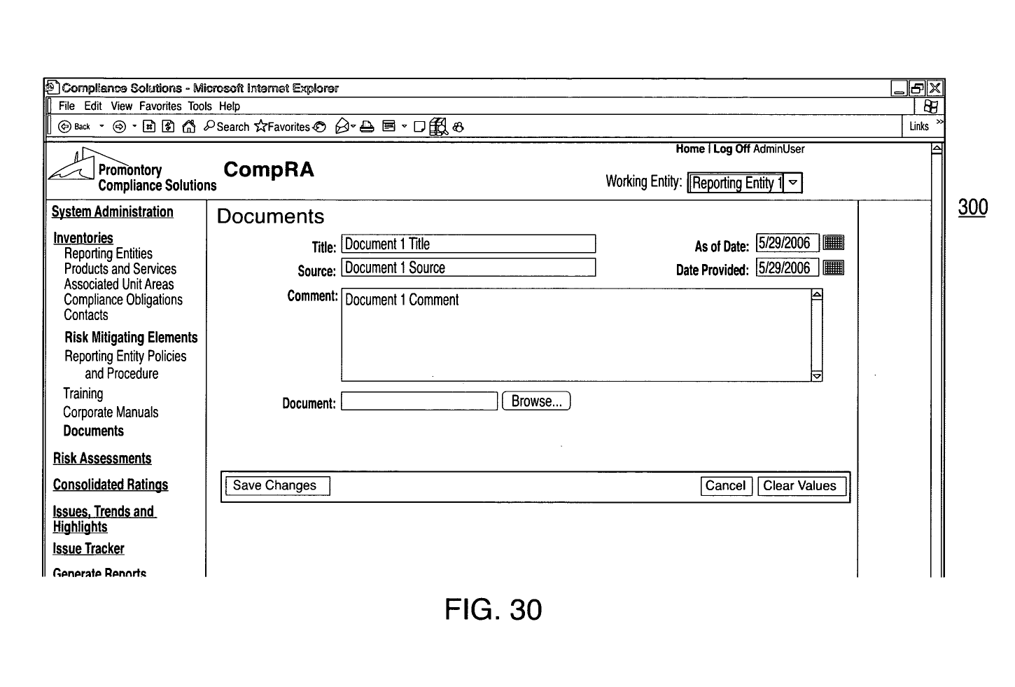

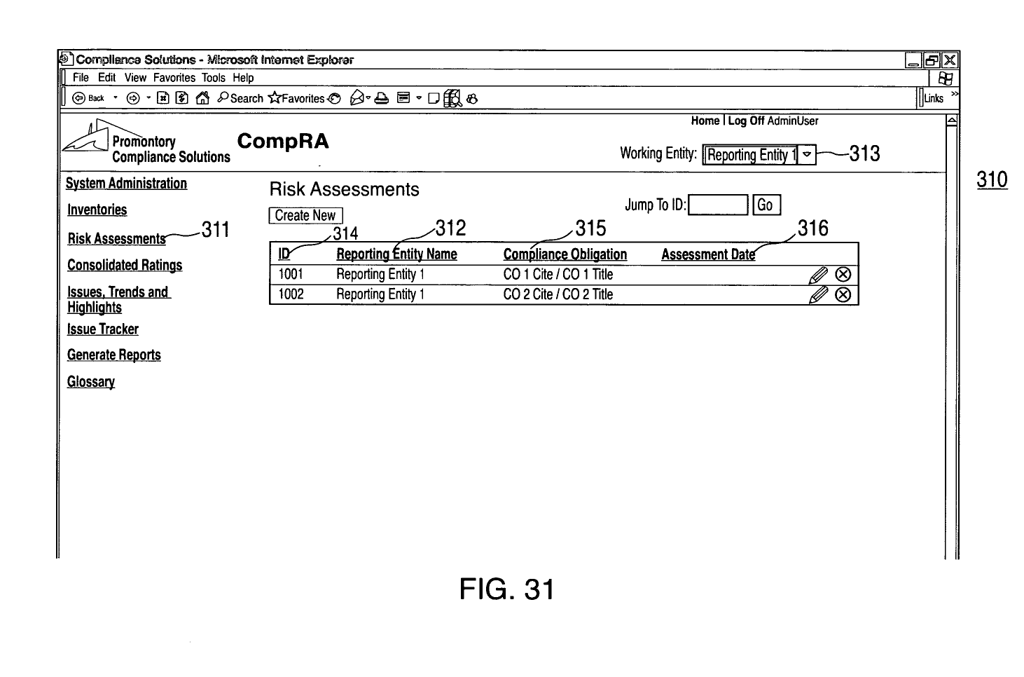

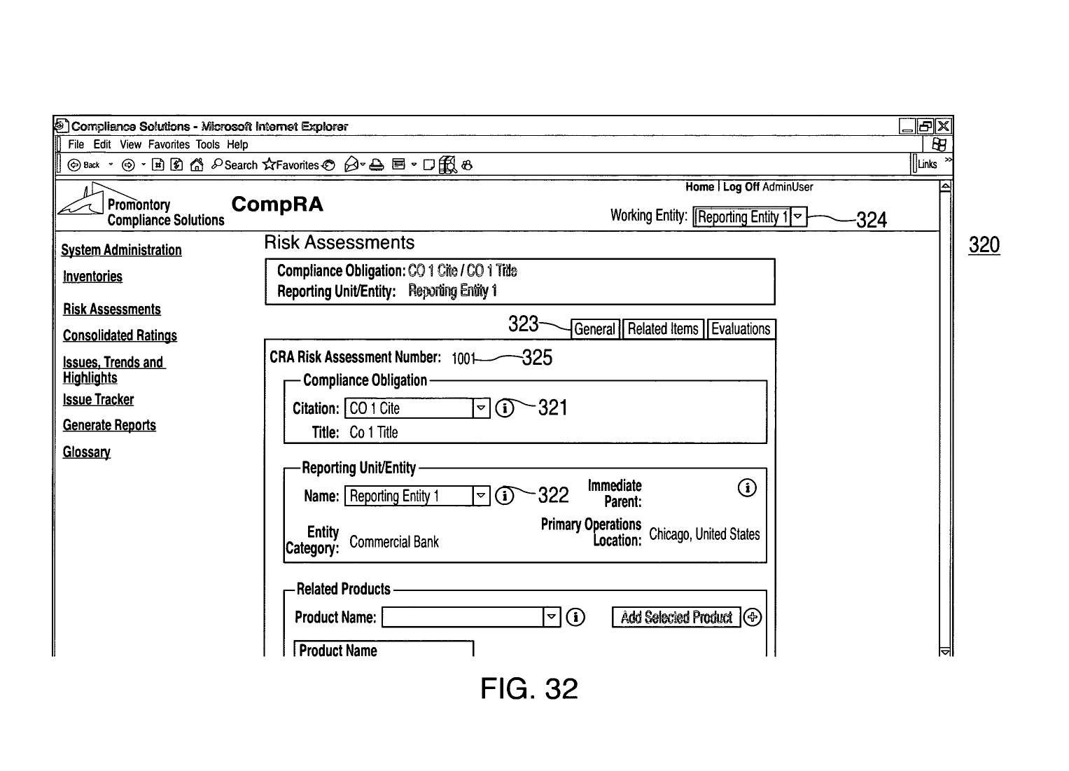

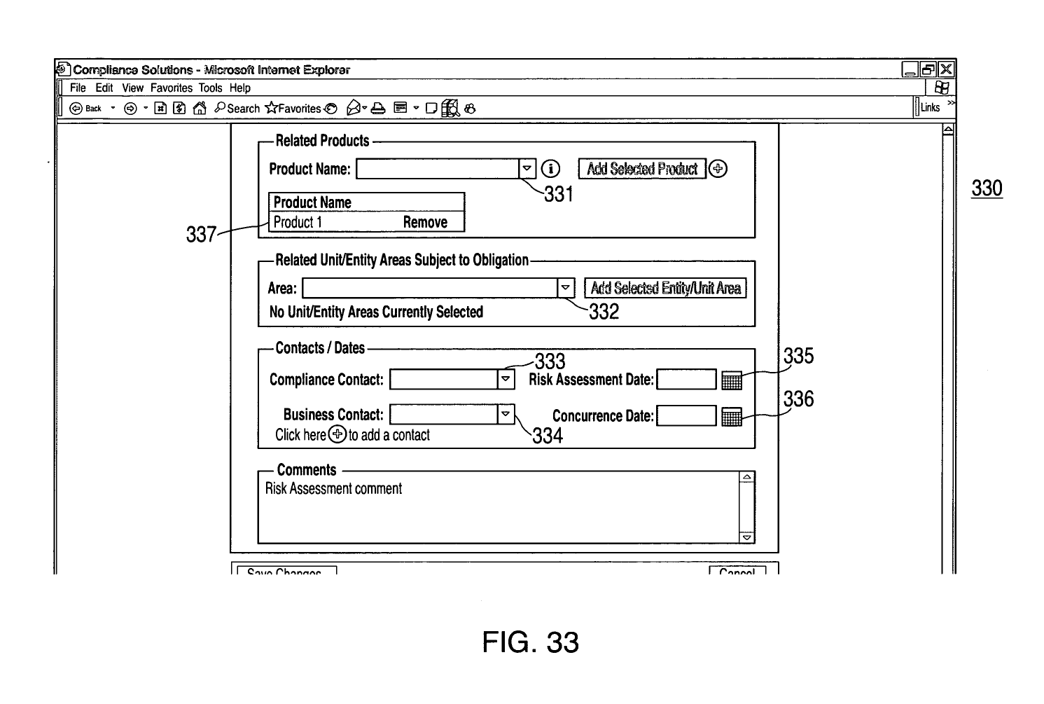

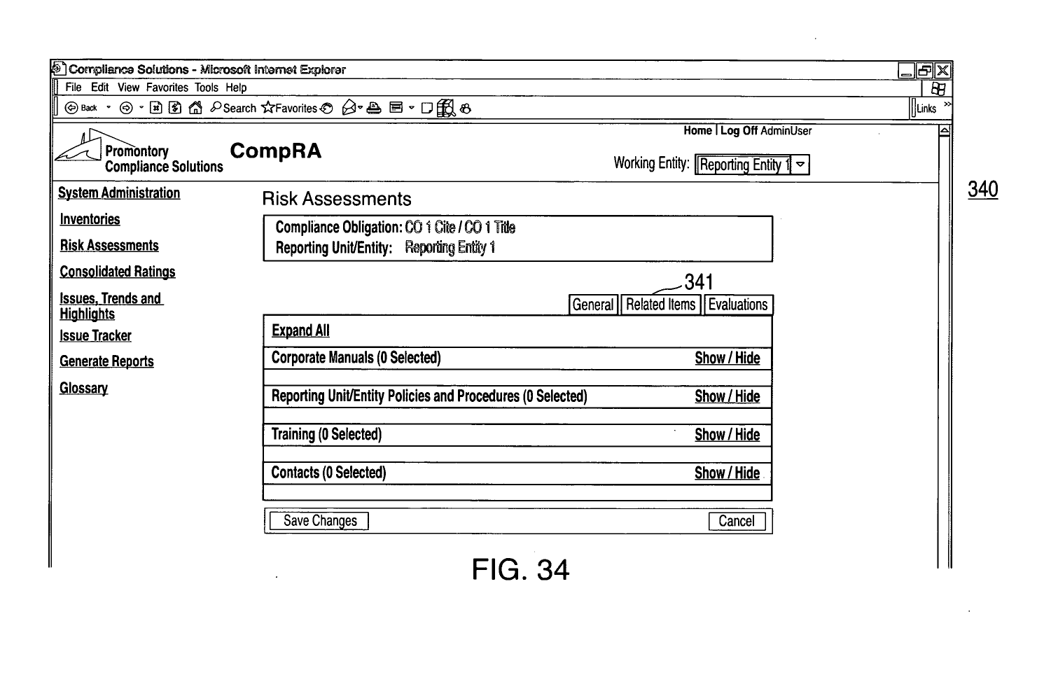

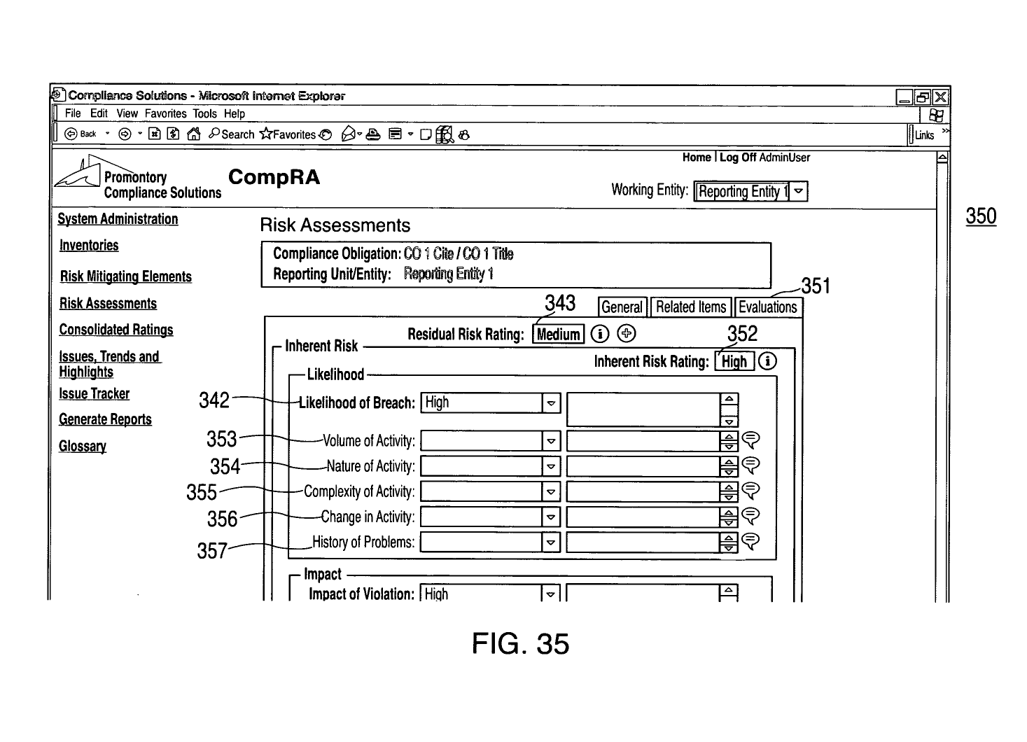

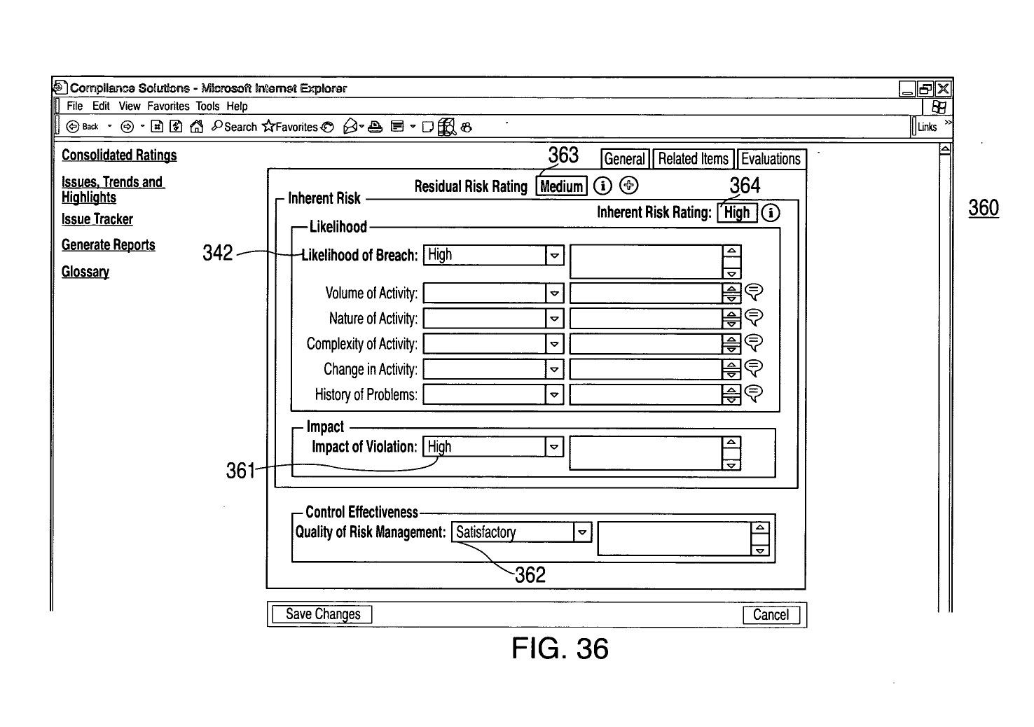

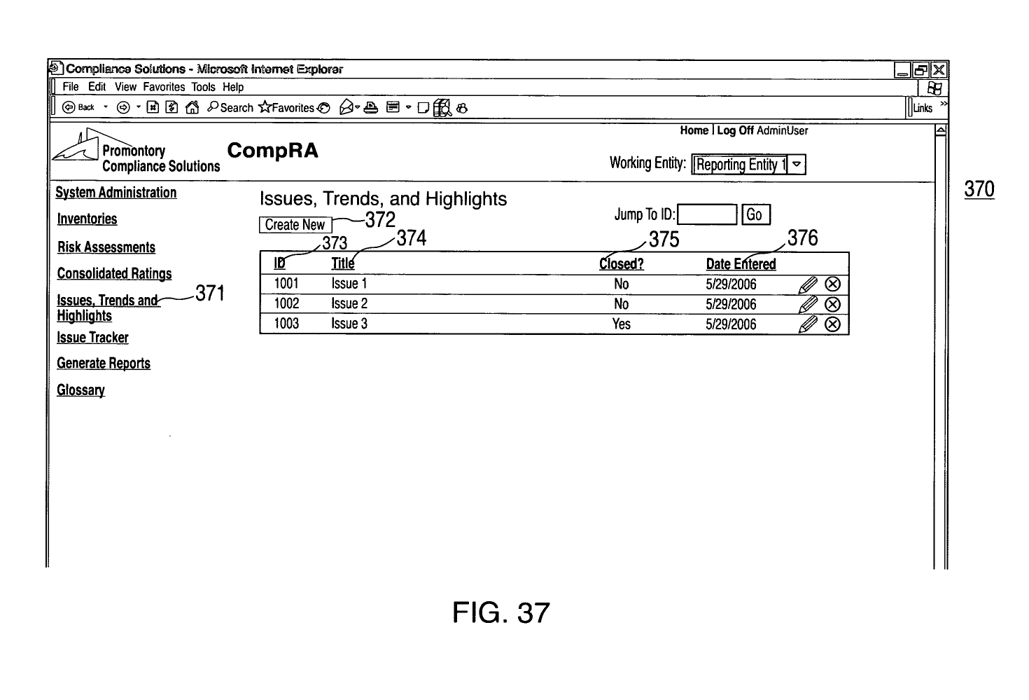

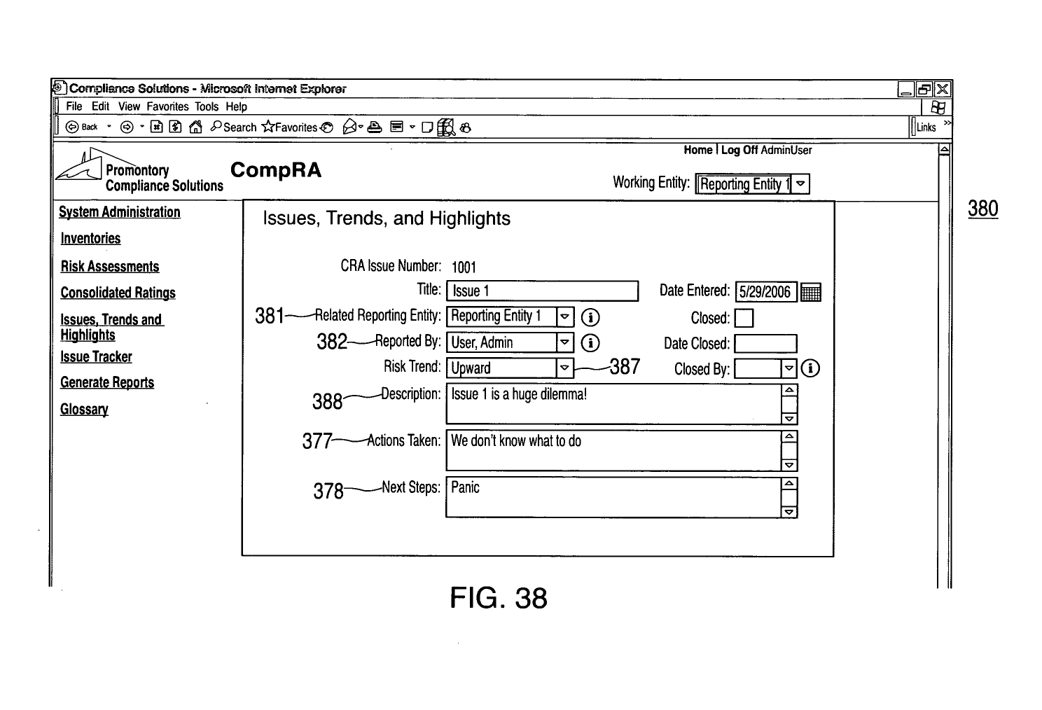

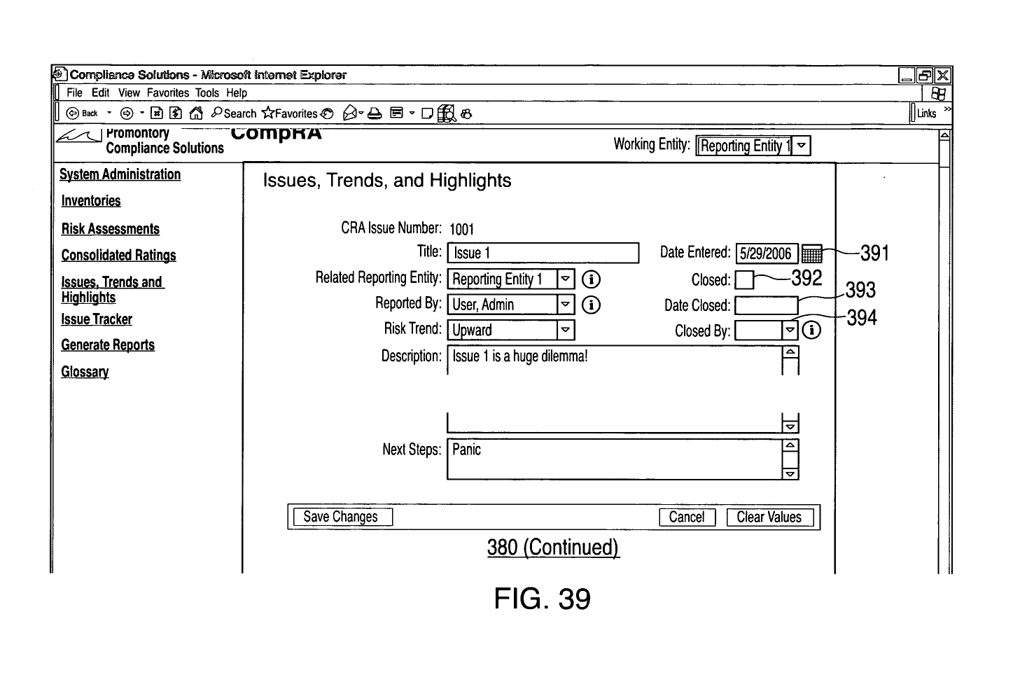

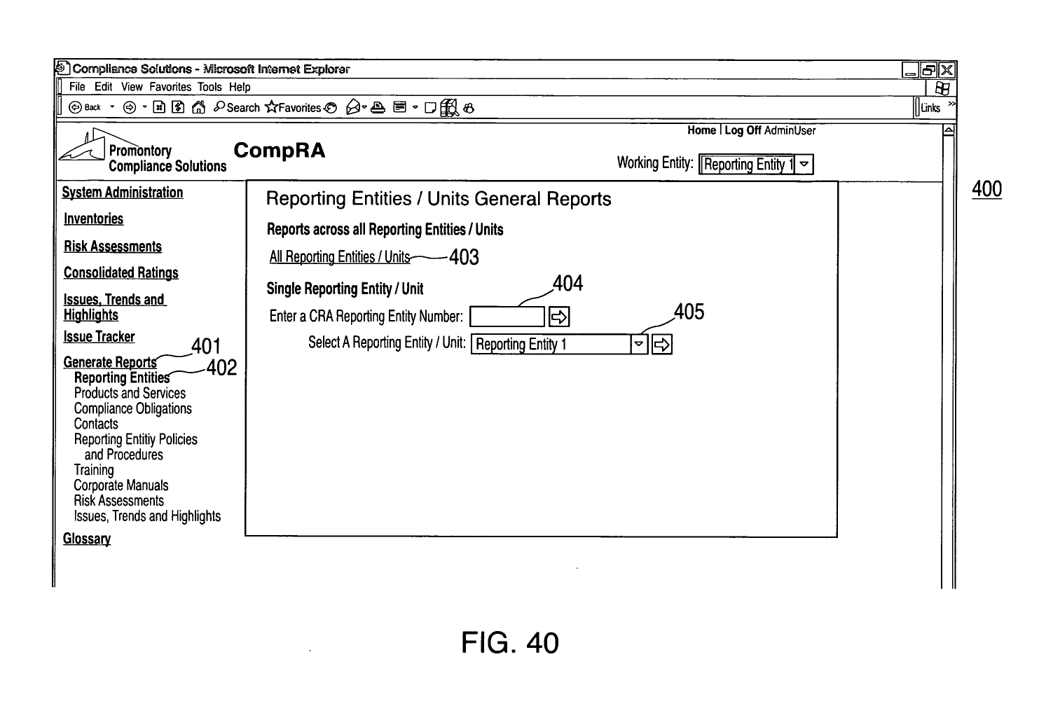

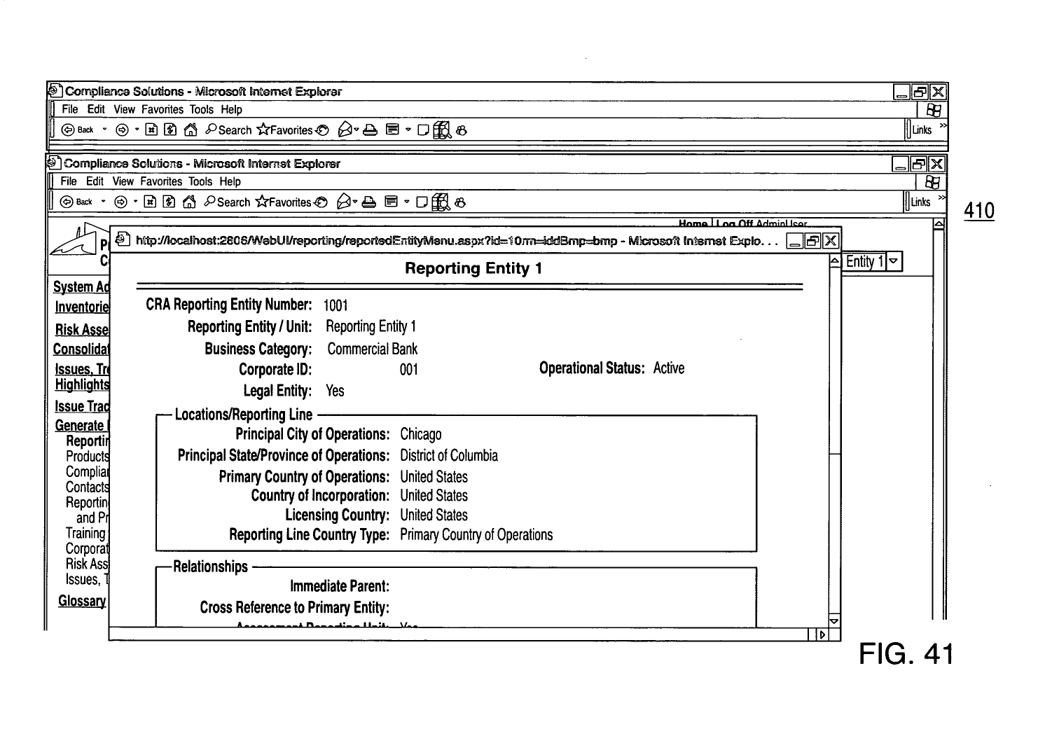

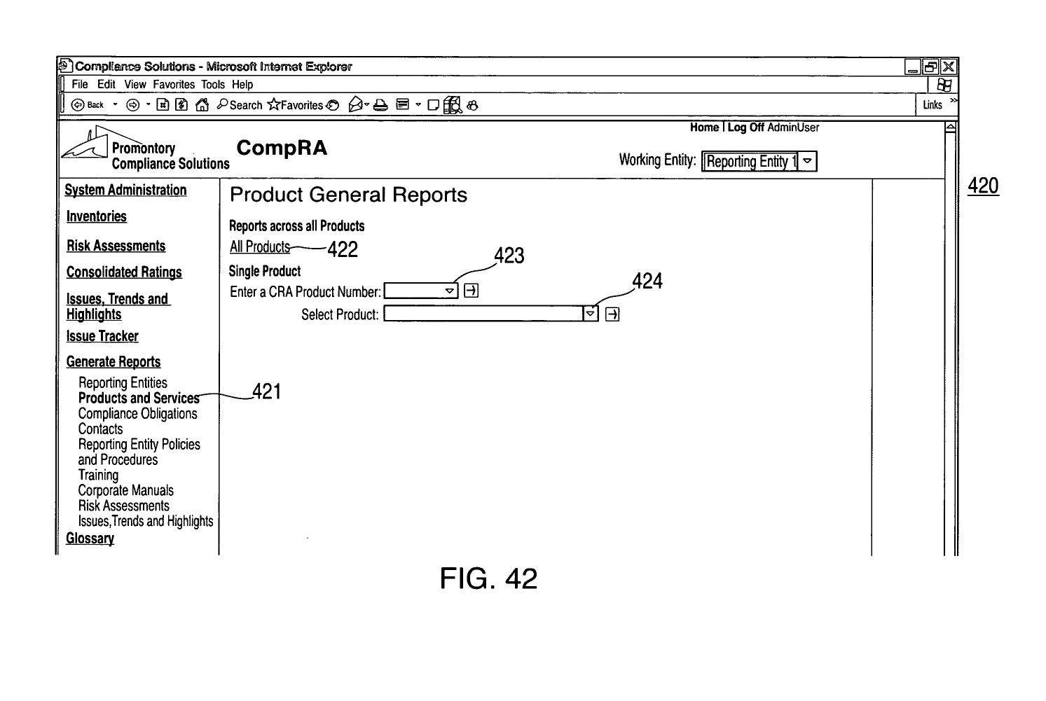

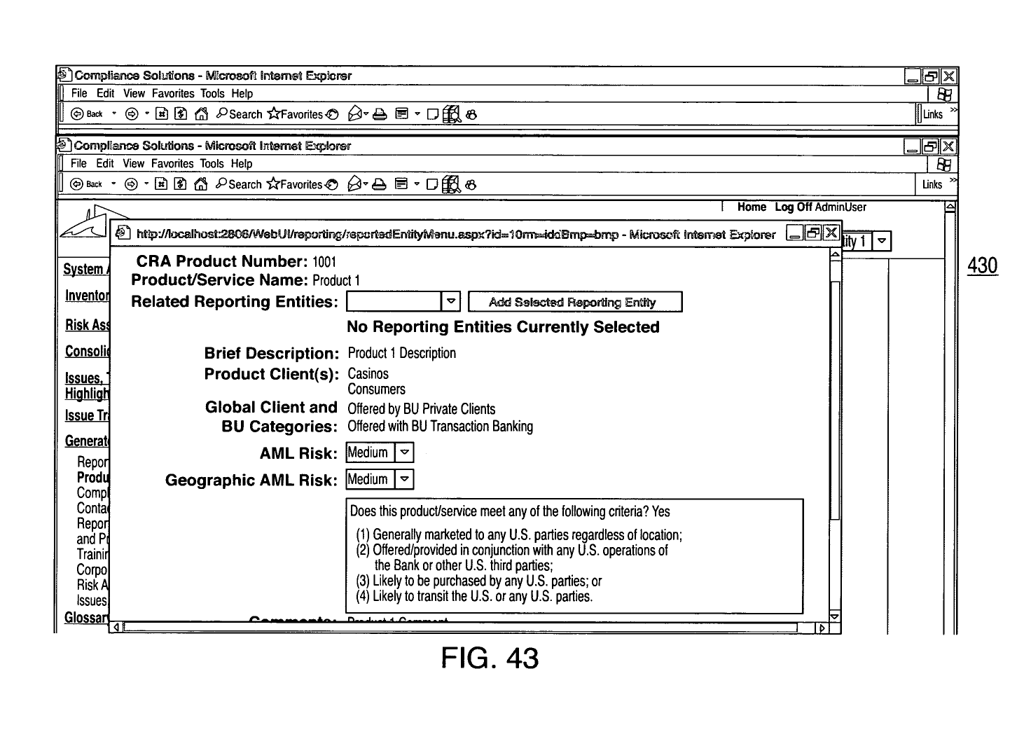

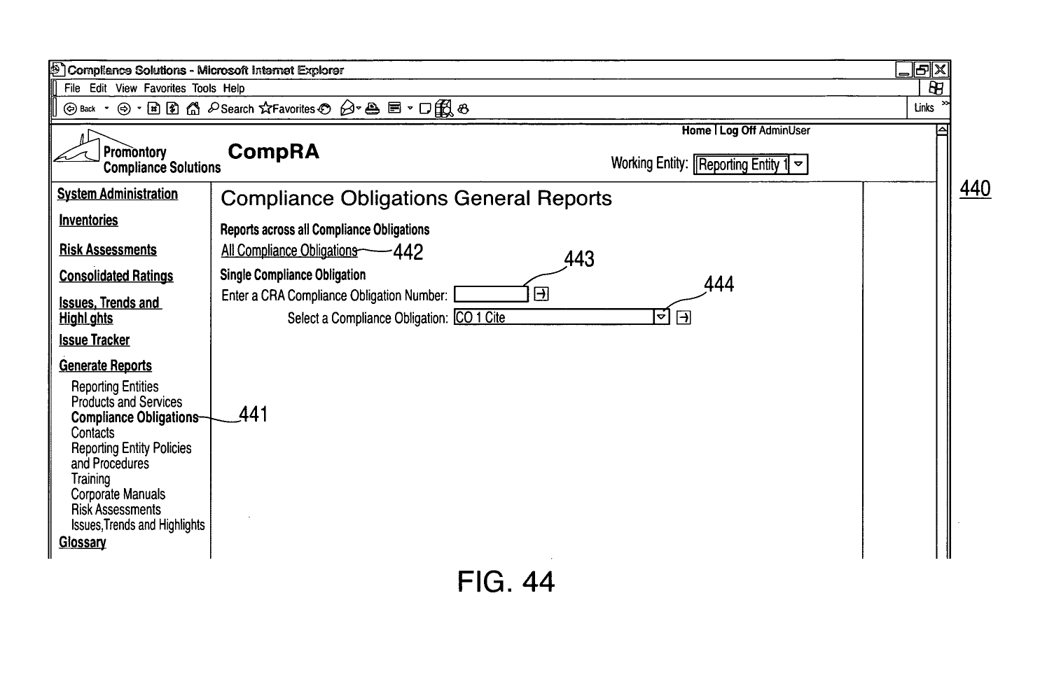

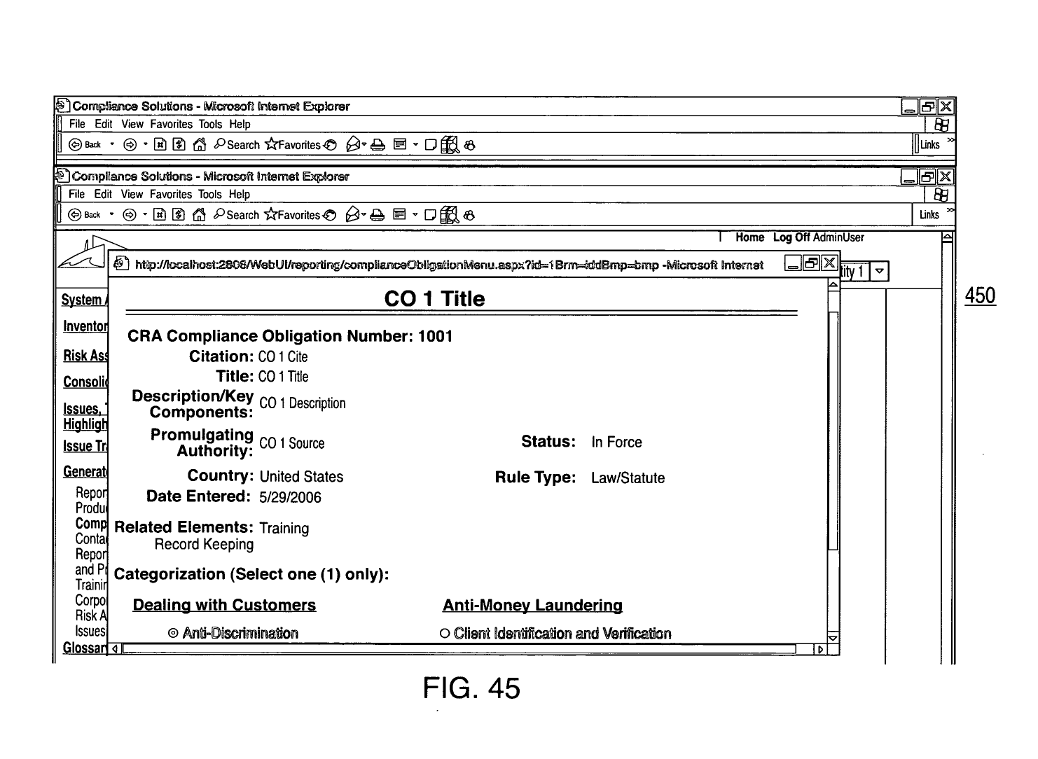

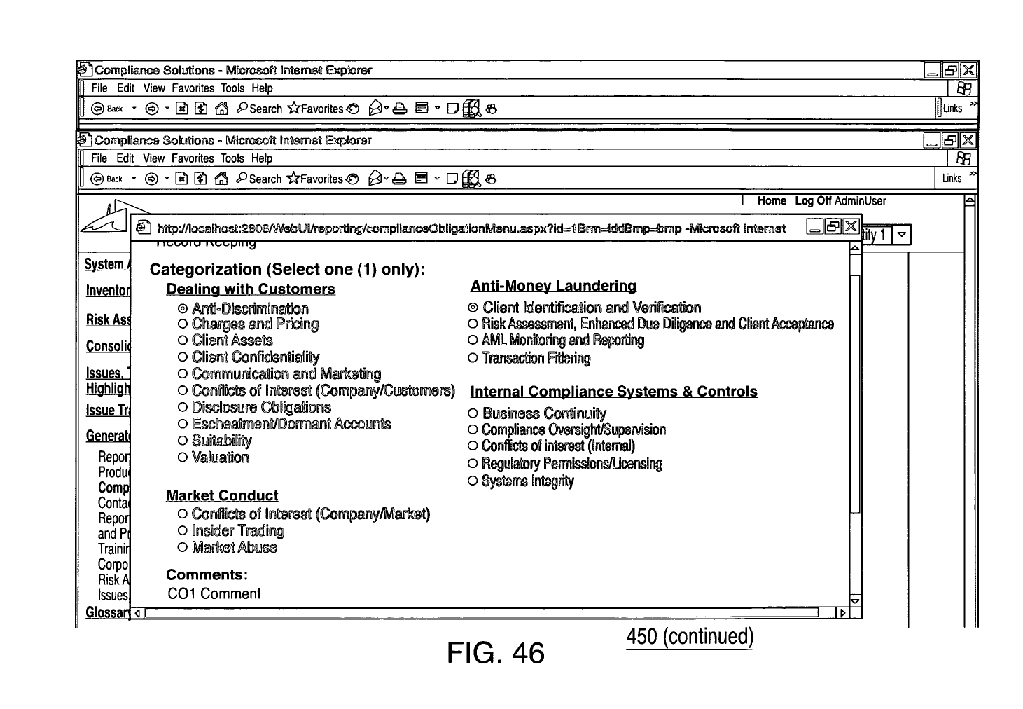

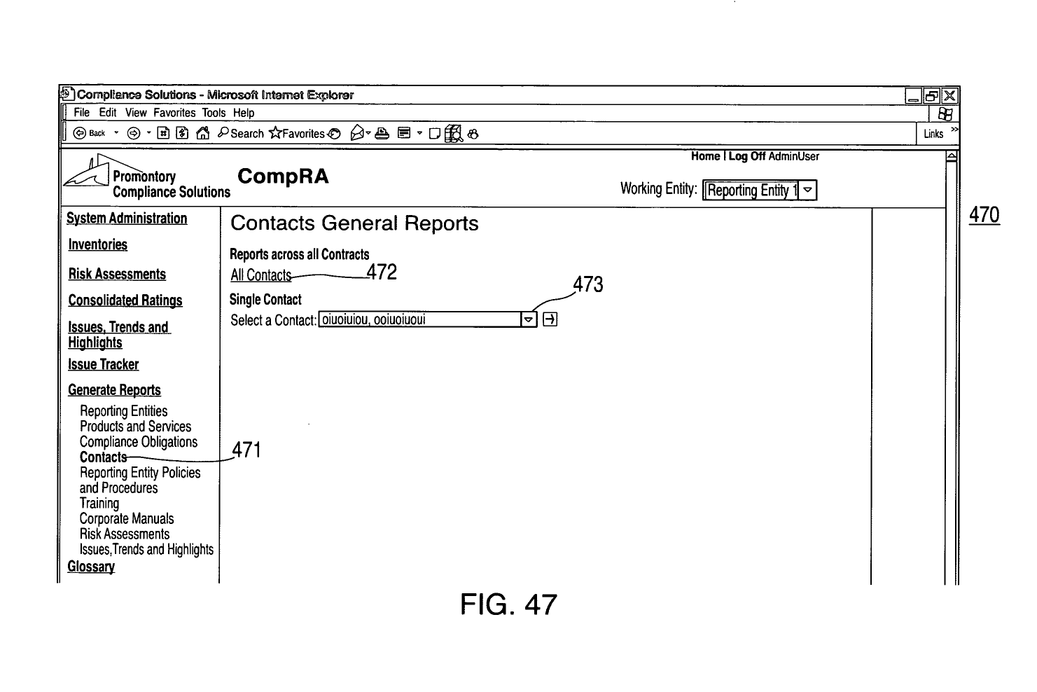

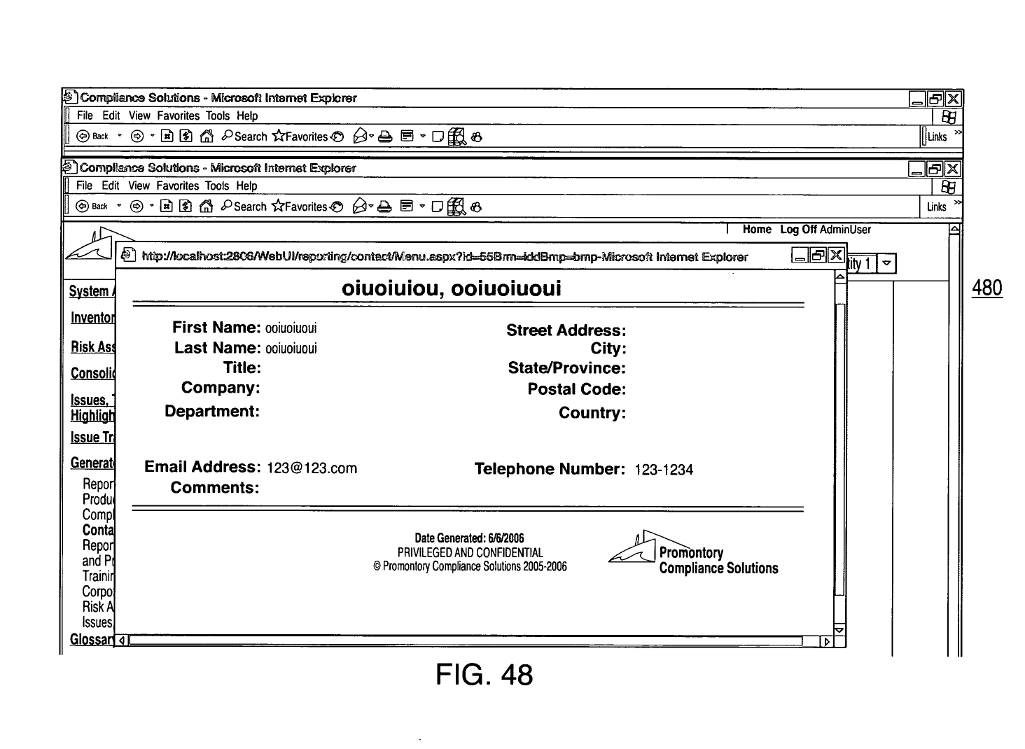

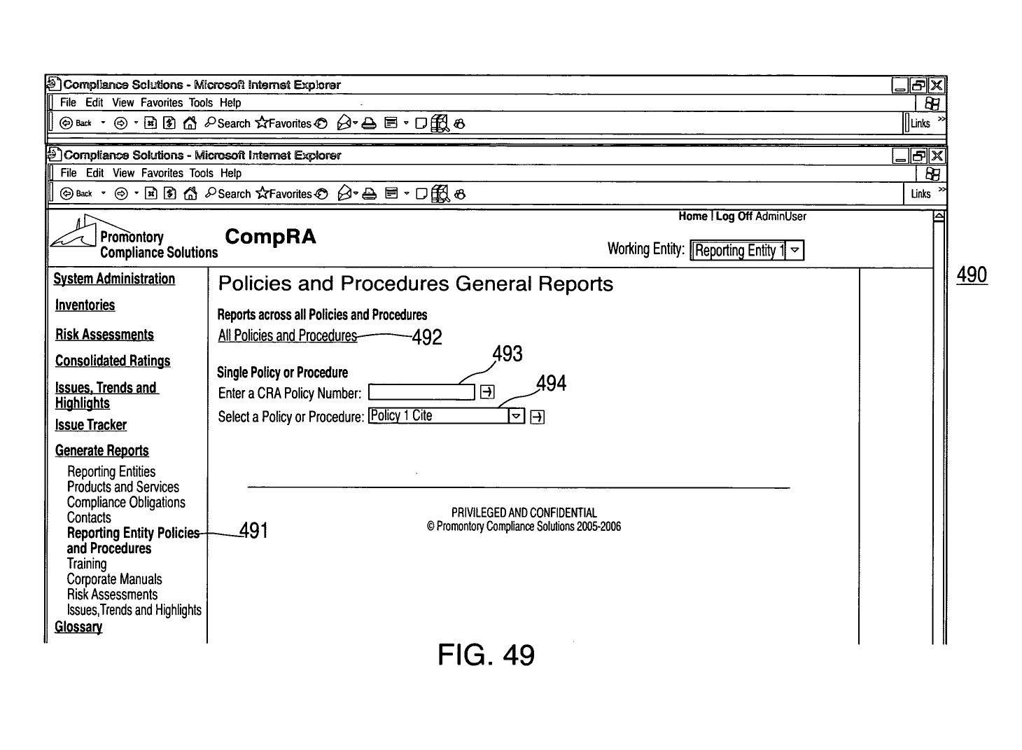

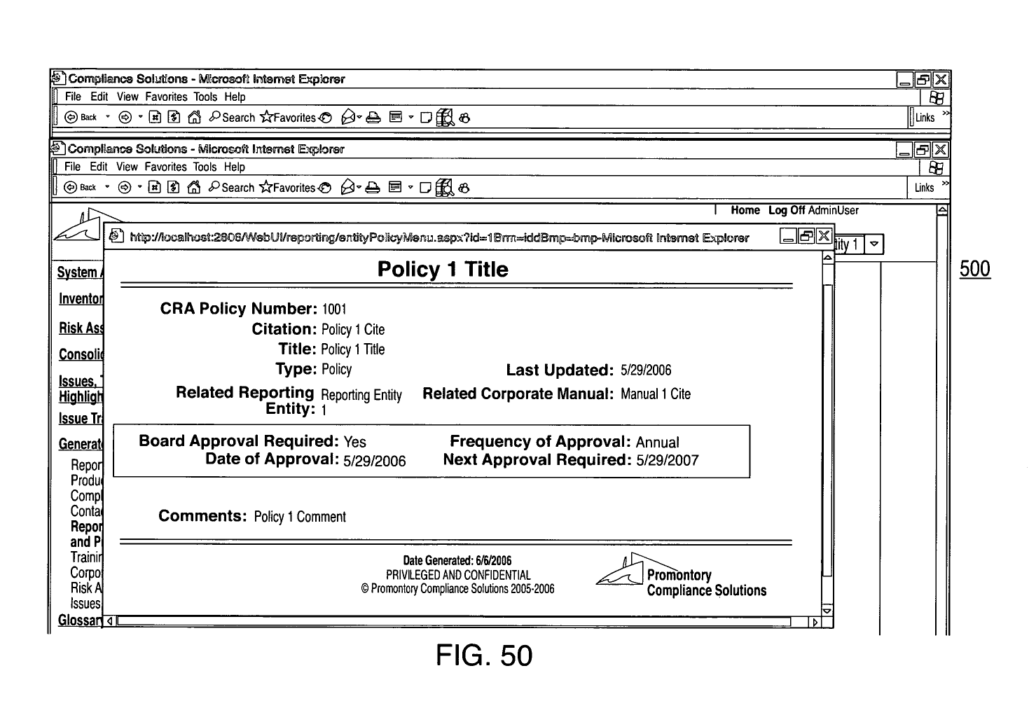

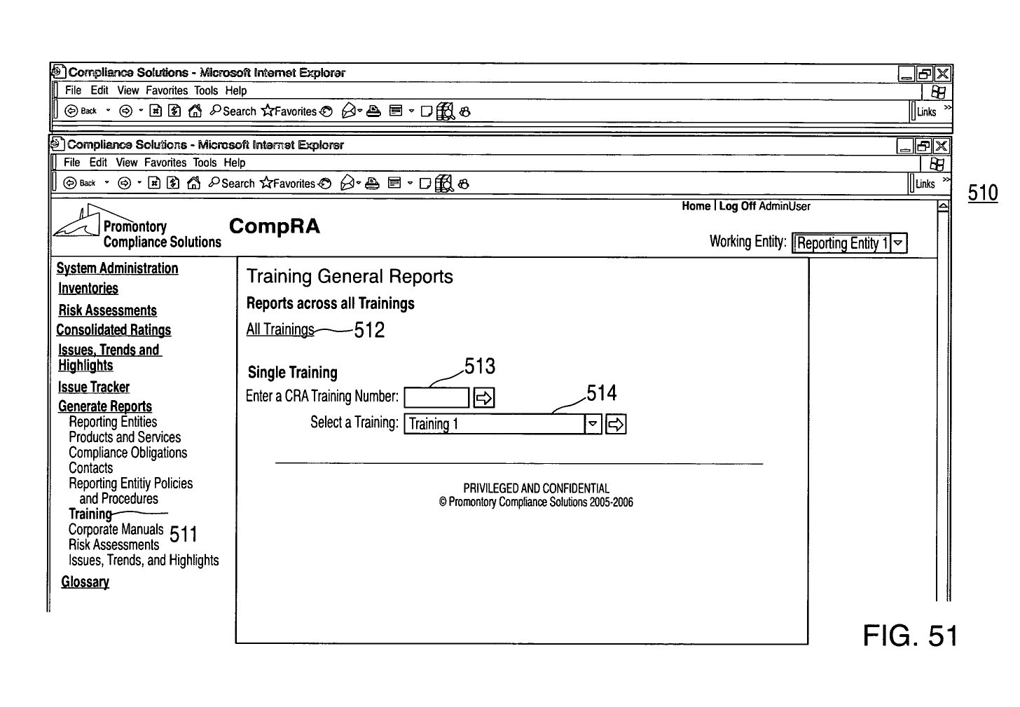

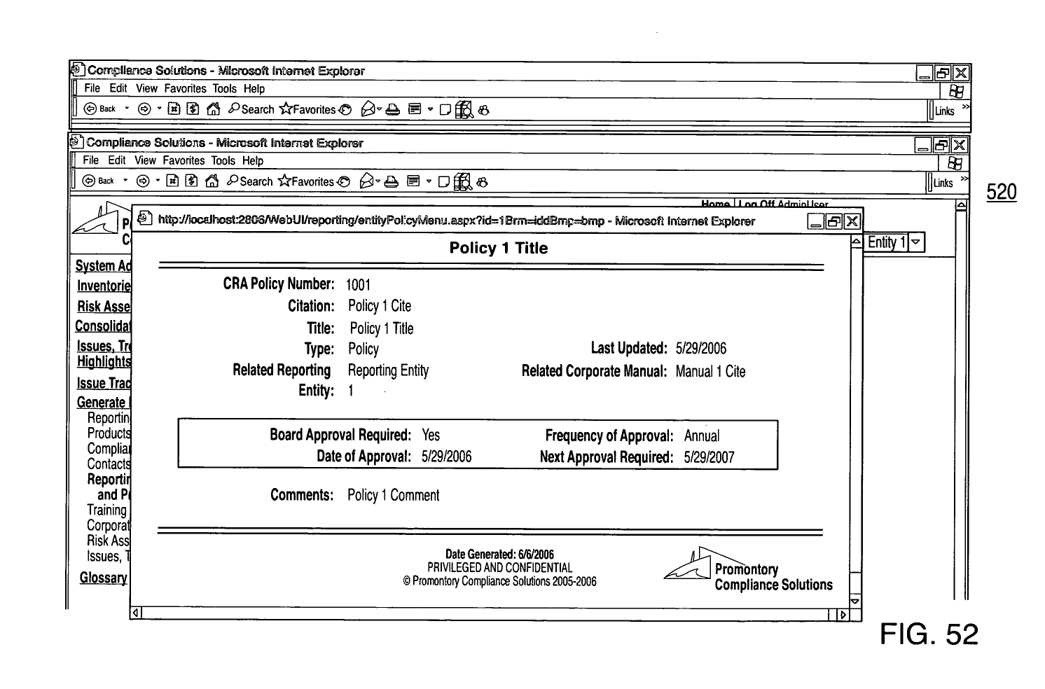

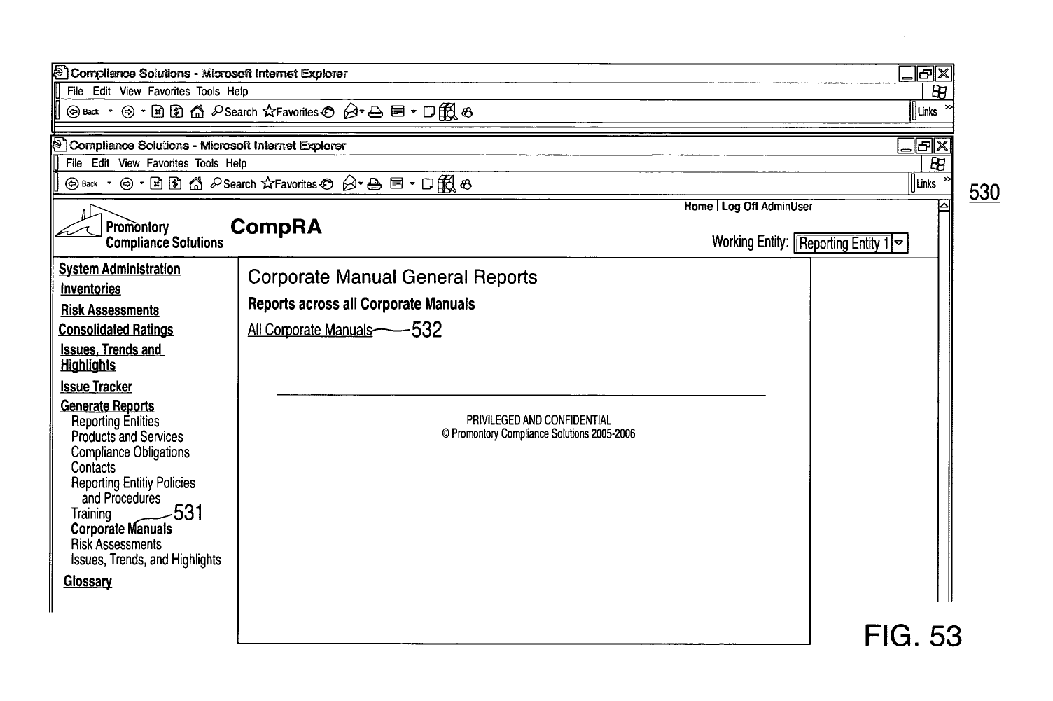

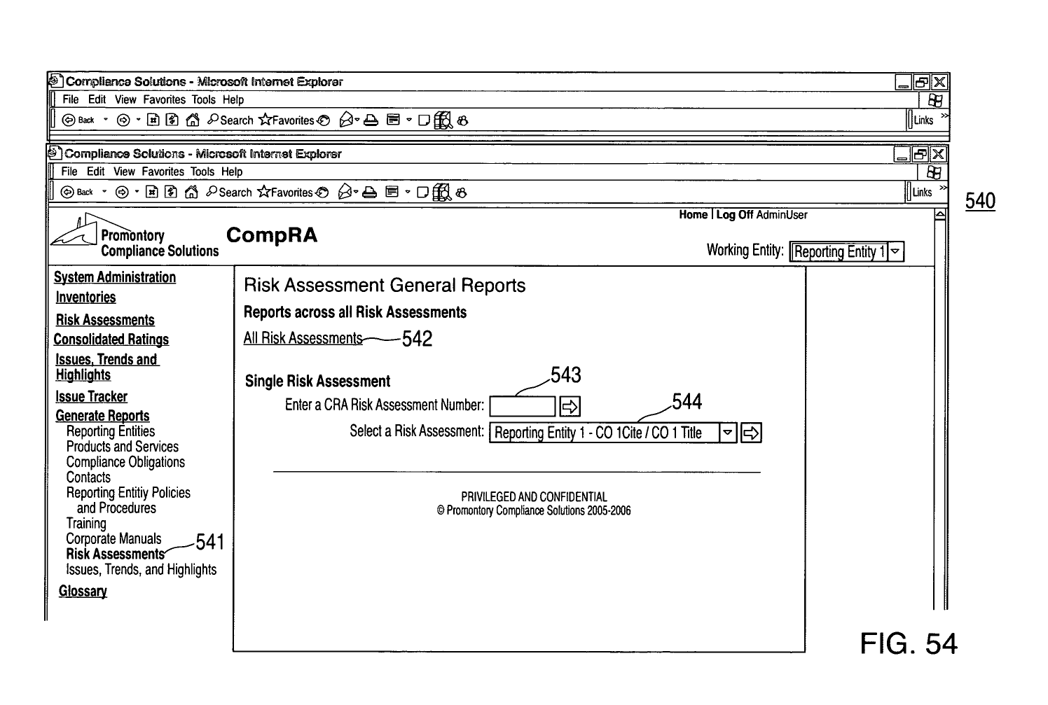

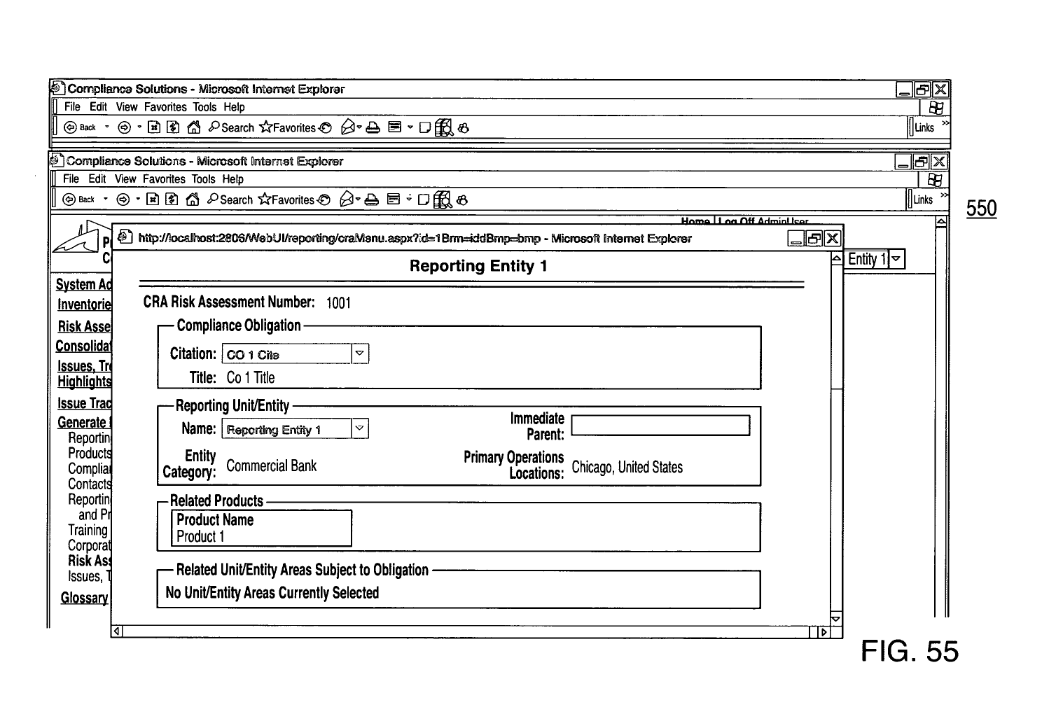

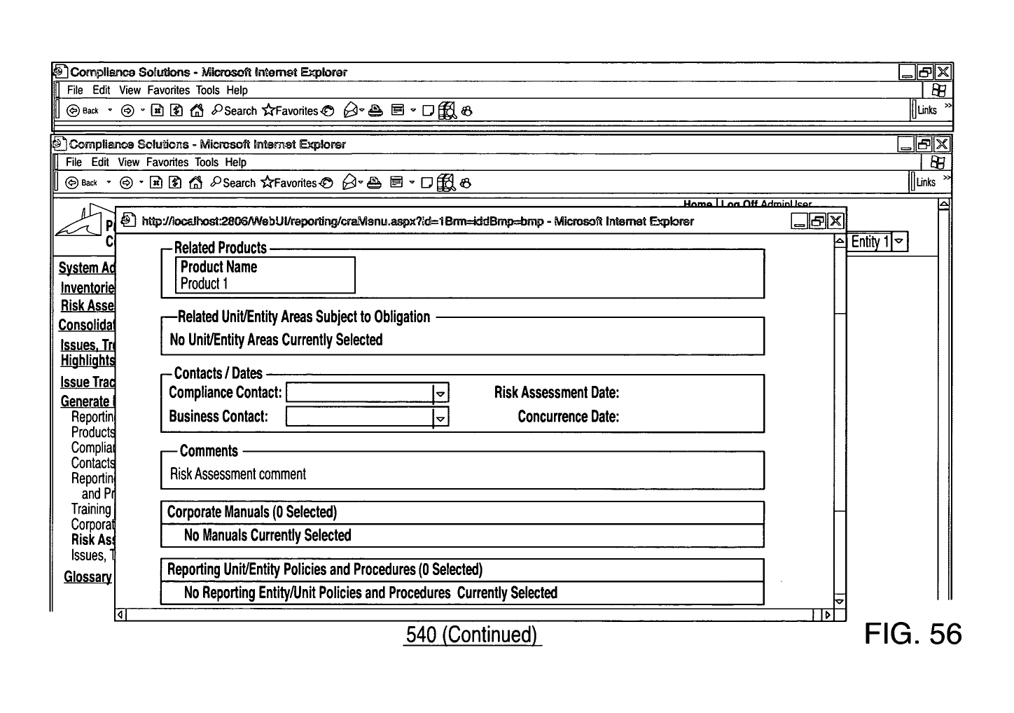

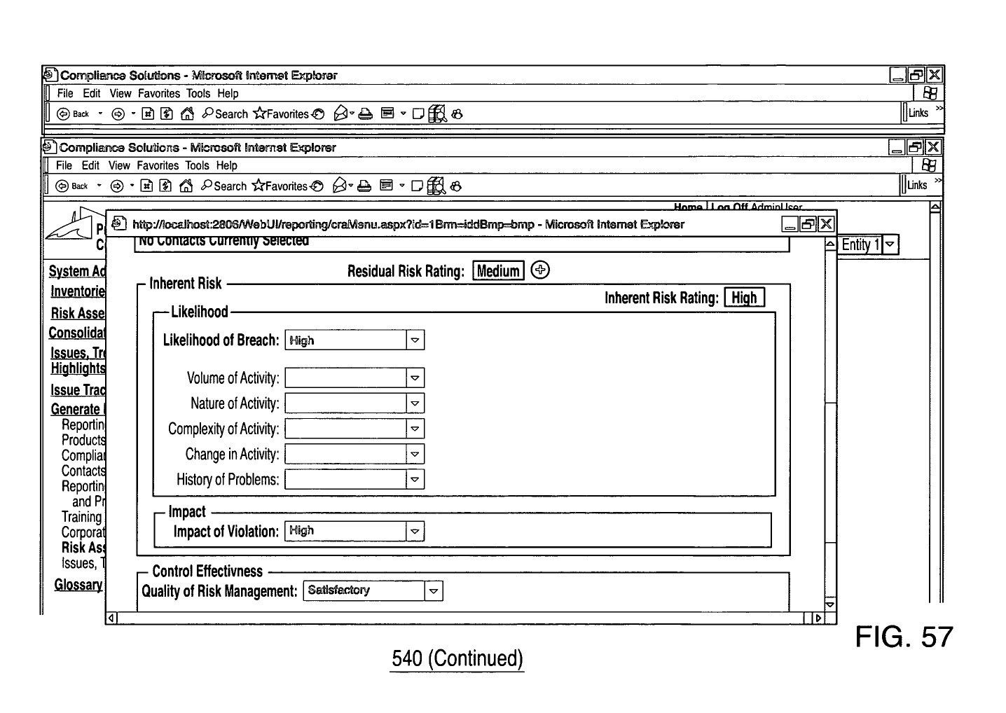

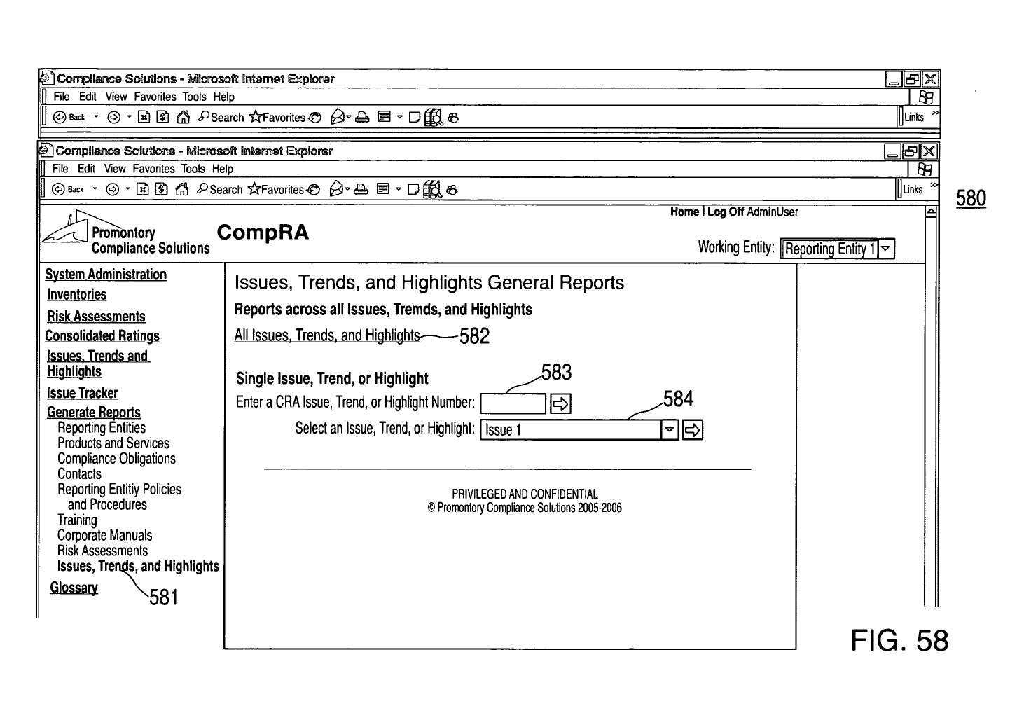

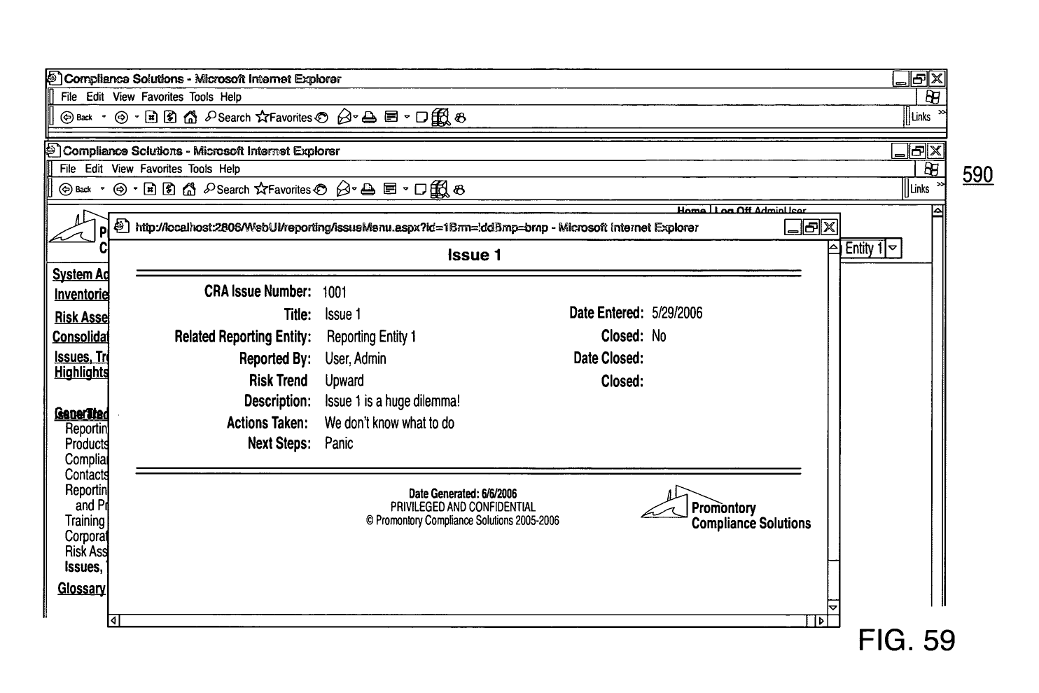

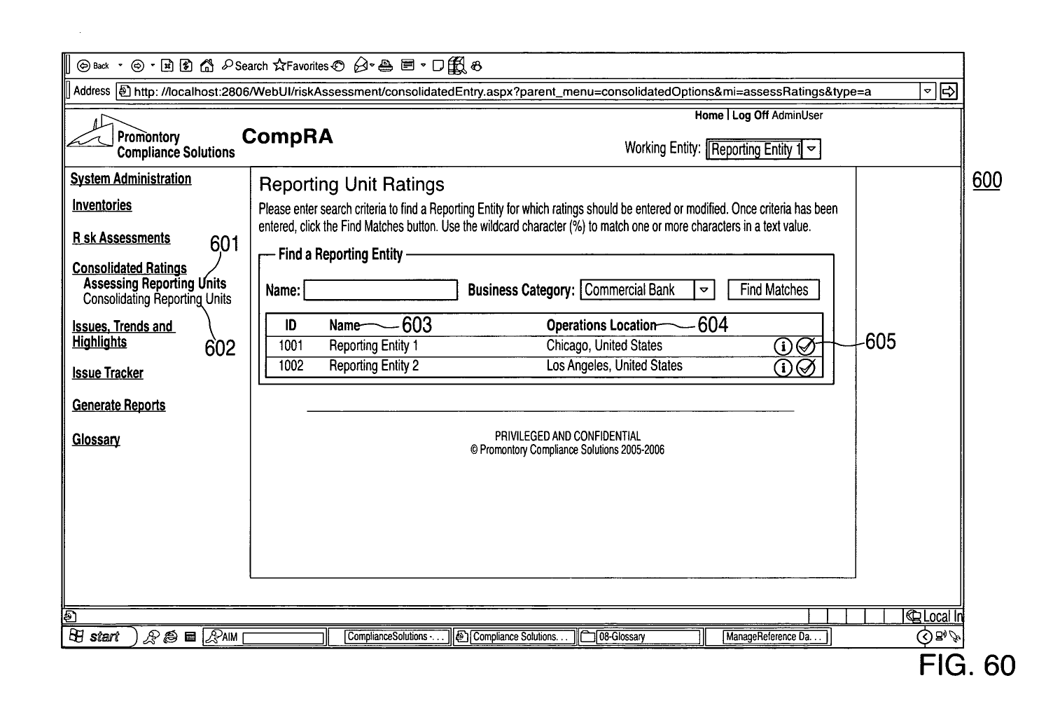

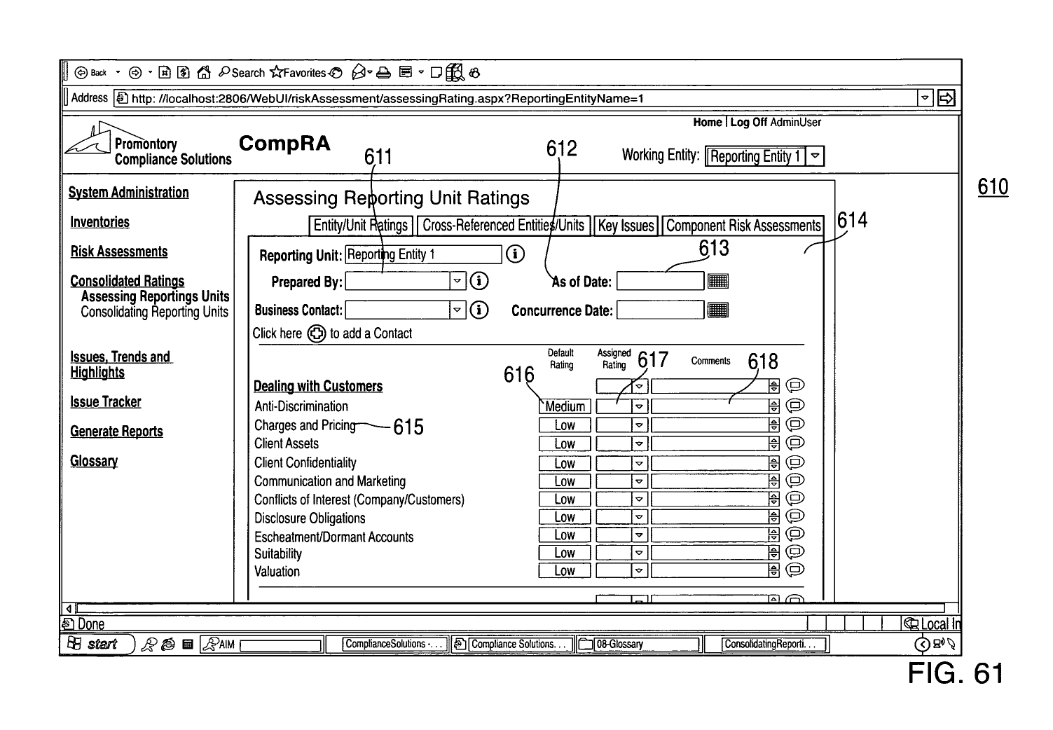

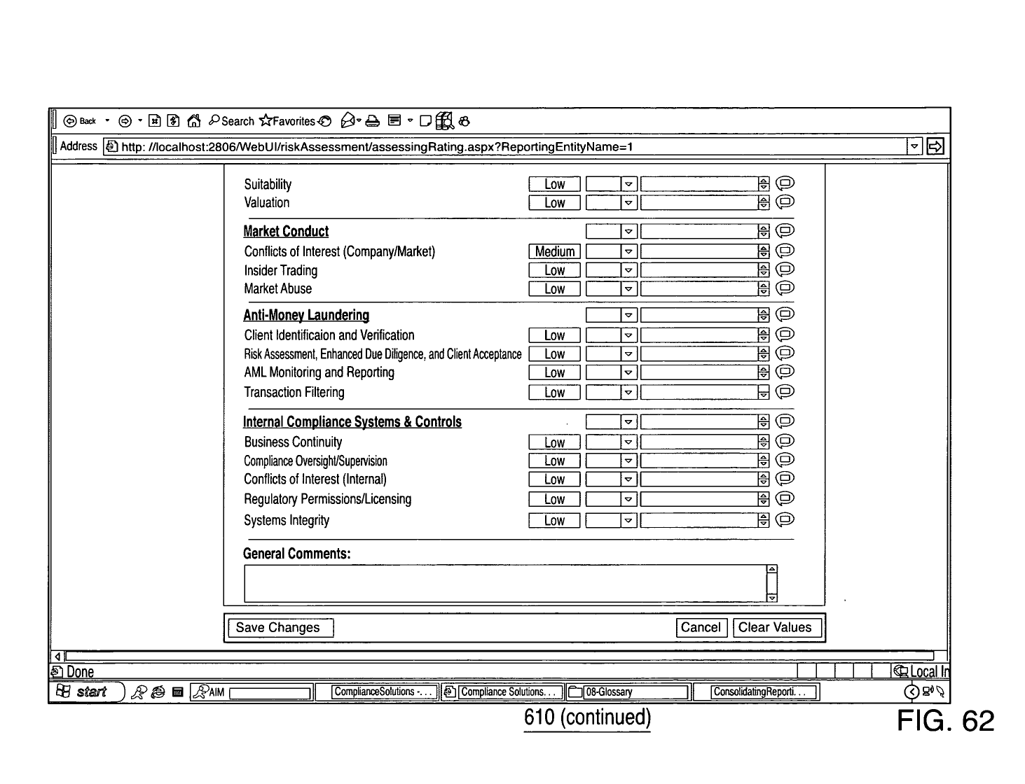

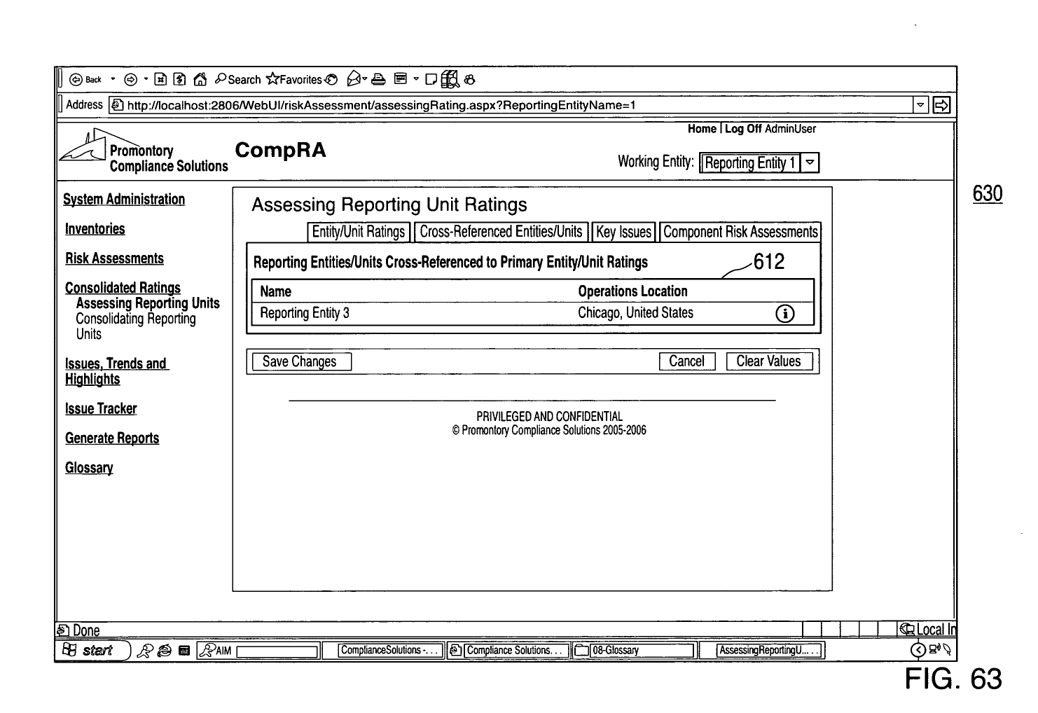

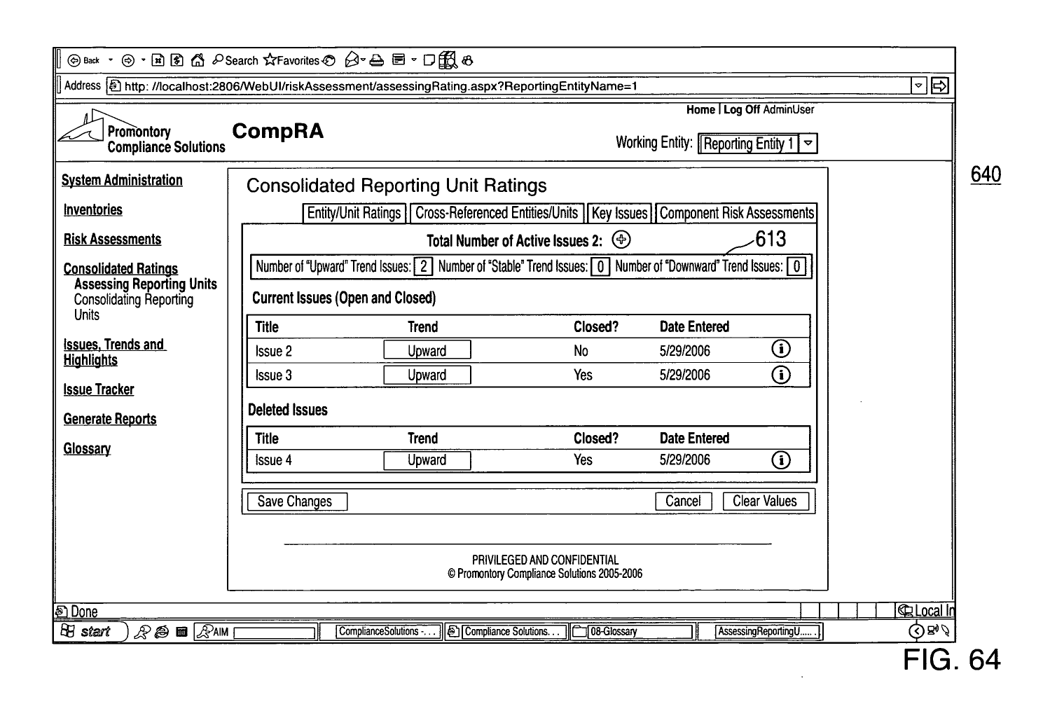

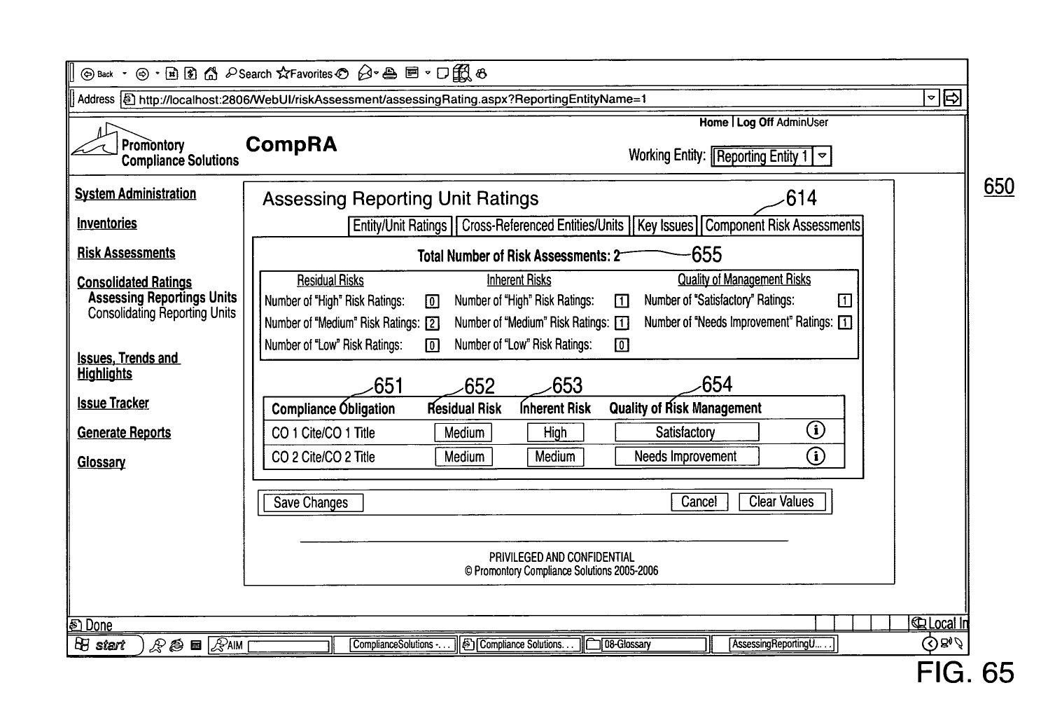

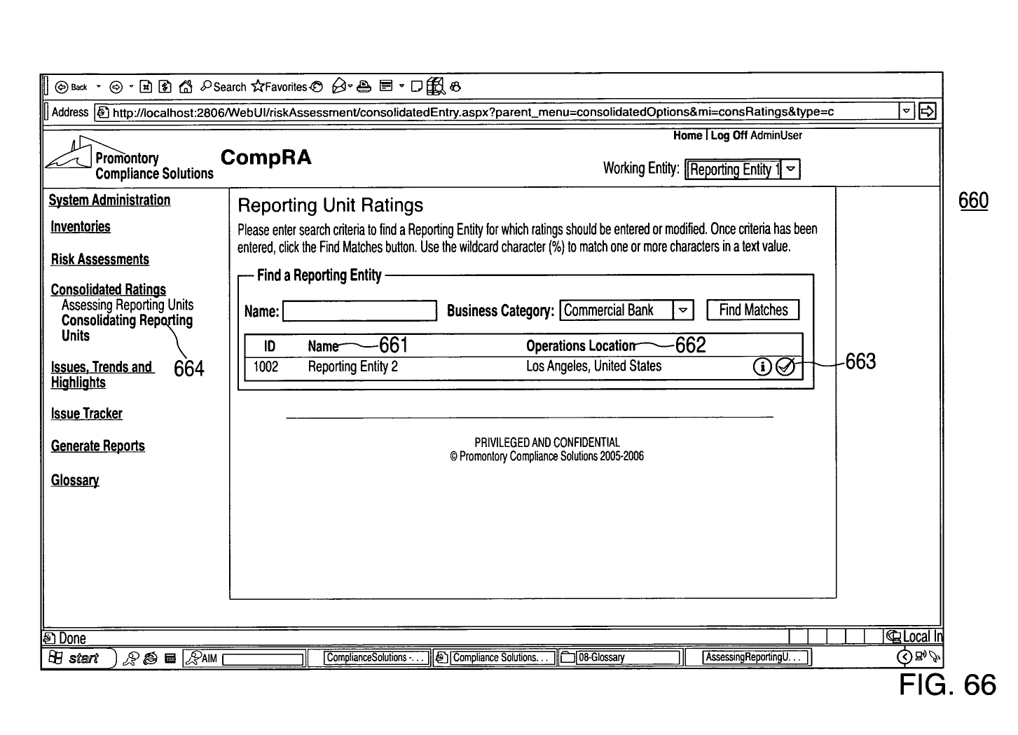

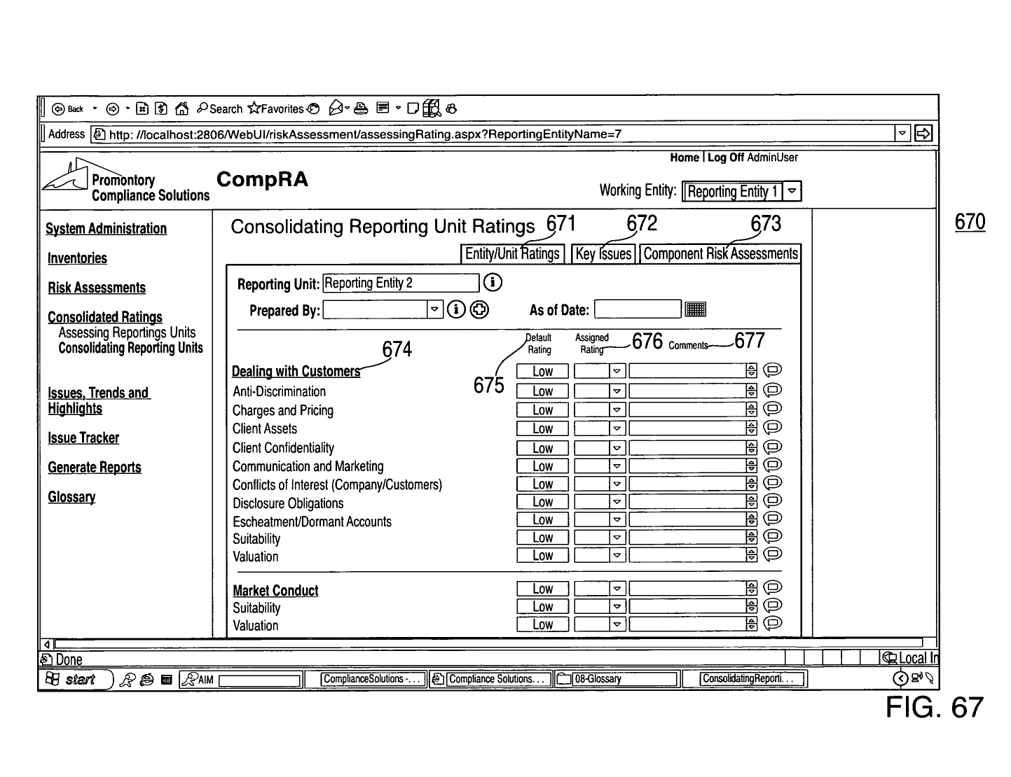

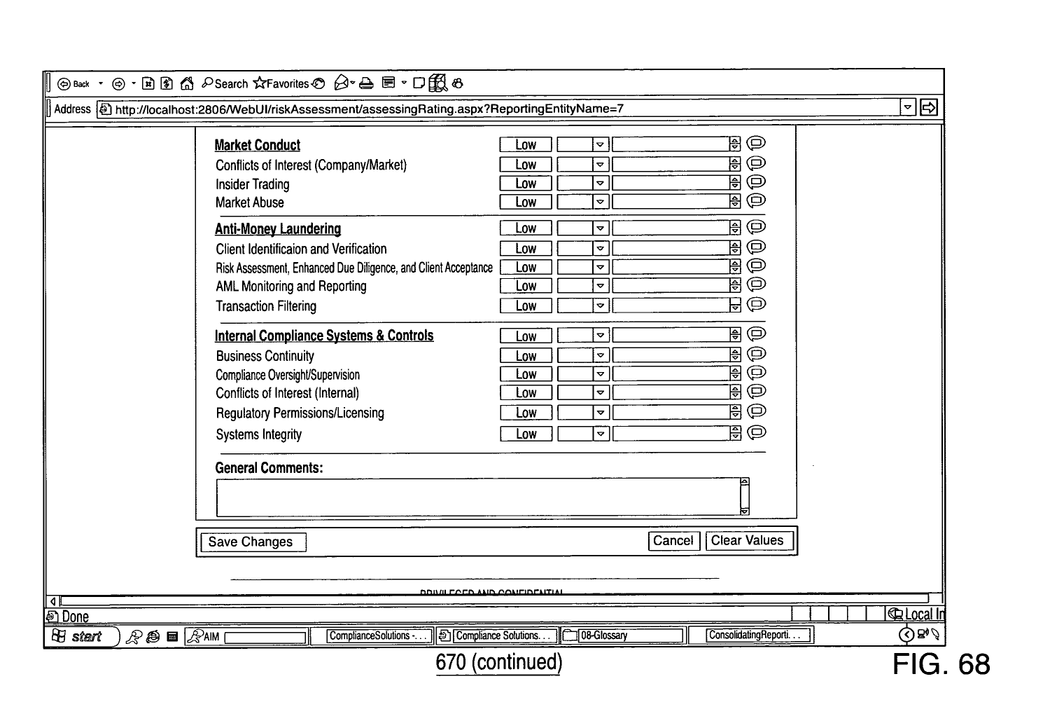

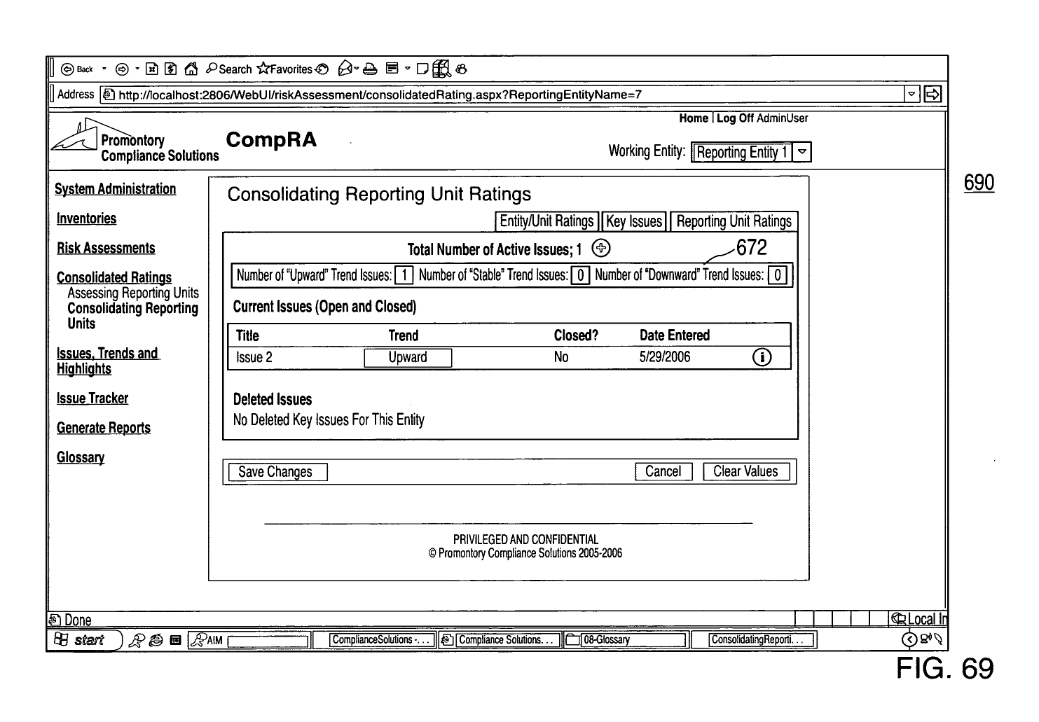

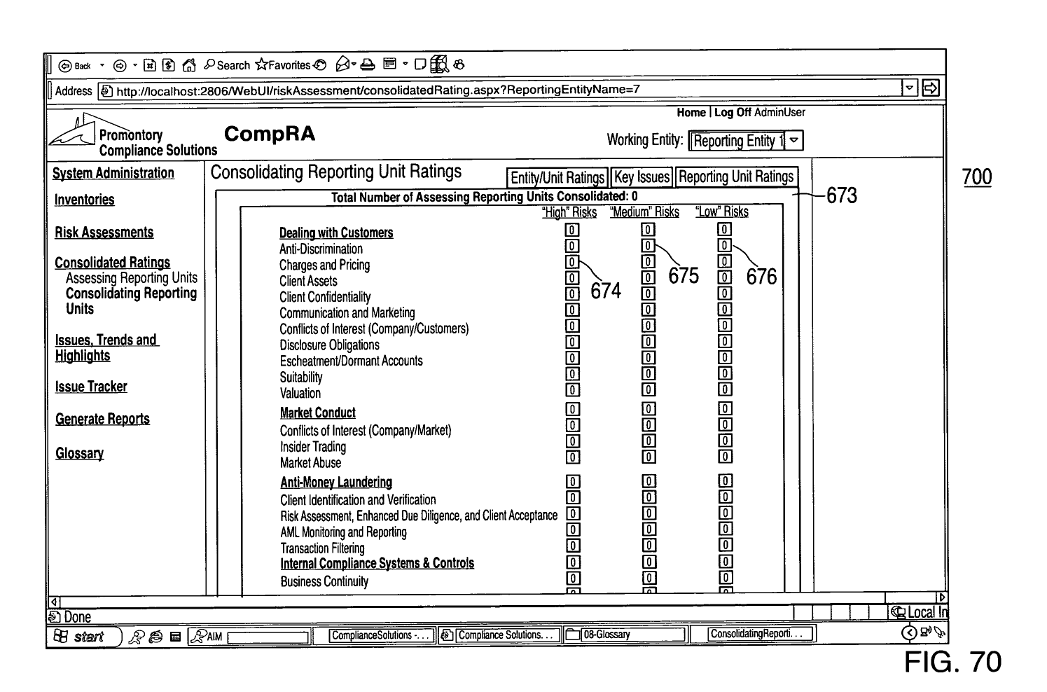

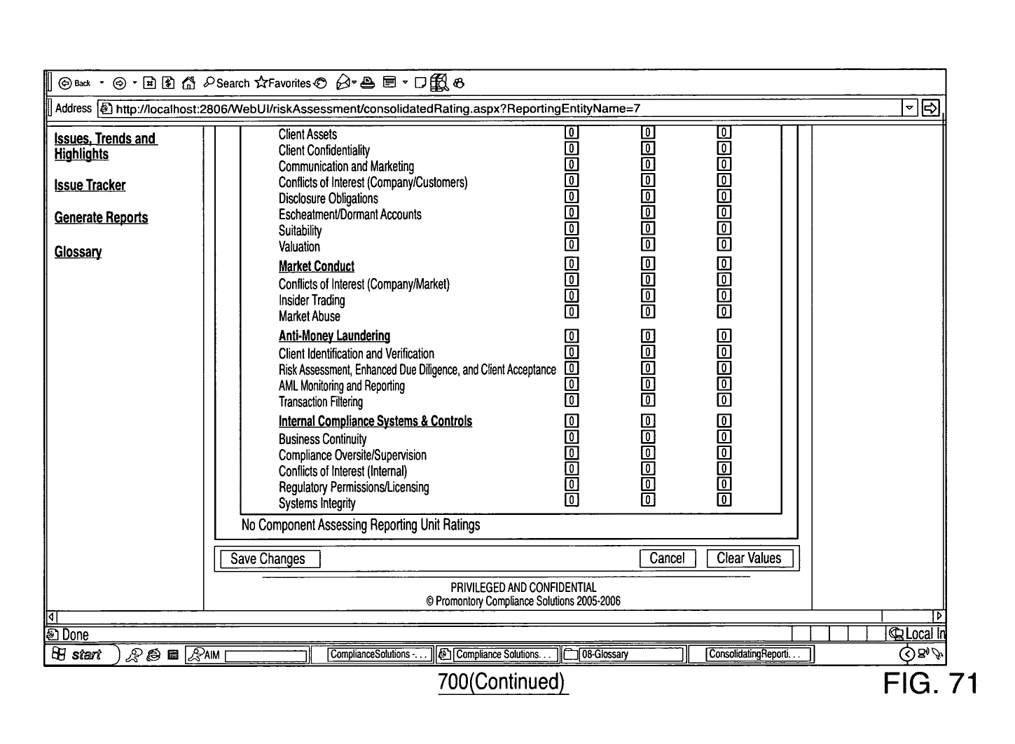

Some compliance obligations attach to specific products. For example, mortgage products are subject to special rules of disclosure. As another example, investment products are subject to special rules relating to such things as suitability and best execution. For that reason, the compliance risk manager contains a tool for building an inventory of products and services and the option to associate each product or service with one or more reporting entities and one or more compliance obligations. Screen shots of the data input form for the products and services catalogue are shown in FIGS. 1-71.

Compliance Obligation Inventory

The compliance obligation builds a dynamic inventory of compliance obligations from the bottom-up. Having first mapped the enterprise to one or more dimensions via the enterprise builder, a compliance risk manager views each vector of the enterprise for which he or she is responsible and identifies the compliance obligations that apply to that vector. The user may either supply his or her own description of a compliance obligation or select from a drop-down list that is populated with specific compliance obligations, such as the anti-money laundering and counter-terrorist financing obligations of the Bank Secrecy Act, the Trading with the Enemy Act, and the International Emergency Economic Powers Act and their implementing regulations. The result is an inventory of compliance obligations that apply to the entire enterprise, as well as a map of how those obligations relate to any one component of the enterprise. By relating each compliance obligation to different compliance categories (e.g., obligations that protect customers; obligations that protect counterparties; obligations that relate to preventing financial crime), as well as to different compliance sub-categories, the user can produce a map of compliance obligations in varying degrees of relief. A higher-level view that lends itself more readily to comparisons of compliance risk across the enterprise, as well as more granular views, is now possible.

Use of the compliance obligation inventory module is likely to produce an inventory of compliance obligations that affect the entire enterprise more efficiently and with less expense than a top-down approach, since draws upon existing expertise of local compliance professionals within an enterprise.

Use of the compliance obligation inventory module is also likely to produce more accurate results, since it forces the compliance professional to think about the organization for which he or she is responsible from multiple perspectives—the legal entity perspective, the business unit perspective, the client perspective, the product perspective, the market perspective, and the like. Also, since the obligations are identified by category and subcategory of organization and then mapped unto a multi-dimensional model of the organization, the compliance obligation inventory module can identify discontinuities in coverage of a compliance obligation category or subcategory. Mathematically, that discontinuity could be represented by a comparison of different entity vectors:
V1=( . . . , x1,y1,z1,cgc1,csc1,cso1, . . . )
V2=( . . . , x2,y1,z1,0,0,0, . . . )
V3=( . . . , x3,y1,z1,cgc1,csc1,cso3, . . . )

Where x, y, and z equal enterprise dimensions such as geography, client segment, product segment, and cgc equals “compliance: general category”, csc equals “compliance subcategory, and cso equals “compliance specific obligation.” In practical terms, these vectors could depict an enterprise where operations in countries 1, 2, and 3, each involve the same client segment and product type, but compliance obligations have been mapped only for countries 1 and 3, not for country 2. The enterprise, as part of the quality assurance around use of the compliance risk manager could evaluate whether the discontinuity in the map of compliance obligations was attributable to a user overlooking a relevant compliance obligation or to a lacunae in the law of country 2. In this way, the combination of the compliance obligation inventory module and the enterprise vector module can facilitate the production and maintenance of more accurate compliance obligation inventories.

The following table depicts a representative example of compliance general categories and compliance subcategories:

| Compliance General | |
|---|---|
| Category | Compliance Subcategory |
| Dealing with Customers | Anti-Discrimination |
| | Charges and Pricing |
| | Client Assets |
| | Client Confidentiality |
| | Communication and Marketing |
| | Conflicts of Interest |
| | (Company/Customers) |
| | Disclosure Obligations |
| | Escheatment |
| | Suitability |
| | Valuation |
| Market Conduct | Conflicts of Interest |
| | (Company/Market) |
| | Insider Trading |
| | Market Abuse |
| Anti-Money | Client Acceptance - Know Your |
| Laundering | Customer |
| | AML Monitoring and Reporting |
| | Transaction Filtering |
| Internal Compliance | Business Continuity |
| Systems and Controls | |
| | Compliance Oversight/Supervision |
| | Conflicts of Interest (Internal) |
| | Regulatory Permissions/Licensing |
| | Systems Integrity |

Compliance Risk Management Module

The compliance risk management module 754 shown in FIG. 75 relies on a relational database of business units, compliance obligations, and products and services. By mapping compliance obligations to products and services and business units, a multi-dimension view of compliance risk can be created.

The Compliance Risk Management module contains a simple, easy to use, web-based method for creating and maintaining a multi-dimensional assessment of compliance risk that permits aggregation and comparison of compliance risks across an organization.

Once the enterprise has mapped compliance obligations onto the enterprise vector, the enterprise should assess the risks of violating the compliance obligation. In this regard, complex organizations face a challenge in that different regulators often prefer different methods of assessing compliance risk. Also, the skill sets of compliance professionals in different jurisdiction may vary. The compliance risk assessment module allows an enterprise to choose the ways in which compliance risk is measured. In one manifestation of the invention, the enterprise can pre-populate the module with an enterprise-preferred method of measuring compliance risk and allow the users to depart from that module for documented reasons. For example, the enterprise can adopt a method of assessing compliance risk that is based on the following formula:
Residual Risk=f(Inherent Risk, Control Effectiveness)

Where “Inherent Risk,” “Control Effectiveness,” and “Residual Risk” have the following definitions:

“Inherent Risk” is a function of (1) the probability of a compliance violation occurring absent any controls to mitigate the likelihood of a violation or the severity of a violation should one occur, and (2) the impact of a compliance violation.

Where “Control Effectiveness” is an assessment of whether controls are reasonably designed to prevent a compliance obligation from occurring whether the controls are appropriately documented, and whether the controls are monitored and tested with satisfactory results.

Where “Residual Risk” is the risk of a compliance violation that remains after considering Inherent Risk and Control Effectiveness.

The compliance risk assessment module enables enterprises to manage risk, as well as assess them. For example, in order to assess control effectiveness, the use of the risk assessment module must identify and document the key controls that mitigate the probability of a violation occurring. The user must then identify the “owner” of the control. The use must next identify whether the control is monitored and tested, by whom, and with what result.

Once entered or derived, compliance risks can be aggregated and presented to senior compliance professionals, senior management, or the Board of Directors in different ways. For example, aggregate assessments of compliance risk by category and sub-category of compliance obligation can be formed by assigning an aggregating rating equal to the highest risk rating of any component unit. The compliance professional responsible for preparing the aggregated report can choose to assign a lower rating for documented reasons (such as where the higher rating is driven by a rating for a component that is a very small portion of the business being aggregated).

Monitoring and Testing Module

The compliance risk manager can also include a monitoring and testing module. This module provides a mechanism for a compliance officer to allocate monitoring and testing resources by compliance risk to ensure that key controls are monitored and tested at an appropriate frequency. In one manifestation, monitoring and testing resources can be allocated according to the reduction in risk attributable to control effectiveness. For example, if a compliance obligation has high inherent risk but low residual risk, the organization is highly dependent on the effectiveness of the relevant controls and should allocate more resources to the testing of these controls. Any exceptions identified by the monitoring and testing module can be logged in the database.

Compliance Commitment Tracker

Organizations frequently make commitments to take particular compliance actions in addition to or related to their compliance obligations. These can include: commitments made to regulators, commitments made to internal or external auditors, commitments made to the Board or senior management. Tracking these commitments can be a challenge for many organizations. But it is especially important for the organizations to meet the challenges. For example, the enforcement policy of the Office of the Comptroller of the Currency cites the existence of repeat violations as a reason for taking bringing an enforcement action. Notwithstanding this, organizations have proven to have difficulty in executing on their commitments. See, for example, publicly available press reporting on enforcement actions brought against Riggs Bank and Deutsche Bank, others. Accordingly, financial institutions need a compliance commitment tracker. This invention links the compliance commitments to assessments of compliance risk so that as an organization assesses its risks, it pays prominent attention to whether there is an outstanding commitment with respect to that risk.

Compliance Risk Assessment Methodology

FIGS. 1-71 depict exemplary embodiments of various screen shots produced by a software program that enables one or more users to create and edit a database for a particular organization, then associate particular risks with various parts of the organization and relate those risks to each other, as desired, according to one aspect of the present invention. Other aspects of the invention will be apparent based on the following description.

FIG. 1 depicts an initial login screen 10 via which a given user gains access to the software program by entering a user ID and password in the login fields 11 and clicking on the login button in the customary manner. Certain functions of the system are common to all users. Common functions include logging in and out of the system and navigating through the system.

To log into the system from the Login page 10, a user types his or her login user ID in the User Name field 12 in the login portion 11 of screen 10. A user name is assigned and controlled by the system administrator. The user then types his or her password in the Password field 31. The system administrator may assign the initial password. The system administrator may determine password requirements, such as number of spaces and whether it is case sensitive.

To recall a forgotten password, a user can click the Forgot Your Password link 15 in the lower left corner of the login portion 11 of screen 10. After typing the login user ID in the User Name field 12 and pressing submit, the password will be sent via email to the email address registered with the user ID.

If invalid information is entered in the User Name field or the Password field, a message will appear stating that the Log In attempt failed and prompting the user to try again. The login user ID is associated with the user's role and is displayed in the upper right corner of every page (see element 16, FIG. 2) after a successful login. The login user ID identifies the user as: Administrative User—users who set up and maintain system options and parameters; Compliance User—users who perform data entry, data editing, and functional tasks, including compliance risk assessments; Business Concurrence User—users who perform limited data editing and functional tasks, which may include compliance risk assessments; Compliance Approval User—users who perform limited data editing and functional tasks, and which may include compliance risk assessments and/or approvals; or Read Only User—users who view data but do not perform data entry, data editing, or functional tasks. The password is a security code known only to the user and the system administrator. The password may be initially be assigned by the system administrator. This password prevents unauthorized users from logging onto the system and performing actions for which they are not authorized. For additional security, the password is not displayed as it is entered.

To log out of the system, the user click the Log Off link in the upper right corner of any page (see element 17, FIG. 2). For security purposes, the user may be automatically logged out of the system if the keyboard is idle for 30 minutes or more.

Turning to FIG. 2, there are certain system wide navigation and actions possible. The system provides the user with system-wide links that are displayed on every page. The system-wide navigational elements are presented as textual navigation. These links allow users to navigate to different functional areas in the system. Two links, Home 18 and Log Off 17, appear in the upper right corner of each page (along with the current user ID 16). The remaining system wide links (i.e., the main menu) are listed vertically on the left side 21 of every page. Table 1 below lists the navigational links and a description for each.

TABLE 1

| Navigational Link | Description |
|---|---|
| Home | Returns the user to the first page displayed |
| | after logging on to the system |
| Log Off | Ends the session; returns the user to the |
| | Login page |
| System Administration | Select this link to manage and create new |
| Note: This link only | users or to manage reference data |
| appears to users | |
| designated as system | |
| administrators | |
| Inventories | Select this link to enter or edit (if the user |
| | is authorized to perform data entry) or |
| | review descriptive information on |
| | compliance-related risk elements |
| Risk Assessments | Select this link to perform risk assessments |
| Consolidated Ratings | Select this link to conduct consolidated |
| | assessments after risk assessments have |
| | been performed |
| Issues, Trends, and | Select this link to enter or edit (if the user |
| Highlights | is authorized to perform data entry) or |
| | review relevant issues, trends, and |
| | highlights |
| Generate Reports | Select this link to review and print |
| | available reports |
| Glossary | Select this link to view a glossary of |
| | relevant terms |

Many of these functional areas have sub-categories for navigation discussed later. The system-wide navigational textual links and their descriptions are listed in Table 1. After selecting any of the system-wide links described below, the user accesses a functional area.

The system offers the ability to filter some data at a system level using a drop down selection field 23. This drop down field 23, located in the upper right corner of the screen just below the Home and Log Off links and User ID, allows the user to switch the context of the current reporting entity.

There are three types of pages in the exemplary embodiment, which three pages include: the home page (see FIG. 1), list pages (e.g., see FIG. 6) and detail pages (e.g., see FIGS. 7-8). The Home page 10 is the default screen, after logging into the system.

List pages contain general information about data records in each functional area. List pages contain rows of data organized into columns. FIG. 6 displays a typical list page. Available actions applicable to list pages include: Create New 63; Jump To ID—Go 67; Edit or View 69; and Delete 59. The availability of actions varies from page to page depending on tasks that are being performed by the user. A user's authorization determines whether a selection is editable or read-only.

TABLE 2

| | Description |
|---|---|
| List Page Buttons | |
| Create New 63 | Select this button to enter a new list item. |
| | Opens a detail page for data entry. |
| Jump To ID - Go 67 | Enter an ID number in this field and select |
| | the “Go” button to navigate to another |
| | entry on the list page. |
| List Page Icons | |
| Edit or View 69 | Select this icon to view or edit more |
| | detailed information about a list item. |
| | Opens a detail page for data entry. |
| Delete 59 | Select this icon to delete a list item. |

To create a new record, the user presses the Create New button 63 in the upper left of the page. To navigate to a particular list item, the user enters the ID number of the desired entry in the Jump To ID: field 67 in the upper right of the page and presses the Go button next to the Jump To ID: field 67. To edit a list item or view more information about it, the user clicks on the “pencil” icon 69 at the end of the specific list item. When a list item is selected for viewing or editing by using the “pencil” icon 69, a detail page appears displaying more information about that item (e.g., see FIG. 7). To delete a list item, the user clicks on the “X” icon 59 at the end of the line of data to delete. Table 2 shows the available actions applicable to most list pages.

Detail pages are pages in which the user may enter data for a new item, edit data for an existing item, or view detailed information about an item. Detail page data can be editable or read-only depending on the user's authorization. Detail pages contain specific information for a particular item and may consist of additional pages of information. After an item is selected from a list page by using the “pencil” icon 69, detail pages for that item can: Display additional information; Provide data entry fields to enter or modify information; or Show actions that can be performed on that item.

Available actions applicable to detail pages include: Save Changes 83; Cancel 84; Clear Values 85; Find Matches; and Add. There are also two features that allow the user to view more information about a record or insert a date. They are Detail and Insert Date. The availability of actions and features varies from page to page depending on tasks that are being performed by the user. A user's authorization determines whether a selection is editable or read-only.

Detail page buttons include the following. To save changes made to a record, the user presses the Save Changes button 83 at the bottom left corner of the page (e.g., see FIG. 8). To undo any changed information in a field(s) and navigate away from the current page in use, the user presses the Cancel button 84 at the bottom right of the page. To undo any changed information in a field(s) and stay on the same page currently in use, the user presses the Clear Values button 85 at the bottom right of the page.

Detail page icons include the following. These icons only appear next to an applicable individual item. To view more detailed information about an item, the user selects the “i” icon 86 next to the applicable data field. To add a new item, the user selects the “plus sign” icon 87 next to the applicable data field. To insert a date into a date field, the user selects the “calendar” icon 88.

Table 3 below shows the available actions and features applicable to most detail pages.

TABLE 3

| | Description |
|---|---|
| Detail Page Buttons | |
| Save Changes 83 | Select this button to save changes made to an item(s). A green |
| | check mark and message will inform user if the record was |
| | successfully saved. If required fields are not complete or are |
| | invalid, a red error message will inform the user which field(s) |
| | to add/revise. |
| Cancel 84 | Select this button to undo information typed into a field(s) on a |
| | data entry page and navigate away from the page. A message |
| | will appear warning the user that changes will be lost if not |
| | saved using “save changes” button. The user can choose |
| | “cancel” to cancel action, return to page, and save data or |
| | “OK” to continue, lose data, and leave the page. |
| Clear Values 85 | Select this button to undo any changed information typed into |
| | a field(s) on a data entry page and return to the same page. A |
| | message will appear warning the user that changes will be lost |
| | if not saved using “save changes” button. The user can choose |
| | “cancel” to cancel action, return to page, and save data or |
| | “OK” to continue, lose data, and return to the page. |
| Detail Page Icons | |
| Detail 86 | Select this icon to view more detailed information about a |
| Note: Selecting this icon opens a | record. The user can view the record but not enter data. |
| new read-only window | |
| Add 87 | Select this icon to add a new item. Upon selection, a detail |
| | page will open providing the user with data entry fields and |
| | relevant actions. |
| Insert Date 88 | Select this icon to insert a date in a date field. To insert date, |
| Note: User can also type in date | use arrows in month header to scroll from month to month and |
| in field. If an invalid format is | select the correct date. |
| entered, an error message appears. | |

Some detail pages employ the use of tabs to allow for secondary navigation. For example, the Reporting Entities functional area of screen 70 contains both General information 71 and Cross-Referencing Entity information 72 tabs. These two groupings of information are displayed in their own tabs 71, 72.

Referring to FIG. 2, shown therein is an exemplary embodiment of a screen shot 20 that is displayed when the user clicks on the system administration menu item 28 and selects the first sub menu item—manage users 29. The left side of screen 20 includes the main menu 21, which includes menu items—“System Administration” 28, “Inventories”, “Risk Assessments”, “Consolidated Ratings”, “Issues, Trends and Highlights”, “Issue Tracker”, “Generate Reports” and “Glossary.” Each of these menu items has various submenu items that are displayed when clicking on the menu item, as will be shown in subsequent figures. The list page 20 in FIG. 2 shows a list of users and some related information about each user, such as user ID 25, name 26, and email address 27.

Via screen 20, a user can create a new user and authorize various levels of access or edit an access level for an existing user. By clicking on the pencil icon 22 (i.e., the edit icon), the user opens up the user detail screen (e.g., 30, FIG. 3) for the particular user, in this case “AdminUser.” Each screen 20 for managing users is associated with a particular reporting entity, which can be modified by accessing drop down menu 23. Any previously entered reporting entity can be selected via drop down menu 23. New reporting entities are created via the Inventories menu item as will be shown with reference to FIG. 6. All users for a given reporting entity can be managed separately.

Turning to FIG. 3, within the user detail screen 30, the reporting entity associated with a given user can be modified via field 3). Other data associated with a given user can be modified as shown in FIG. 3, such as username 32, first name 33, last name 34, email address 35, type of user 36, reporting entity 31, and country 37, which is selectable from a drop down menu. Once edited, the changes can be saved or cancelled in the normal manner.

Turning to FIG. 4, shown therein is the Reference Data Manager screen 40, which is accessed by clicking on the manage reference data link 41 on the submenu underneath the System Administration menu heading. Clicking on the link for Approval Frequencies 42 opens screen 50 in FIG. 5. Each of the data categories can be accessed by clicking on the associated edit icon. The categories of data may include, for example: Approval Frequencies, Authority Status, Business Unit (BU) Categories, BU Roles, Business Units, Compliance Obligation Elements, Contact Rules, Countries, Customer Categories, Entity Categories, Glossary, Issue Audit Dispositions, Issue Categories, Issue Difficulties, Issue General Priorities, etc.

FIG. 5 depicts a screen 50 for managing the approval frequencies within the organization. In this example, there are three times when an approval is required—annually, when the data is revised and other. Each of these can be edited via screen 50 or a new approval frequency can be established via screen 50 using the create button 52. For each approval frequency, there is a code 53, a description 54, a display order 55, an activated date 56 and a deactivated date 57. Any of these values can be edited by clicking on the editing icon as described above.

If the user navigates to the Inventories link (68, FIG. 6) and selects the Reporting Entities sub-category 44, the Reporting Entities list page 60 will appear. If the user selects the pencil icon 69 to edit or view data, the General Tab page 70 opens displaying descriptive information about the selected or primary reporting entity, such as ID number 79, business category 73, principal location of operations (inside window 75), relationships (in section 76) and approximate gross revenue (in section 81, FIG. 8).

As depicted in FIG. 7, the Cross-Referencing Entities Tab 72 is shown in grey at the top right of the page. After the Cross-Referencing Entities Tab 72 is selected, it becomes the active tab (see element 96, FIG. 9) showing information about entities cross-referenced to the primary entity from the General Tab 92. The active tab is shown in dark blue (e.g., element 96, FIG. 9), while the inactive tab (element 92 is shown in grey.

Comprehensive information about each record, for viewing or editing (depending on a user's authorization described previously), is displayed on detail pages. Detail pages are accessible through a functional area's list page.

There are two ways to view or edit a record from a list page applicable to both read-only users and data entry users. The user can select the “pencil” icon 69 for a particular list item, which will open the detail page for that record allowing the user to edit data for that item if authorized, or view detailed information about that item. The second way to view or edit a record from a list page is to type in a list item's ID number into the Jump To ID: field 67 (FIG. 6) on the top right of the list page and select Go. This section will open the detail page for that record for editing data, if authorized, or viewing detailed information about that item.

Additionally, to create a new list item on a list page (applicable to data entry users only), the user can select Create New 63 (FIG. 6). Selecting this button 63 opens a detail page requiring data entry to create a new record.

The types of data entry fields and basic instructions for completing those fields are shown in Table 4 below.

TABLE 4

| Type of Data | |
|---|---|
| Entry Fields | Basic Instructions |
| Read-only | |
| Data Entry | Type in requested information |
| Drop-down | Select drop down arrow to choose one listed item, or |
| Menu | choose “other” at the bottom of a list of items and type |
| | in an unlisted item in the blank text box to the right of |
| | the drop-down menu |
| Check Box | Select a check box(es) to place a check mark in the |
| | appropriate item(s). To remove a check mark, select the |
| | check box again. |
| Enter Date | Select “calendar” icon. Use arrows in month header to |
| | scroll from month to month and select the correct date. |
| | Or type in date in field. If an invalid format is entered, |
| | an error message appears. |

Inventories

This section provides a brief explanation of the purpose of the Inventories link and describes each functional area, or sub-category, within the link. The Inventories link 68 (FIG. 6) provides the user with a building block approach to build an inventory of information needed for conducting a risk assessment(s). The sub-categories of the Inventories link (i.e., “Reporting Entities” 44, “Products and Services” 45, “Associated Unit Areas” 46, “Compliance Obligations” 47 and “Contacts” 48) are designed to identify all the necessary compliance-related risks, and key elements mitigating those risks, for entities monitored by compliance professionals and recorded in the system.

Each Inventories sub-category 44-48 contains data that will be linked and compiled collectively, as appropriate, during the risk assessment process. Data entered into the system includes various components associated with compliance-related risks for one or more reporting entities. For example, the Reporting Entities sub-category 44 captures information about each entity monitored by a compliance professional. The Products and Services sub-category 45 contains information about all products and services offered by all reporting entities monitored by a compliance professional. The Compliance Obligations sub-category 47 describes the compliance requirements of any and all reporting entities monitored by a compliance professional.

By capturing a cross-section of components, meaningful risk assessments can be performed. After the information featured above and other relevant data is completed, risk assessments may be conducted and results reviewed by the compliance or business professional authorized to do so.

Each sub-category 44-48 of the Inventories link and the navigation of each functional area are described in detail below.

To enter the Inventories functional area after logging on to the system, select the Inventories link 68 listed vertically on the left side 21 (FIG. 2) of the screen (e.g., 20). When a user selects the Inventories link 68 (FIG. 6), a drop-down menu appears listing each functional area 44-48, or sub-category, of the link. By selecting a sub-category 44-48, its appropriate list page will appear, i.e., screens 60 (FIG. 6), 100 (FIG. 10), 15 (FIGS. 15-16), 170 (FIG. 17) and 200 (FIG. 20).

Three sub-categories within this link contain components required to identify the most basic compliance-related risks. These sub-categories are: (1) Reporting Entities 44 (FIG. 6); (2) Products and Services 45 (FIG. 6); and (3) Compliance Obligations 46 (FIG. 6).

Reporting Entities

Screen 60 in FIG. 6 can be accessed by clicking on the Inventories menu heading 68, which opens and displays the submenu items, and then selecting Associated Reporting Unit Areas 44. The submenu under Inventories 68 includes the following items: Reporting Entities, Products and Services, Associated Unit Areas 44, Compliance Obligations, Contacts and Risk Mitigating Elements. Each of these will be described in subsequent figures.

Via screen 60 a user can edit or create an associated unit area/reporting entity. Once created, other data elements can then be associated with an associated reporting entity/unit area. For each associated reporting entity/unit area, there is an identification number 64, a name 65 and an operations location 66. A new reporting entity can be associated with a given reporting entity (i.e., the working reporting entity 62) by clicking on the create button 63. The working entity 62 is displayed via drop down menu, via which another working entity can be selected for display. Clicking on the edit icon for a given reporting entity as described above, such as reporting entity 1, opens screen 70 in FIG. 7. Using the jump to button 67 a user can enter the identification number 64 for a given reporting entity, which then opens a screen for that reporting entity, such as shown in FIG. 7. Alternatively, one can access the reporting entity by clicking on the reporting entities sub menu item 78 underneath the Inventories menu item.

The Reporting Entities functional area 60 shown in FIG. 6 contains identifying information about individual reporting entities. Some of the reporting entities data may be pre-populated into the system. Users authorized for data entry provide as much additional information on the Reporting Entities detail pages as possible. Possible additional information needed includes the following: Business category (a non-exhaustive list is included, which is accessible via drop down menu 73); Immediate parent (which is accessible via a drop down menu 76a; Principal location of operations 75a; Approximate annual gross revenues 81a and/or assets 81b; and Contact information 81c for the compliance and business professionals with responsibility for the unit.

Four fields in the Reporting Entities functional area warrant further explanation. These fields are Immediate Parent 76a; Cross-Reference to Primary Entity 76b; Assessing Reporting Unit (ARU); and Consolidated Reporting Unit (CRU) 76d. All of these fields appear in the General Tab detail page 71 under the group titled Relationships 76. Knowledge of and correct completion of these fields are critical to accurate and meaningful risk assessment results. The two sample organization charts depicted below in FIGS. 5 and 6 will be used to explain these fields.

FIG. 56 is used to describe the Immediate Parent and Cross-Reference to Primary Entity fields. This cross-reference field is used to avoid redundancies if, within a corporate structure, more than one reporting entity presents the identical risk profile to another from a compliance risk perspective.

In the sample organization chart above, the ABC Holding Company 561 is the Immediate Parent of the three real estate investment trusts (562, 563, 564) shown below it. The Immediate Parent refers to the organization that is directly above a given reporting entity in the organizational hierarchy.

In the above example, ABC Holding Company 561 contains three multiple real estate investment trusts (REITs) 562-564: REIT 1 (562) is the primary or lead reporting entity 562; REIT 2 (563) and REIT 3 (564) are secondary reporting entities. In this case a full risk assessment for each REIT would be unnecessarily repetitive. In this example, each REIT would be recorded individually as a reporting unit in the Reporting Entities functional area. However, additionally, REIT 2 (563) and REIT 3 (564) would include a cross-reference to REIT 1 (562) (the primary entity) in their respective individual records. This primary and secondary cross-reference approach may also be used when one or more reporting entities do not operate functionally apart from each other, such as those entities arising from legacy licenses and/or charters for companies that have been completely integrated without having legally disposed of the corporate identity. This cross-reference information is needed for performing consolidated risk ratings, which are explained in more detail below.

FIG. 57 is used to explain the designations of Assessing Reporting Unit (ARU) 76c and Consolidated Reporting Unit (CRU) 76d. Identifying a unit as an ARU indicates that the unit will be risk assessed against specific compliance obligations. In the sample organization chart in FIG. 57, Units two 572 and three 573 would be designated as ARUs because they engage directly in activities to be risk assessed against compliance obligations specific to their activities.

Units may also be identified as CRUs 76d, in which risk ratings are assigned through a consolidated review of the component ratings compiled from two or more ARUs based on categories and sub-categories; of compliance obligations, rather than on specific obligations. From a corporate governance perspective, both compliance and business concurrence professionals monitoring a reporting unit (in this case ABC Bank—Unit one 571) should review and assess their unit's compliance risk on a consolidated basis addressing the individual unit's activities (Unit one 571) as well as those of its subsidiary units (Units two 572, three 573, and four 574).

To meet the goals of determining ABC Bank's 571 risk profile as: (1) a discrete entity with operational divisions; and (2) collectively with its subsidiary entity, ABC Bank 571 should be considered a CRU in two contexts. One is a consolidation of all subsidiary units of a CRU (Units two 572, three 573, and four 574) whether they are operational divisions or subsidiary divisions. The second is a consolidation of a sub-set of operational units (Units two 572 and three 573).

Reporting Entities List Page

After selecting Reporting Entities/Units 44 (FIG. 6), a list page 60 appears displaying summary information of all entities recorded in the system. The summary information included for each listing consists of an ID number 64, entity name 65, and its operations location 66. The summary information displayed on the list page 60 is derived from a more detailed account of the entity captured on the Reporting Entities detail pages 70 (FIG. 7) described below.

On page 60, the user can perform the following list page actions: Create New; Jump To ID—Go; Edit or View; and Delete as has been described. A user's authorization determines whether a selection is editable or read-only.

Reporting Entities Detail Pages

Within screen 70 of FIG. 7, there are two tabs—General 71 and Cross-Referencing Entities 72. In FIG. 7, the General tab 71 is opened. There is a business category associated with the reporting entity, which can be selected from drop down menu 73, which opens a list of default categories. A user can also create a new business category, if the correct business category does not exist. A corporate ID is associated with the reporting entity and an indication is made as to whether the reporting entity is a legal entity or not by clicking on box 74. The operational status of a reporting entity can be made ACTIVE or INACTIVE, as desired,

The fields within box 75 enable one to enter data regarding the reporting entity's locations/reporting line. For example, the reporting entity's principal city of operations, principal state/province of operations, country of incorporation, licensing country and reporting line country type can be edited within box 75. Drop down menus are provided for certain of these data items.

Fields in box 76 enable the user to designate relationships that the reporting entity has with other entities, such as selecting an immediate parent, from a drop down menu. Essentially, this enables the user to create an electronic organizational chart in a database. By using these entry screens a highly complex organization can be defined in a manner that enables one or more users to manage various aspects of the organization, including but not limited to risk and/or compliance risk. Certainly other aspects of the organization could be managed via the resulting database, such as budgets, personnel, performance, etc.

Selecting the cross reference to a primary entity enables the user to cross reference data from a primary entity to simplify data entry for reporting entities that are the same or similar to other reporting entities. This reduces the data entry requirements for organizations that have large numbers of similar units, but which must each be tracked separately.

FIG. 8 shows the lower portion of screen 70. Portion 81 enables the user to enter data regarding the gross revenue, assets, an information as of date, a compliance contact, a business contact and general comments. Additionally, in box 82 the user can indicate the level of High Risk Geography Information, as none, minimal (less than 5%) or significant (more than 5%).

After selecting the “pencil” icon 69 on the Reporting Entities list page 60 for editing or viewing, a Reporting Entities detail page 70 opens. There are two detail pages within the Reporting Entities sub-category delineated with tabs: Tab 1—General 71; Tab 2—Cross-Referencing Entities 72. The General lab 71 is the default tab, after selecting the edit/view icon 69 on the Reporting Entities list page 70.

The General Tab 71 presents descriptive information about the selected, or primary, reporting entity such as ID number 79, business category 73, principal location of operations 75, and approximate gross revenue 81a. FIGS. 7-8 show an example of the Reporting Entities/Units General Tab detail page 70.

The user can perform the following detail page actions in the General Tab 71: Save Changes; Cancel; Clear Values; Detail; Add; and Insert Date. A user's authorization determines whether a selection is editable or read-only.

Table 5 presents a description of each field in the Reporting Entity Detail Page General Tab 71.

TABLE 5

| Name | Type | Description |
|---|---|---|
| CRA Reporting | read-only | Identification number of reporting entity |
| Entity Number | | |
| Reporting | data entry | Name of reporting entity |
| Entity/Unit | | |
| Business Category | drop- | |
| | down | |
| | menu | |
| Corporate ID | drop- | Corporate identification number |
| | down | |
| | menu | |
| Operational Status | drop- | |
| | down | |
| | menu | |
| Legal Entity | check box | |

Locations/Reporting Line

| | | |
|---|---|---|
| Principal City of | data entry | Reporting entity's principal city of |
| Operations | | operations |
| Principal | drop- | Reporting entity's principal state or |
| State/Province of | down | province of operations |
| Operations | menu | |
| Primary Country | drop- | Reporting entity's primary country |
| of Operations | down | of operations |
| | menu | |
| Country of | drop- | Reporting entity's country of |
| Incorporation | down | incorporation |
| | menu | |
| Licensing Country | drop- | |
| | down | |
| | menu | |
| Reporting Line | drop- | |
| Country Type | down | |
| | menu | |

Relationships

| | | |
|---|---|---|
| Immediate Parent | drop- | |
| | down | |
| | menu | |
| Cross Reference to | drop- | |
| Primary Entity | down | |
| | menu, | |
| | plus i | |
| Assessing | check box | |
| Reporting Unit | | |
| Consolidating | check box | |
| Reporting Unit | | |
| Approx. Gross | Data entry | Approximate money amount of the |
| Revenue | | reporting entity's gross revenue |
| Approx. Assets | Data entry | Approximate money amount of the |
| Information As of | Date | reporting entity's assets |
| Date | | |
| Compliance | drop- | |
| Contact | down | |
| | menu, | |
| | plus i, | |
| | plus + | |
| Business Contact | drop- | |
| | down | |
| | menu, | |
| | plus i | |
| Comments | Data entry | Additional comments, if needed |

High Risk Geography Information

| | |
|---|---|
| Select level of | check one |
| HRG Operations | |

Referring to FIG. 9, shown therein is an example of the Cross-Referencing Entities Tab 96. The Cross-Referencing Entities Tab 72 (shown open as screen 90 in FIG. 9) provides the name 93 and operational location 94 of entities cross-referenced to the primary entity featured in the General Tab 92. The detail icon 95 can be selected to view more detailed information about a particular cross-referenced entity.

FIG. 9 shows screen 90 with the Cross-Referencing Entities tab 96 opened and the General Tab 92 closed. Screen 90 displays the name 93 and the operational location 94 of all cross-referenced entities In this example, this figure shows that Reporting Entity Three is cross-referenced to Reporting Entity One, which is the working entity 91.

Products and Services

Turning to FIG. 10, shown therein is a screen 100 depicting the Products and Services functional area, which captures information about the products and services associated with any and all reporting entities monitored by a compliance professional. There are three general categories used for recording required information about a product or service offered by one or more reporting entities. These general categories are separated into three tabs. The first tab—Description Tab 112 (FIG. 11)—captures basic identifying information about a product or service. The second tab—General Categorization Tab 113 (FIG. 11)—displays a generic product list used to classify the product or service. The third tab—High Risk Geography Details Tab 114 (FIG. 11)—captures the geographical risk level of the customers of each reporting entity associated with the product or service identified in the Description Tab 112 (FIG. 11). The High Risk Geography Details Tab 114 (FIG. 11) also captures the geographical risk level of the transactions of each reporting entity associated with the product or service identified in the Description Tab 112 (FIG. 11).

FIG. 11 shows the products/services detail screen 110 for Product One 109, in which the user can select related reporting entities from drop down menu 111 and add it by clicking on the adjacent “Add Selected Reporting Entity” button. Two tabs—Description 112 and General Categorization 113 are provided. FIGS. 11-12 show screen 110 with tab 112 selected. FIGS. 13-14 show screen 110 with tab 113 selected. A field is provided to enter a description of the product/service. A list of product clients is provided, from which a user can designate all that apply. Examples include: Casinos, Consumers, Corporations, Domestic Banks, Domestic Securities Broker/Dealers, Foreign Banks, etc.

Next, global client and business unit categories can be designated. For example, the user can designate whether the product or service is offered by Business Unit Global Clients, by Business Unit Private Clients, with Business Unit Global Markets, with Business Unit Transaction Banking, or with Business Unit Asset Management. Next, the user can designate the AML risk (low, medium, high) and the geographic AML risk (low, medium, high). Finally, as shown in FIG. 12, which is the continuation of screen 10, the following question is answered with respect to the given product/service: “Does the product/service meet any of the following criteria?

(1) Generally marketed to any U.S. parties regardless of location;

(2) Offered/provided in conjunction with any U.S. operations of the Bank or other U.S. third parties;

(3) Likely to be purchased by any U.S. parties; or

(4) Likely to transit the U.S. or any U.S. parties.” Also, a general comment field is provided, in which a user can enter any comments desired.

Products and Services List Page

After selecting Products and Services 45 (FIG. 6), a list page 100 (FIG. 10) appears displaying summary information of each product and service offered by all entities included in the inventory. The summary information included for each listing consists of an ID number 104, product name 108, and its description 106. The summary information displayed on the list page is derived from a more detailed account of the product captured on the Products and Services detail pages 110 (FIGS. 11-12) described below. FIG. 10 provides an example of the Products and Services list page 100.

The user can perform the following list page actions: Create New; Jump To ID—Go; Edit or View; and Delete. A user's authorization determines whether a selection is editable or read-only.

Products and Services Detail Page

Turning to FIG. 11, after selecting the “pencil” icon 69 on the Products and Services list page 100 (FIG. 10) for editing or viewing, a Products and Services detail page 110 (FIG. 11) opens. There are three detail pages within the Products and Services sub-category delineated with tabs: Tab 1—Description 112; Tab 2—General Categorization 113; and Tab 3—High Risk Geography Details 114. The Description tab 112 is the default tab, after selecting the edit/view icon 101 on the Products and Services list page 100. The active tab's heading is dark blue (see element 112, FIG. 11) while the inactive tab's heading is grey (see elements 113, 114).

Description Tab

Referring to FIG. 11, the Description Tab 112 presents detailed information about a product or service provided by a particular reporting entity. Its fields are described in detail below in Table 7.

The user can perform the following detail page actions in the Description Tab: Save Changes; Cancel; and Clear Values. A user's authorization determines whether a selection is editable or read-only.

Table 5 presents a description of each field in the Products and Services Detail Page 110 Description Tab 112.

TABLE 6

| Name | Type | Description |
|---|---|---|
| CRA Product | Read-only | Identification number of product |
| Number | | |
| Product/Service | Data entry | Name of product or service |
| Name | | |
| Related Reporting | Drop- | |
| Entities | down | |
| | menu | |
| Brief Description | Data entry | Description of product or service |
| Product Client(s) | Drop- | |
| | down | |
| | menu | |
| Global Client and | Check box | |
| BU Categories | | |
| AML Risk | Drop- | |
| | down | |
| | menu | |
| Geographic AML | Drop- | |
| Risk | down | |
| | menu | |
| Meet Criteria | Check box | [from database meaning that we can |
| question | | rely on “four”?] |
| Comments | Data entry | Additional comments, if needed |

General Categorization Tab

The General Categorization Tab 121 (shown opened in FIGS. 12-13) presents a generic product list used to categorize a product or service. All categories that apply to the product or service recorded in the Description Tab 112 should be selected on the product list. Some products and services may not fit into one of these categories. If there is not a reasonable link between the product inventoried and the generic product list, no category should be selected. To complete this tab, the user checks as many boxes as apply. To remove a check, the user selects the check box again.

The user can perform the following detail page actions in the General Categorization Tab 121: Save Changes; Cancel; and Clear Values. A user's authorization determines whether a selection is editable or read-only.

FIGS. 13-14 show the various categories of products and services with which a given product or service can be associated by clicking on the check box next to each category. More than one can be selected. Under the category of Administrative Services and Other Fee Business, the following products/services are listed: Safe Deposit Boxes; Traveler's Checks; Trust, which includes: Administrative Services (Trust), Fiduciary Services (Trust) and Management Services (Trust); and Research, which includes: Equity Research and Financial Market Research.

Under the category of Consulting and Advisory, the following products/services are listed: Corporate Finance and Advisory Services, which includes: Corporate Finance Advisory Services, Debt Advisory, Financial Engineering, and Mergers and Acquisitions and Advisory Services; and Employee Benefits.

Under the category of Financing, the following products/services are listed: Lending Products, which includes: Asset Securitization, and Collateralized Debt Obligation; Commercial Loans, which includes: Asset-Based Loan, Bridge Loan, Commercial Real Estate Loan, Money Market Loan, Revolving Loan, Roll-over Loan, Term Loan, Consumer Home Mortgages, Consumer Personal Loans, Credit Card Loans, Factoring Services, Leases, Leveraged Finance, and Repurchase Agreement; and Structured Finance, which includes Commodity Finance, Project Finance and Advisory, and Structured Trade Finance.

Under the category of Investment, the following products/services are listed: Asset Management, which includes: Global Mutual Fund, Local Mutual Fund, Segregated DPM Mandate, and Segregated Institutional Mandate; Bonds and Other Fixed Income, which includes: Bond, Commercial Paper, Fixed Income Origination and Syndication, Floating Rate Note, Medium-Term Note, and Treasury Bills; Commodity-Based Products, which includes Precious Metals; Deposits, which includes: Deposits and Money Market Accounts; Equity, which includes: Convertible Bonds, Equity Origination and Syndication, and Stocks or Shares; Private Equity, which includes: Buy Out and Venture Capital; Savings Accounts; and Security Services, which includes: Custody Services, Securities Clearing Services, Securities Execution Services, Securities Lending, and settlement Services.

Under the category of Management of Financial Risks, the following products/services are listed: Derivatives; which includes Cap, Floor, Forward, Futures, Options, Swap, and Warrant; Foreign Exchange (ForEx) Services; Guarantees, which includes Non-trade related guarantees, and trade related guarantees; and Insurance Services, which includes Capital Insurance, Damage Insurance, and Life Insurance.

Under the category of Payments, the following products/services are listed: Cash and Liquidity Management, which includes, Cash Management Services and Liquidity Management Services; Payment Accounts, which includes current accounts; Payments and Collections, which includes, Cash Payment Services, Collection Services, and Electronic Payment Services; and Treasury services.

High Risk Geography Tab

The High Risk Geography Tab 141 shown opened in FIG. 14 captures the geographical risk level of the customers of each reporting entity associated with the product or service identified in the Description Tab 112. This screen 140 also captures the geographical risk level of the transactions of each reporting entity associated with the product or service identified in the Description Tab 112. FIG. 14 shows an example of the Products and Services High Risk Geography Tab detail page 140 followed by Table 7 describing its fields in detail.

TABLE 7

| Name | Type | Description |
|---|---|---|
| Reporting Entity | Read-only | Identification on number of reporting |
| Number | | entity |
| Level of HRG | Select one | |
| Customers | | |
| Selected HRGs | | |
| Number of | Data entry | |
| Customers in HRGs | | |
| Total Number of | Data entry | |
| Customers | | |
| Comment | Data entry | Additional comments, if needed |
| Level of HRG | Select one | |
| Transactions | | |
| Selected HRGs | | |
| Number of | Data entry | |
| Transactions in | | |
| HRGs | | |
| Total Number of | Data entry | |
| Customers | | |
| Value of | Data entry | |
| Transactions in HRG | | |
| Per Year | | |
| Total Value of | Data entry | |
| Transactions Per | | |
| Year | | |
| Comment | Data entry | Additional comments, if needed |

The user can perform the following detail page actions in the High risk Geography Tab 140: Save Changes; Cancel; and Clear Values. A user's authorization determines whether a selection is editable or read-only. Table 7 presents a description of each field in the Products and Services Detail Page: High Risk Geography Details Tab 140.

Associated Unit Areas

The Associated Unit Areas functional area shown in FIG. 15 should be completed if the compliance risk within an entity is focused on a specific unit area rather than on particular product or service line. For example, a law may require that the board of an entity formally adopt or ratify specific policies and procedures, such as an anti-money laundering compliance program. Such an obligation is not affiliated with any particular product or service, but should be risk assessed, monitored, and controlled appropriately.

Unit Areas List Page

After selecting Associated Unit Areas 46 (FIG. 6) in the main menu, a list page 150 appears displaying a brief description of each unit area. The system is pre-populated with twelve unit areas: (1) Corporate Secretary Function/Board of Directors; (2) EU Affairs and Market Infrastructure; (3) Executive Team; (4) Group Audit; (5) Group Communications; (6) Group Compliance and Legal; (7) Group Finance; (8) Group Risk Management; (9) Group Shared Services; (10) Investor Relations; (11) Physical Security; and (12) Strategy and New Products. Additional unit areas may be added as needed using the Create New button 151 at the top left of the list page 150. Editing information about an individual unit area recorded on the list page is done on the Associated Unit Areas detail page 160 (FIG. 16). FIG. 15 below displays an example of the Associated Unit Areas list page 150.

The user can perform the following list page actions: Create New; Edit or View; and Delete. A user's authorization determines whether a selection is editable or read-only.

Unit Areas Detail Page

After selecting the “pencil” icon 152 on the Unit Areas list page 150 for editing or viewing, the Unit Area detail 160 page opens containing two data entry fields shown below in Table 8.

TABLE 8

| | | |
|---|---|---|
| Name | Type | Description |

| | |
|---|---|
| Area | Data entry |
| Description | Data entry |

The user can perform the following actions in the Unit Area detail page: Save Changes; Cancel; and Clear Values. A user's authorization determines whether a selection is editable or read-only.

Compliance Obligations

The Compliance Obligations link 47 (FIG. 6) is used to record each compliance obligation. Examples of compliance obligations records are: an individual item, such as a subsection of a regulation; or, when appropriate, a combination of distinct items that can be grouped by citation in regulation or law.

Compliance Obligations List Page

After selecting Compliance Obligations 46 (FIG. 6), a list page 170 (FIG. 17) appears showing summary information of compliance requirements. The summary information included for each listing consists of an ID number 171, two levels of categorization 172, 173 for the compliance requirement, the appropriate citation 174, and the related title 175. The summary information displayed on the list page 170 is derived from a more detailed account of the obligation captured on the Compliance Obligations detail page 180 (FIG. 18). See FIG. 17 an example of the Compliance Obligations list page 170.

The user can perform the following list page actions: Create New; Jump To ID—Go; Edit or View; and Delete. A user's authorization determines whether a selection is editable or read-only.

Compliance Obligations Detail Page

After selecting the “pencil” icon on 176 the Compliance Obligations list page 170 for editing or viewing, the Compliance Obligations detail page 180 (shown in FIGS. 18-19) opens.

The user can perform the following actions in the Compliance Obligations detail page 180: Save Changes; Cancel; and (Clear Values. A user's authorization determines whether a selection is editable or read-only.

Table 9 presents a description of the Compliance Obligations Detail Page 180 fields.

FIGS. 18-19 depict screen 180 that is displayed when selecting the editing icon in screen 170. Screen 180 enables the user to enter and store information regarding the compliance obligation, such as for example, the citation, title, description/key components, source/promulgating authority, country, status, rule type, and date entered. Using this screen a user can also check whether there are certain related elements to this compliance obligation, such as training and record keeping for the given compliance obligation. Additionally, the user can indicate to which category the compliance obligation belongs, under dealing with customers, market conduct, Internal compliance system & controls, and anti-money laundering. Within each of these four categories, there are multiple subcategories.

For example, under Dealing with customers, one of the following categories can be selected: anti-discrimination, charges and pricing, client assets, client confidentiality, communication and marketing, conflicts of interest (company/customers), disclosure obligations, escheatment/dormant accounts, suitability and valuation.

For example, under Market Conduct, one of the following subcategories can be selected: Conflicts of Interest (Company/Market), insider trading, market abuse.

For example, under Anti-money laundering, one of the following subcategories can be selected: client identification and verification, risk assessment, enhanced due diligence, and client acceptance, AML monitoring and reporting, and transaction filtering.

For example, under Institutional Compliance Systems and Controls, one of the following subcategories can be selected: Business continuity, Compliance Oversight/Supervision, Conflicts of Interest (Internal), Regulatory Permissions/Licensing, and Systems Integrity.

A general comment field is also provided, into which a user can input any desired comments.

TABLE 9

| | | |
|---|---|---|
| Name | Type | Description |

| | |
|---|---|
| CRA Compliance | Read-only |
| Obligation Number | |
| Citation | Data entry |
| Title | Data entry |
| Description/Key | Data entry |
| Components | |
| Source/Promulgating | Data entry |
| Authority | |
| Status | Drop-down |
| | menu |
| Country | Drop-down |
| | menu |
| Rule Type | Drop-down |
| | menu |
| Date Entered | Data entry or |
| | [date select] |
| Related Elements | Check box |
| Categorization | Check one |
| Comments | Data entry |

Contacts

Turning to FIG. 20, the Contacts functional area is where contact information is provided for any relevant contacts needed during the risk assessment process. It includes contact information for the compliance user, compliance approval user, business concurrence user, and others.

Contacts List Page

After selecting Contacts 201, a list page 200 appears displaying summary information of each relevant contact person. The summary information included for each listing consists of a contact's name, title, company name, email address, and telephone number. The summary information displayed originates from a more detailed description of each contact contained on the Contacts detail page 210 (FIG. 21). FIG. 20 is an example of the Contacts list page 200.

The user can perform the following list page actions: Create New; Edit or View; and Delete. A user's authorization determines whether a selection is editable or read-only.

Contacts Detail Page

After selecting the “pencil” icon on the Contacts list page for editing or viewing, the Contacts detail page 210 (FIG. 21 opens showing additional identifying information about a contact person.

The user can perform the following actions in the Contacts detail page: Save Changes; Cancel; and Clear Values. A user's authorization determines whether a selection is editable or read-only.

Table 10 presents a description of the Contacts Detail Page 210 fields.

TABLE 10

| | | |
|---|---|---|
| Name | Type | Description |

| | |
|---|---|
| First Name | Data entry |
| Last Name | Data entry |
| Title | Data entry |
| Company | Data entry |
| Department | Data entry |
| Street Address | Data entry |
| City | Data entry |
| State/Province | Data entry |
| Postal Code | Data entry |
| Country | Data entry |
| Email Address | Data entry |
| Telephone Number | Data entry |
| Comments | Data entry |

Risk Mitigating Elements

Upon selecting Risk Mitigating Elements 225 in the main menu item, a subcategory of menu items opens, showing Reporting Entities Policies and Procedures 226, Training 227, Corporate Manuals 228 and Document 229.

Reporting Entity Policies and Procedures

Reporting Entity Policies and Procedures List Page

After selecting Reporting Entity Policies and Procedures 226, a list page 220 appears showing summary information of policy citations and related reporting entities. The summary information included for each listing consists of an ID number 221, the name of the related reporting entity 222, and the citation name 223 and title 224. The summary information displayed on the list page 220 is derived from a more detailed account of the citation captured on the Reporting Entity Policies and Procedures detail page 230 (FIG. 23).

The user can perform the following list page actions: Create New; Jump To ID—Go; Edit or View; and Delete. A user's authorization determines whether a selection is editable or read-only.

Reporting Entity Policies and Procedures Detail Page

After selecting the “pencil” icon on the Reporting Entity Policies and Procedures list page 220 for editing or viewing, the Reporting Entity Policies and Procedures detail page 230 opens displaying more specific information about a citation as well as approval requirements and dates of approval. See FIG. 23 for an example of the Unit/Entity Policies and Procedures detail page 230.

The user can perform the following actions in the Reporting Entity Policies and Procedures detail page: Save Changes; Cancel; and Clear Values. A user's authorization determines whether a selection is editable or read-only. Table 11 presents a description of the Unit/Entity Policies and Procedures Detail Page 230 fields.

TABLE 11

| | | |
|---|---|---|
| Name | Type | Description |

| | |
|---|---|
| CRA Policy | Read-only |
| Number | |
| Citation | Data entry |
| Title | Data entry |
| Type | Drop-down menu |
| Related Reporting | Drop-down menu |
| Entity | |
| Last Updated | Insert date |
| Related Corporate | Drop-down menu |
| Manual | |
| Board Approval | Check box 233 |
| Required | |
| Date of Approval | Insert date 234 |
| Frequency of | Drop-down menu |
| Approval | 235 |
| Next Approval | Insert date 236 |
| Required | |
| Comments | Data entry 237 |

Training

The Training functional area captures information about training programs completed by the employees of entities monitored by compliance professionals. Training programs that increase employees' awareness and understanding of their organization's compliance obligations is related to the quality of risk management.

Training List Page

After selecting Training 227 (FIG. 22), a list page 240 (FIG. 24) appears showing summary information of training courses completed by employees of reporting entities. The summary information included for each listing consists of an ID number 241, title 242 and start date of training course 243. The summary information displayed originates from a more detailed description of the training programs included on the Training detail page 250 shown in FIG. 25.

The user can perform the following list page actions: Create New; Jump To ID—Go; Edit or View; and Delete. A user's authorization determines whether a selection is editable or read-only.

Training Detail Page

After selecting the “pencil” icon on the Training list page for editing or viewing, the Training detail page 250 (FIGS. 25-26) opens displaying more complete information about a training course.

The user can perform the following actions in the Training detail page 250: Save Changes; Cancel; and Clear Values. A user's authorization determines whether a selection is editable or read-only. Table 12 presents a description of the Training Detail Page 250 fields.

TABLE 12

| | | |
|---|---|---|
| Name | Type | Description |

| | |
|---|---|
| CRA Training | Read-only |
| Number | |
| Title | Data entry |
| Author(s) | Data entry |
| Instructor(s) | Data entry |
| Materials As of Date | Insert date |
| Start Date | Insert date |
| End Date | Insert date |
| Type of Training | Drop-down |
| | menu |
| Required | Check box |
| Test | Check box |
| Audience | Data entry |
| Testing/Validation | Data entry |
| Method | |
| Categorization | Check box |
| Responsible | Check box |
| Office(s)/Group(s) | |
| Comments | Data entry |

Corporate Manuals

Corporate Manuals List Page

After selecting Corporate Manuals 228 (FIG. 22), a list page 270 appears showing summary information. The summary information included for each listing consists of the manual's name, number, and manual title, and the date it was inventoried. The summary information displayed on the list page 270 is derived from a more detailed account of the manual captured on the Corporate Manuals detail page 280 shown in FIG. 28. FIG. 27 shows an example of the Corporate Manual Inventory list page 270.

The user can perform the following list page actions: Create New; Edit or View; and Delete. A user's authorization determines whether a selection is editable or read-only.

Corporate Manuals Detail Page

After selecting the “pencil” icon on the Corporate Manuals list page 270 for editing or viewing, the Corporate Manuals detail page 280 opens showing additional identifying information. FIG. 28 displays an example of the Corporate Manual Inventory detail page 280.

The user can perform the following actions in the Corporate Manuals detail page: Save Changes; and Cancel. A user's authorization determines whether a selection is editable or read-only.

The table 13 presents a description of the Corporate Manual Inventory Detail Page 280 fields.

TABLE 13

| | | |
|---|---|---|
| Name | Type | Description |

| | |
|---|---|
| Citation | Data entry |
| As of Date | Insert date |
| Date Inventoried | Insert date |
| Title | Data entry |
| Translations | Check box |
| Available | |
| Comments | |

Documents

Documents List Page

After selecting Documents 229 (FIG. 22), a list page 290 appears showing a list of document titles. The information displayed on the list page is derived from a more detailed account of each document captured on the Documents detail page 300 shown in FIG. 30. FIG. 29 provides an example of the Documents list page 290.

The user can perform the following list page actions: Create New; Edit or View; and Delete. A user's authorization determines whether a selection is editable or read-only.

Documents Detail Page

After selecting the “pencil” icon on the Documents list page 290 for editing or viewing, the Documents detail page 300 opens displaying additional information about each document. FIG. 30 shows an example of the Documents detail page 300.

The user can perform the following actions in the Documents detail page: Save Changes; Cancel; and Clear Values. A user's authorization determines whether a selection is editable or read-only. Table 14 presents a description of the Documents Detail Page fields 300.

TABLE 14

| | | |
|---|---|---|
| Name | Type | Description |

| | |
|---|---|
| Title | Data entry |
| Source | Data entry |
| As of Date | Insert date |
| Date Provided | Insert date |
| Comments | Data entry |

Risk Assessments

Having completed the inventories, the user proceeds to the risk assessment stage.

Turning to FIG. 31, shown therein is the screen 310 displayed upon selecting “Risk Assessments” 311 from the main menu. Screen 310 displays a table that includes a risk assessment for each reporting entity 313. The table includes: a risk assessment identification number 314, a compliance obligation 315 and an assessment date 316. New risk assessments can be created via screen 310 as well. Clicking on the editing icon in the normal manner opens screen 320 shown in FIGS. 32-33.

For a given reporting entity 324, screen 320 displays the risk assessment information for a particular risk assessment labeled with an identification number 325. The citation 321 on which the risk assessment is based is selectable, as well as the reporting entity 322. Screen 320 includes three tabs: general 323 (shown in FIG. 32), related items (340, FIG. 34) and evaluations (350, FIGS. 35-36).

Turning to FIG. 33, which shows the bottom portion of screen 320, any products related to the risk assessment can be selected via drop down menu 331. Table 337 lists the products previously selected for the given risk assessment. Via drop down menu 332 the user can select unit areas or related entities subject to the obligation for which the risk assessment is being conducted. In this example, there are none, but if so, a table would be displayed similar to table 337 but listing the related entities/unit areas. Using drop down menus 334 and 333, the user can select a compliance: contact and business contact, respectively. A contact can also be added at this place. The user can also select a risk assessment date 335 and a concurrence date 336. A general comments field is provided.

Turning to FIG. 34, shown there is screen 340 with the related items tab 341 opened. Screen 340 enables the user to view/edit the related corporate manuals, the reporting unit/entity policies and procedures, training and contacts.

FIG. 35 shows the screen 350 with the evaluations tab opened. Here the user can select (high, medium, low) the likelihood of breach via drop down menu 342. The user may also select the volume of activity 353, the nature of the activity 354, the complexity of the activity 355, the change in activity 356, and the history of problems 357. The system determines the inherent risk rating 352 based on the matrix in Table 15 below and the values entered in the likelihood of breach 342 and the impact 361 fields in screen 360:

TABLE 15

| Inherent Risk | | Likelihood | | |
|---|---|---|---|---|
| Matrix | | Low | Medium | High |
| Impact | High | M | H | H |
| | Medium | M | M | H |
| | Low | L | M | M |

Description of Exemplary Risk Assessment Methodology

The following describes an exemplary embodiment of a risk assessment methodology using the previously described system as applied to Anti-Money Laundering (AML) and the procedures by which it is implemented and maintained over time.

The result is a consolidated risk assessment for an exemplary bank by category of BSA/AML compliance obligation. In addition to this consolidated risk assessment, individual risk assessments are available for each of the units within the bank that were included in the risk assessment.

2. Roles & Responsibilities

a. BSA Compliance Contacts

BSA Compliance Contacts are responsible for completing the risk assessment(s) for the reporting entity or entities for which they are the designated BSA Compliance Contacts. This responsibility includes the following:

Ensuring that the inventory information about the BSA Compliance Contact is complete and accurate

Ensuring that the inventory information about the Reporting Entity for which the BSA Compliance Contact is responsible is complete and accurate;

Ensuring that the inventory information includes all products and services that the Reporting Entity offers, that information about the products and services is complete, and that the products and services offered by the Reporting Entity are identified as such in the database;

Completing the risk assessment for each applicable obligation with respect to the products and services offered by the Reporting Entity;

Reviewing the consolidated risk assessments for the BSA Contact's Reporting Entity; and

Seeking assistance from BSA Compliance if they do not understand a particular compliance obligation or whether it is applicable to their Reporting Entity.

BSA Compliance Contacts may delegate some or all of these responsibilities to colleagues in their Reporting Entity.

b. Business Concurrer

The Business Concurrer is an employee other than the person who completes the risk assessments for the Reporting Entity. In most cases, it will be the BSA Compliance Contact's manager. The Business Concurrer is responsible for reviewing and concurring with each individual risk assessment relevant to that reporting entity. The Business Concurrer is responsible for reviewing the consolidated risk assessments for his reporting entity. Where the BSA Compliance Contact has delegated his or her responsibilities to another person, the BSA Compliance Contract may play the role of Business Concurrer.

c. Risk Assessment Administrator

The Risk Assessment Administrator administers the database in which the risk assessments reside. He or she administers access rights for users of the tool. He or she also controls access to “reference” data, which determines various parameters within the risk assessment database. The Risk Assessment Administrator, or his or her delegate, also performs quality assurance on the database.

3. Process

d. Inventory Reporting Entities (Legal and Non-Legal Entities).

Reporting Entities are legal or non-legal entities that comprise the bank. During implementation, the Risk Assessment Administrator reviewed each of the Reporting Entities that were the subject of the previous risk assessment to determine whether or not they should be included in the next Risk Assessment. Reasons for excluding a Reporting Entity from the next Risk Assessment include sale or closure of the Reporting Entity or a determination that the Reporting Entity identified on the previous Risk Assessment should be assessed as a component of another, larger risk assessment. In addition, the Risk Assessment Administrator sought the opinion of the BSA Compliance Officer as to what other Reporting Entities should be included in the next Risk Assessment. In addition, each of the BSA Compliance Contacts was free to further divide his or her Reporting Entity into multiple Reporting Entities when he or she believed that this would lead to a more accurate assessment.

e. Inventory Products and Services

AML Risks vary by product and service. Accordingly, the Risk Assessment includes an inventory of products and services offered by the bank. Feedback from BSA Contacts indicated that this included some actions, like account servicing items, which were not products or services offered to customers in a traditional sense. Accordingly, these were removed. Other feedback indicated that the list could be simplified. For example, the many different types of DDA accounts could be captured with two general product descriptions, DDA Personal and DDA Business. The next Risk Assessment uses this simplified list of products and services.

In addition, BSA Contacts were free to add products and services that in their judgment needed to be added in order to conduct an accurate risk assessment. In this way, the next Risk Assessment Process started with the best available inventory of products and services, simplified that list based on BSA Contact feedback, and then allowed BSA Contacts to add to the list any missing products or services.

Each product and service must be mapped to a generic product and service category. This is so that risks may be compared across similar products with different names or descriptions. Generic products and services are assigned default AML risk ratings based on guidance in the FFIEC BSA/AML Examination Manual.

The products and services are kept current pursuant to the Periodic Review process. For each product that is associated with a Reporting Entity, the BSA Contact, or his or her delegate, is prompted for additional information about high-risk customer types and high-risk geographies. In addition to high-risk foreign geographies, the bank considered domestic geographies identified as High Intensity Drug Trafficking Areas or High Intensity Financial Crimes Areas as high-risk geographies. Following the guidance in the FFIEC BSA/AML Examination manual, Reporting Entity/Product Combinations are afforded a low customer risk default score only if the Reporting Entity offers the Product to no high or medium risk customer categories. If the Reporting Entity offers the product to at least one medium risk customer category but to no high-risk customer categories, the Reporting Entity/Product combination receives a default customer risk score of medium. If the Reporting Entity offers the Product to at least one high-risk customer category, the Reporting Entity/Product combination receives a default customer risk score of high.

Reporting Entity/Product combinations receive a low default geographic risk score only if they have no operations, customers, or transactions in high-risk geographies. They receive a default score of medium if they have some, but less than 5%, of their operations, customers or transactions in a high-risk geography. They receive a default score of high if they have 5% or more of their operations, customers, or transactions in a high-risk geography.

f. Inventory Compliance Obligations

The Risk Assessment is conducted with respect to specific BSA/AML compliance obligations. Additionally, compliance obligations are mapped to categories of BSA/AML compliance obligations. This allows risks to be compared across obligations that have similar purposes, but different citations. For example, SAR reporting requirements for banks and SAR reporting requirements for broker dealers are mapped to the same category of compliance obligation, “Transaction Monitoring & Reporting.”

g. Assess Risk

Using the inventoried information, BSA Contacts assess the risk of violating particular BSA/AML compliance obligations for their Reporting Entity, with respect to identified products and services. BSA Contacts use guidance on assessing inherent risk and quality of risk management to produce a residual risk rating.

h. Consolidate Risk Assessments

The risk assessment methodology automatically consolidates individual risk assessments into consolidated residual risk assessments for each Reporting Entity. Automatic consolidation is done using a conservative, “weakest link” approach. That is, a default consolidated rating is assigned that is equal to the highest underlying risk assessment for that category of compliance obligation. For example, if the residual risk of violating the SAR reporting requirement for banks was medium, but the residual risk of violating the SAR reporting requirement for broker dealers was high, the residual risk rating would be high.

BSA Contacts and Business Concurrers may depart from the automatically consolidated risk assessments. If BSA Contacts and Business Concurrers wish to depart from these consolidated ratings, they must review the consolidated ratings and explain the reason for the departure. There are many legitimate reasons for making a departure. For example, a consolidated risk assessment could have a rating of high based on the weakest link approach even though the vast majority of consolidated ratings were low. Under such circumstances, the BSA Contact and the Business Unit Concurrer might reasonably conclude that the automatically assigned rating does not reflect the true rating. They may then assign a new rating, but they must document their reason for the change. The original, automatically assigned rating is retained for purposes of maintaining a complete audit trail.

4. Quality Assurance

The risk assessment is subject to quality assurance by the Risk Assessment Administrator. The Risk Assessment Administrator may correct obvious typographical errors in the risk assessment. The Risk Assessment Administrator may also make changes to accommodate technological upgrades in the risk assessment software, so long as the changes do not affect the resulting risk assessment. Any changes that impact the risk assessment must be made by the BSA Compliance Contact and concurred on by the Business Concurrer.

5. Periodic Review

To maintain enhanced due diligence of the BSA/AML Risk Assessment the BSA Risk Assessment Administrator will:

Contact the Reporting Entity's BSA Compliance Contact quarterly to determine if there has been a change in products, services, customers, geographic locations, and/or history of problems that warrant a re-assessment of the Reporting Entity's risk profile.

Review internal and/or external audit/examination reports for BSA/AML Compliance as necessary to determine if the findings, management response, and/or corrective action taken impact the risk profile of the Reporting Entity, the Bank, and/or the Corporation.

If a change has occurred, the BSA Risk Assessment Administrator will work with the Business Unit Compliance Contact to re-assess the risk to maintain an up-to-date risk assessment. An updated overall risk assessment report of the bank/corporation will be generated and distributed to management. If there is a change in the risk profile, Management will determine if it warrants changes to the bank/corporation BSA/AML Compliance Program in order to manage the risk.

6. Audit Trail

The system audits the activity of the users by capturing the user ID that creates and/or updates the following items:

Inventory items,

Risk Assessments;

Consolidated Ratings; and

Issues, Trends, and Highlights

The application also captures the creation timestamp and last updated timestamp for the listed items. This auditing information is stored in the SQL Server database.

Exemplary Method for Assessing Inherent Risk, the Quality of Risk Management, and Residual Risk

Referring to FIGS. 35-36, to complete the risk assessments in the system, the user must determine the inherent risk (also known as quantity of risk), and the quality of risk management 362. Once these are determined, the system automatically calculates residual risk 363. This guidance is intended to assist the user in making determinations of inherent risk 364 and quality of risk management 362.

Inherent Risk

Inherent risk 364 is a function of likelihood 342 and impact 361. Each of these is addressed in turn.

Rating the Likelihood of a Compliance Violation

To derive the overall assessment of likelihood, compliance contacts must provide information regarding each of the following factors:

Volume and scale of activity 353

Nature of activity 354

Complexity of activity and/or compliance obligation 355

Change in activity and/or compliance obligation 356

History of problems 357

Each of these five factors may be rated Low, Medium, or High. More detail on each of these five factors and how to rate them follows:

Volume and Scale of Activity

Volume of activity 353 includes the number of transactions, the number of impacted accounts, or the number of customer relationships. Scale of activity reflects the value of transactions and/or the number of employees involved in the activity.

Low—the volume and scale of activity to which the compliance obligation applies is a small and discrete portion of the reporting entity's business, customers, employees, processes or systems.

Medium—the volume and scale of activity to which the compliance obligation applies to a significant, but not a major, portion of the reporting entity's business, customers, employees, processes or systems.

High—the volume and scale of activity to which the compliance obligation applies to all or a major portion of the reporting entity's business, customers, employees, processes or systems.

Note: It is very important to provide detailed comments about the volume and scale of the activity. This information should be provided in the comments field next to the volume rating. Volume information should include such things number of transactions, number of relationships, number of accounts, dollar value of transactions, etc. However, it is expected that the specific volume information provided by any particular unit will differ from unit to unit.

Nature of Activity

Nature of activity 354 factor includes whether the activity is a high profile activity that is likely to draw significant regulatory or public attention, even if it is only a small portion of the reporting entity's activities. It also includes whether the activity presents special risks of a violation.

For example, providing investments to pensioners presents a higher risk of violating suitability obligations. As another example, providing banking services to Money Services Businesses (non-bank check cashers, money transmitters, currency exchanges, or casas de cambio) may present higher risk of violating anti-money laundering requirements.

Low—there is little, if any, interest in the activity or the compliance obligation by regulators, the media, or consumer advocacy groups.

Medium—there is interest in the activity or the compliance obligation by regulators, the media, or consumer advocacy groups, but the activity or the compliance obligation stops short of being a top priority of regulators, media, or consumer advocacy groups.

High—the activity or the compliance obligation is a top priority of regulators, media, or consumer advocacy groups.

When assessing the inherent risk of a violation of anti-money laundering obligations, the nature of the activity 354 will require consideration of the products and services that are subject to the obligation, the type of customers to show those products and services are provided, and the geographies involved. The database provides a default rating of high for each of these factors. In order to arrive at a lower rating, the user must complete assessments for the Products and Services, Customers and Entities; and Geography as set forth below.

Products and Services

The following is an excerpt from the FFIEC BSA/AML Examination Manual concerning high-risk products:

Products and Services

Certain products and services offered by banks may pose a higher risk of money laundering or terrorist financing depending on the nature of the specific product or service offered by the bank. Such products and services may facilitate a higher degree of anonymity, or involve the handling of high volumes of currency or currency equivalents. Some of these products and services are listed below, but the list is not all inclusive:

Electronic funds payment services—electronic cash (e.g., stored value and payroll cards), funds transfers (domestic and international), payable upon proper identification (PUPID) transactions, third party payment processors, remittance activity, automated clearing house (ACH) and automated teller machines (ATMs).

Electronic banking

Private banking—both domestic and international

Trust and asset management services

Monetary Instruments

Foreign correspondent accounts—pouch activity, payable through accounts, and U.S. dollar drafts.

International trade finance (letters of credit).

Special use or concentration accounts.

Nondeposit account services (e.g., nondeposit investment products, insurance and safe deposit boxes).

If the bank has conducted an inventory of the products and services it offers and has assigned each of those products a rating for AML risk based on characteristics of the product or service, whether the product or service is offered to high risk customers or customers for whom there is little KYC data, and the volume of the transactions conducted under that product type, reference should be made to these ratings when completing the product/service, customer, and geography portion of the risk assessment.

The Products & Services component of the nature rating should be low, medium, or high, based on the following guidance:

Low—none of the products or services that are subject to this risk assessment are medium or high risk.

Medium—at least one of the products or services that is subject to this risk assessment is medium risk and any high risk products and services that are subject to this risk assessment comprise less than 5% of the volume and value of the reporting entity's business.

High—high risk products and services that are subject to this risk assessment comprise 5% or more of the volume and value of the reporting entity's business.

Customers and Entities

The FFIEC BSA/AML Manual contains the following guidance on high-risk customer types:

Although any type of account is potentially vulnerable to money laundering or terrorist financing, by the nature of their business, occupation or anticipated transaction activity, certain customers and entities may pose specific money laundering risks. However, it is essential that banks exercise judgment and neither define nor treat all members of a specific category of customer as posing the same level of risk. In assessing customer risk, it is essential that banks also factor other variables, such as services sought, source of funds and geographic location. Within any category of business, there will be accountholders that pose varying levels of risk of money laundering. The expanded sections provide detailed guidance and discussions on specific customers and entities that are detailed below:

Foreign financial institutions, including banks and foreign money service providers (e.g., casas de cambio, exchange houses, money transmitters, and bureaux de change).

Non-bank financial institutions (e.g., money services businesses, casinos and card clubs, brokers/dealers in securities, and dealers in precious metals, stones or jewels).

Senior foreign political figures and their immediate family members and close associates (collectively known as politically exposed persons (PEPs)).

Nonresident alien (NRA) and accounts of foreign individuals.

Foreign corporations with transaction accounts, particularly offshore corporations (such as Private Investment Companies (PICs) and international business corporations (IBCs) located in high-risk geographic locations).

Deposit brokers, particularly foreign deposit brokers.

Cash intensive businesses (e.g., convenience stores, restaurants, retail stores, liquor stores, cigarette distributors, privately-owned ATMs, vending machine operators, and parking garages).

Non-governmental organizations and charities (foreign and domestic).

Professional service providers (e.g., attorneys, accountants, doctors, or real estate brokers).

The FFIEC BSA/AML Manual contains the following guidance on high-risk customer types:

The Customers and Entities component of the nature rating should be low, medium, or high, based on the following guidance:

Low—none of the Customers and Entities for the products or services that are subject to this risk assessment are medium or high risk.

Medium—at least some of the Customers and Entities for the products or services being offered is medium risk and any high risk Customers and Entities for the products and services comprise less than 5% of the volume and value of the reporting entity's business.

High—high risk Customers and Entities for the products and services comprise 5% or more of the volume and value for those products and services.

Geography

The AML Compliance intranet site contains a list of high-risk geographies. It is importing to note that high risk geographies can be foreign countries and territories or domestic regions of the United States that have been identified as High Intensity Financial Crimes Areas (HIFCAs) or High Intensity Drug Trafficking Areas (HIDTAs). It is important to specify which high risk geographies your reporting entity(ies) operates in. In addition, it is important to specify whether your reporting entity(ies) has any customers that are domiciled in a high risk geography and, if so, how many such customers you have.

Finally, it is important to recognize that products and services may involve high-risk geographies even if the reporting entity does not operate in the geography and even if no customers are domiciled there. For example, lending products may involve properties located in high-risk geographies, even if the customer is not domiciled there.

As another example, letters of credit or wire transfers may involve transactions with counterparties in high-risk geographies. Accordingly, it is important to indicate whether your reporting unit has transactions involving high-risk geographies and, if so the number of such transactions and the dollar value of such transactions.

The Geography component of the nature rating should be low, medium, or high, based on the following guidance:

Low—the reporting entity has no operations in a high-risk geography, no customers in a high-risk geography, and no transactions involving a high-risk geography.

Medium—less than 5% of the reporting entity's operations, customers, or transactions (by both volume and value) are in or involve a high-risk geography;

High—5% or more of the reporting entity's operations, customers, or transactions (by both volume and value) are in or involve a high-risk geography.

Complexity

Complexity 355 includes the operational complexity of the activity and/or the complexity of the compliance obligation.

Low—the activity is routine and widely understood by employees and the compliance obligation is simple and transparent.

Medium—the activity or compliance obligation is relatively complex, not widely understood by employees, and requires occasional input by subject matter experts.

High—the activity or compliance obligation is highly complex, understood fully by only a small number of employees, and requires frequent input by subject matter experts.

Change

Change 356 includes the degree of change in the activity and/or the compliance obligation.

Low—the activity is unchanged or reduced from previous rating periods and the compliance obligation has not changed.

Medium—the activity is growing or the compliance obligation is changing.

High—the activity is growing unexpectedly or as a result of a special strategic focus and/or the compliance obligation has undergone major revisions or reinterpretations.

History of Problems

History of problems 357 includes the feedback track record with regard to compliance matters over a meaningful time series (not just the prior year). Feedback includes customer complaints, internal and external audit feedback, regulatory citations or examination criticisms, and prior compliance issues from monitoring and testing.

Low—few, if any, isolated, non-recurring issues and problems, including violations or citations.

Medium—more than a few issues and problems, including violations or citations, but not critical, pervasive, or persistent issues and problems.

High—critical, pervasive, or persistent issues and problems including regulatory or legal criticism or actions.

Overall Likelihood Assessment

Based on the factors entered above, the user should make an overall assessment of likelihood that corresponds to the following ratings.

Low—The nature and small volume of the activity in the Business Unit limit the potential exposure to regulatory violations. The rules that apply to the activity have been in place for many years and regulators are not subjecting this area to special scrutiny. There have been few, if any, rule violations and none have resulted in limitations on the Bank's ability to pursue the activity. Customer complaints and litigation occur infrequently, if at all.

Medium—The nature and/or volume of the activity in the Business Unit may increase the potential for regulatory violations. Some of the compliance requirements that apply may be somewhat complex, however, the rules are generally well-established and regulators have not voiced specific concern about this type of activity. Some violations may be outstanding, but they are correctable in the normal course of business without causing substantive financial loss to the Business Unit or the Bank.

No violations have resulted in limitations on the Bank's ability to pursue the activity. Customer complaints and litigation occur occasionally.

High—The nature and/or volume of the activity in the Business Unit significantly increase the potential for serious or frequent violations of rules. The requirements that apply may be complex and open to interpretation. Regulators may be focusing special attention on this type of activity and may have recently instituted new rules covering it.

The Business Unit may have incurred serious and/or numerous rule violations related to the activity and some may have resulted in limitations on the Bank's ability to pursue the activity. Customer complaints and litigation occur frequently.

Rating the Impact of a Compliance Violation

Impact 361 may be of a legal, reputational, or financial nature. Loss histories from previous violations may be a guide to impact, as may observations of the impact of public violations on other institutions. CCRs should apply the following definitions to estimate the potential impact of a compliance failure:

Low—There is little chance that a compliance failure related to the activity could damage the Business Unit's earnings, capital, or reputation. The potential cost of failing to satisfy the rules that apply will have only minor impact on the Business Unit's future earnings.

Medium—Compliance failures can be addressed within the normal range of loss experience for the activity and will not reduce the Business Unit's anticipated earnings to any significant extent or reduce its capital level. As well, these violations do not seriously damage the Bank's reputation or reduce its Bank's business opportunities.

High—Violations have the potential to reduce significantly the Business Unit's anticipated earnings and reduce its capital level. These violations could seriously harm the Bank's reputation and could result in the Bank losing business opportunities. These costs could be the result of fines, penalties, or restitution that regulators impose and/or from the cost of litigation.

Calculating Inherent Risk

Likelihood 342 and impact 361 can be combined to form an assessment of inherent compliance risk 364 as shown in Table 15:

The software used to conduct the compliance risk assessment will automatically calculate inherent risk 364 based on the ratings supplied by the CCRs for likelihood 342 and impact 361 in accordance with Table 15.

Evaluating the Quality of Risk Management

The quality of risk management 362 is an estimate of the ability of existing controls to reduce the probability of a compliance violation occurring or to reduce the impact of a violation, should it occur.

The quality of risk management 362 may be Satisfactory or Needs Improvement. The definitions of Satisfactory and Needs Improvement are:

Satisfactory—Business Unit management effectively addresses key aspects of compliance risk. Management takes appropriate actions in response to compliance issues or regulatory changes. Compliance management systems and information processes are adequate to avoid significant or frequent violations of rules.

Management provides sufficient resources to do the job and factors in compliance considerations into product and systems development. The relevant management and staff have the appropriate level of awareness of the underlying compliance risk and/or related risk management measures.

Needs Improvement—Business Unit management does not effectively address key aspects of compliance risk. Management is not anticipating or taking timely and appropriate actions in response to compliance issues or regulatory changes.

Compliance management systems and information processes are generally deficient. Management often does not factor in compliance considerations into product and systems development. There is a lack of awareness of the underlying compliance risk and/or related risk management measures at the management and/or staff levels.

The quality of risk management will be based upon a review of documented policies and procedures, identified related training, the historical effectiveness of the controls, the professional judgment of the Compliance staff, and the input from the Business Unit management.

Calculating Residual Risk

Residual Risk 363 is the risk that remains after consideration of the Quality of Risk Management 362 on mitigating Inherent Risk 364. Residual 363 may be Low, Medium, or High. Inherent Risk and the Quality of Risk Management 362 can be combined to produce Residual Risk 364 as shown in Table 16:

TABLE 16

Quality of Risk
Management

| Residual Risk | | | Needs |
|---|---|---|---|
| Matrix | | Satisfactory | Improvement |
| Inherent Risk | High | Medium | High |
| | Medium | Low | Medium |
| | Low | Low | Medium |

The software to conduct the compliance risk assessment will automatically calculate residual risk 363 based on the ratings of inherent risk and the quality of risk management 362.

Issues, Trends and Highlights

Turning to FIG. 37, shown therein is the Issues, Trends and Highlights list page 370, which is opened upon clicking on the link 37 by the same name. Via this screen 370, the user can create issues 372, and track issues by ID number 373, title 374, whether the issues are closed or not 375, and the date entered 376. Clicking on the pencil icon opens page 380 in FIGS. 38-39.

Detail Issues page 380 enables the user to enter data regarding the related reporting entity 381 related to the entered issue, and the person who reported the issue 382. A risk trend 383 can be set as upward or downward or unchanged. Field 388 enables the user to enter a description of the issue. Field 377 enables the user to enter information as to the activity taken to resolve the issue. Field 378 enables the user to enter information as to the next steps to resolve the issue. FIG. 39 shows the bottom portion of screen 380. The user can also enter the date the issue was entered by selecting the calendar 391, if the issue is closed 392, the date the issue was closed 393, and who closed the issue 394.

Turning to FIG. 40, shown therein is the Reporting Entities/Units Generate Reports list page 400, which is opened by clicking on the Generate Reports link 401 in the main menu and selecting Reporting Entities 402 underneath in the subcategory of menu items. Using this screen 400, the user can either generate a report across all reporting entities by clicking on link 403 or generate a report for a single reporting entity by entering a reporting entity number in field 404 or selecting a reporting entity from the list opened in drop down menu 405. FIG. 41 shows an example of a report 410 generated for a single reporting entity.

Turning to FIG. 42, shown therein is the Product Generate Reports list page 420, which is opened by clicking on the Generate Reports link 401 in the main menu and selecting Products and Services 421 underneath in the subcategory of menu items. Using this screen 420, the user can either generate a report across all products and services by clicking on link 422 or generate a report for a single product or service by entering a product or service number in field 423 or selecting a product or service from the list opened in drop down menu 424. FIG. 43 shows an example of a report 431) generated for a single product.

Turning to FIG. 44, shown therein is the Compliance Obligations Generate Reports list page 440, which is opened by clicking on the Generate Reports link 401 in the main menu and selecting Compliance Obligations 441 underneath in the subcategory of menu items. Using this screen 440, the user can either generate a report across all compliance obligations by clicking on link 442 or generate a report for a single compliance obligation by entering a compliance obligation number in field 423 or selecting a compliance obligation from the list opened in drop down menu 444. FIGS. 45-46 show an example of a report 450 generated for a single compliance obligation.

Turning to FIG. 47, shown therein is the Contacts Generate Reports list page 470, which is opened by clicking on the (Generate Reports link 401 in the main menu and selecting Contacts 471 underneath in the subcategory of menu items. Using this screen 470, the user can either generate a report across all contacts by clicking on link 472 or generate a report for a single contact by selecting a contact from the list opened in drop down menu 473. FIG. 48 shows an example of a report 480 generated for a single contact.

Turning to FIG. 49, shown therein is the Reporting Entities Policies and Procedures Generate Reports list page 490, which is opened by clicking on the Generate Reports link 401 in the main menu and selecting Reporting Entities Policies and Procedures 491 underneath in the subcategory of menu items. Using this screen 490, the user can either generate a report across all policies and procedures by clicking on link 492 or generate a report for a single policy or procedure by entering a policy or procedure number in field 493 or selecting a policy or procedure from the list opened in drop down menu 444. FIG. 50 shows an example of a report 500 generated for a single policy.

Turning to FIG. 51, shown therein is the Training Generate Reports list page 510, which is opened by clicking on the (Generate Reports link 401 in the main menu and selecting Training 511 underneath in the subcategory of menu items. Using this screen 510, the user can either generate a report across all trainings by clicking on link 512 or generate a report for a single training by entering a training number in field 513 or selecting a training from the list opened in drop down menu 514. FIG. 52 shows an example of a report 520 generated for a single policy.

Turning to FIG. 53, shown therein is the Corporate Manuals Generate Reports list page 530, which is opened by clicking on the Generate Reports link 401 in the main menu and selecting Corporate Manuals 531 underneath in the subcategory of menu items. Using this screen 530, the user can generate a report across all corporate manuals by clicking on link 532.

Turning to FIG. 54, shown therein is the Risk Assessments Generate Reports list page 540, which is opened by clicking on the Generate Reports link 401 in the main menu and selecting Risk Assessments 541 underneath in the subcategory of menu items. Using this screen 540, the user can either select a report across all risk assessments by clicking on link 542 or generate a report for a single risk assessment by entering a risk assessment number in field 543 or selecting a risk assessment from the list opened in drop down menu 544. FIGS. 55-57 show an example of a report 550 generated for a single risk assessment.

Turning to FIG. 58, shown therein is the Issues, Trends and Highlights Generate Reports list page 580, which is opened by clicking on the Generate Reports link 401 in the main menu and selecting Issues, Trends and Highlights 581 underneath in the subcategory of menu items. Using this screen 580, the user can either select a report across all issues, trends and highlights by clicking on link 582 or generate a report for a single issue, trend or highlight by entering an issue, trend or highlight number in field 583 or selecting an issue, trend or highlight from the list opened in drop down menu 584. FIG. 59 shows an example of a report 590 generated for a single issue.

Turning to FIG. 60, shown therein is an example of a Assessing Reporting Units Consolidated Ratings list page 600, which is displayed by clicking on Consolidated Ratings 601 in the main menu and selecting Assessing Reporting Units 602 in the subcategory of menu items. Screen 600 enables a user to input a reporting unit in field 603 and selecting a business category via drop down menu 604 and click on find matches 605 to display a reporting entity for which the user desires to enter ratings or modify them. So doing, opens screen 610 in FIGS. 61-62.

Screen 610 in FIGS. 61-62 includes four tabs 611-614, of which tab 611 is displayed in FIGS. 61-61. Screen 610 enables the user to enter a rating for a given reporting entity, identify the user, identify the business contact, identify the date of preparation (as of date), and enter the concurrence date. For each category (e.g., dealing with customers 615), there are subcategories to which ratings can be entered. A default rating 616 for each is displayed. An assigned rating 617 can be entered along with comments in field 618 for each subcategory. FIG. 62 shows the lower portion of screen 610.

FIG. 63 shows screen 630, which is the assessing reporting unit screen with tab 612 opened, which displays the cross-referenced entities/units to the selected reporting unit (working entity).

FIG. 64 shows screen 640, which is the assessing reporting unit screen with tab 613 opened, which shows key issues related to the selected reporting unit (working entity). This screen 640 displays the number (of upward trend issues, the number of stable trend issues and the number of downward trend issues. The current issues (both opened and closed) and deleted (both opened and closed) issues are displayed, whether the issue is opened or closed, along with the date entered. The total number of active issues can be added by clicking on the plus icon next to the number of active issues.

FIG. 65 shows screen 650, which is the assessing reporting unit screen with tab 614 opened, which shows the component risk assessments related to the selected reporting unit (working entity). This screen 650 displays the number of risk assessments 655 and for each risk assessment the associated compliance obligation 651 and its related rating for each of the Residual Risk 652, Inherent Risk 653 and Quality of Risk Assessment 654.

Turning to FIG. 66, shown therein is an example of a Consolidated Reporting Units Consolidated Ratings list page 660, which is displayed by clicking on Consolidated Ratings 601 in the main menu and selecting Consolidated Reporting Units 664 in the subcategory of menu items. Screen 660 enables a user to input a reporting unit in field 661 and selecting a business category via drop down menu 662 and click on find matches 663 to display a reporting entity for which the user desires to enter ratings or modify them. So doing, opens screen 670 in FIGS. 67-68.

Screen 670 in FIGS. 67-68 includes three tabs 671-673, of which tab 671 is displayed in FIGS. 67-68. Screen 670 enables the user to enter a rating for a given reporting entity, identify the user and identify the date of preparation (as of date). For each category (e.g., dealing with customers 674), there are subcategories to which ratings can be entered. A default rating 675 for each is displayed. An assigned rating 676 can be entered along with comments in field 677 for each subcategory. FIG. 68 shows the lower portion of screen 670.

FIG. 69 shows screen 690, which is the consolidated reporting unit screen with tab 672 opened, which shows key issues related to the selected reporting unit (working entity). This screen 690 displays the number of upward trend issues, the number of stable trend issues and the number of downward trend issues. The current issues (both opened and closed) and deleted (both opened and closed) issues are displayed, whether the issue is opened or closed, along with the date entered. The total number of active issues can be added by clicking on the plus icon next to the number of active issues.

FIGS. 70-71 show screen 700, which displays the consolidated reporting units ratings for all of the categories of compliance and the total number of high 674, medium 675 and low 676 ratings for each category. FIG. 71 shows the lower half of screen 700.

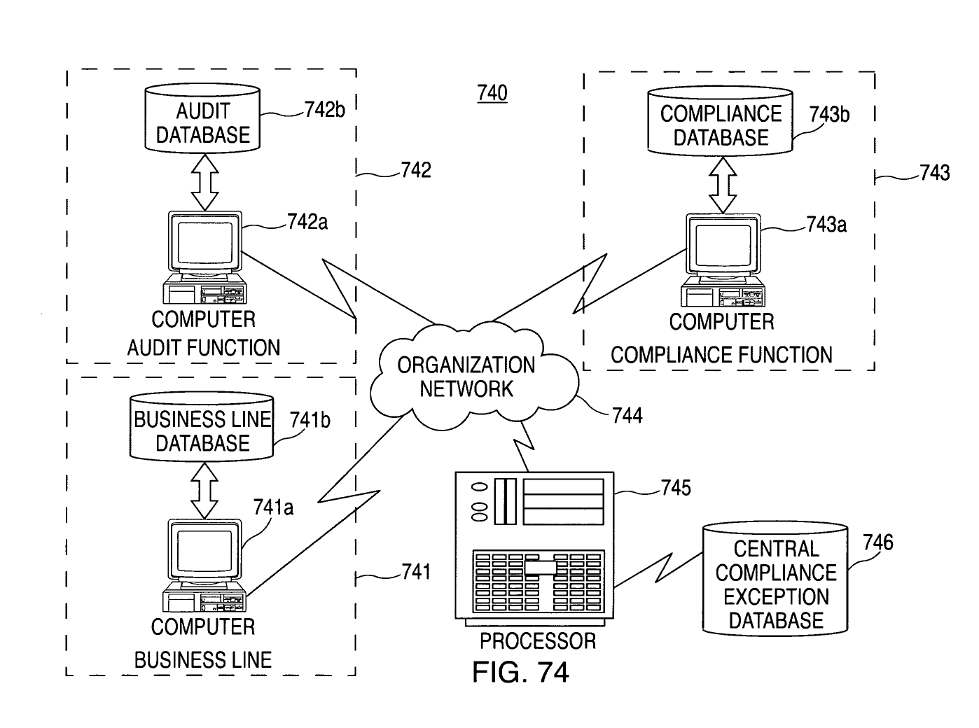

Turning to FIG. 74, shown therein is an exemplary embodiment 740 of an apparatus for implementing the above-described system. The embodiment 740 includes one or more computers 741a-743a, such as personal computers or workstations, coupled via a network 744 to a company-maintained central database 746 of compliance information that is accessible via a server or other processor 745. While one company-maintained database 746 is shown, this database is merely one possible implementation of a potential plurality of databases distributed throughout the organization that might contain data regarding compliance risks and organizational structure. For example, each business line 741 might maintain its own database 741b and each auditor function 742 or compliance function 743 might maintain its own database 742b, 743b, respectively, of compliance exceptions. Thus, database 746 might be comprised of multiple databases, from which data is pulled by or sent to a processor 745 to create the desired graphical displays. Thus, FIG. 74 shows both a central database 746 as well as databases controlled by various functions within the organization. Some or all of these databases 741b-743b, and 746 may contain records regarding compliance exceptions. Moreover, while only one business line 741, audit function 742 and compliance function 743 are depicted, these are merely representative as there could be multiple ones of each within a large organization.

In this embodiment 740, the computers 741a-743a can query the company-maintained database 746 via processor 745 to develop the graphical displays or implementations discussed in FIGS. 1-72, or, alternatively, the processor 745 can develop and maintain these displays and transmit them to the various computers 741a-743a as requested. Of course, these individual computers 741a-743a could query the other databases in the organization to develop their own graphical displays as desired. While only three computers 741a-743a are shown, the apparatus 740 is not limited to three or even as many as three computers. Any number of computers may be coupled to the network 744 and therefore to the database 746 and processor 745. Moreover, any standard computer, network, server and database may be employed to implement the methods discussed herein, as long as the computer is capable of displaying the screens shown in FIGS. 1-72 and the database is capable of maintaining the above described relationships between the various data elements described above.

The Compliance Risk Assessment (“CRA”) methodology can be implemented by means of a Compliance Risk Assessment Database (“CRAD”). Alternatively, a network-based implementation is also possible. The database could also be distributed across one or more networks thereby comprising multiple databases. In an exemplary embodiment, the database is designed using Microsoft Access 2003 or SQL. Other implementations are possible however without departing from the scope of the present invention.

Moreover, all the features disclosed in this specification (including any accompanying claims, abstract and drawings) and/or all of the steps or any method or process so disclosed, may be combined in any combination, except combinations where at least some of the steps or features are mutually exclusive. Each feature disclosed in this specification (including any claims, abstract and drawings) may be replaced by alternative features serving the same equivalent or similar purpose, unless expressly stated otherwise. Thus, unless expressly stated otherwise, each feature disclosed is one example only of a generic series of equivalent or similar features.

What is claimed is:

1. An apparatus for managing risk in an organization comprising:
a relational database to store data associated with the organization; and
a computer-based graphical user interface enabling a user to enter and store data in the relational database representing an inventory of the organization, wherein said inventory includes one or more reporting entities, one or more products or services and one or more compliance obligations, wherein at least one product or service of the one or more products and services is associated with at least one reporting entity of the one or more reporting entities and at least one compliance obligation of the one or more compliance obligations is related to said at least one product or service.

2. The apparatus according to claim 1, wherein said computer-based graphical user interfaces further enables the user to enter and store information defining said one or more reporting entities within the organization.

3. The apparatus according to claim 2, wherein said defining a reporting entity includes identifying another reporting entity within the organization as an immediate parent, if such exists.

4. The apparatus according to claim 2, wherein said defining a reporting entity includes cross-referencing the reporting entity to another reporting entity, which is a primary reporting entity, within the organization.

5. The apparatus according to claim 2, wherein said defining a reporting entity includes identifying the reporting entity as an assessing reporting unit, on which a risk assessment must be performed regarding one or more compliance obligations related to one or more products or services associated with the reporting entity.

6. The apparatus according to claim 5, wherein said defining a reporting entity includes identifying the reporting entity as a consolidating reporting unit, to which one or more risk ratings may be assigned through a consolidated review of one or more component ratings compiled from two or more assessing reporting units based on one or more categories of compliance obligations, rather than on one or more specific compliance obligations.

7. The apparatus according to claim 1, wherein said computer-based graphical user interface further enables the user to enter and store information defining said one or more products or services within the organization and relating each of said one or more products or services to one or more reporting entities within the organization.

8. The apparatus according to claim 1, wherein said computer-based graphical user interfaces further enables the user to enter and store information defining said one or more compliance obligations and relating at least one of said one or more compliance obligations to at least one of said one or more products or services.

9. The apparatus according to claim 5, wherein said graphical user interface further enables the user to enter and store data regarding a risk assessment performed on a particular compliance obligation of the one or more compliance obligations related to a particular product or service of the one or more products and services associated with a particular reporting entity of the one or more reporting entities.

10. The apparatus according to claim 9, wherein said risk assessment includes determining an inherent risk for said particular compliance obligation of the one or more compliance obligations related to a particular product or service of the one or more products and services associated with a particular reporting entity of the one or more reporting entities.

11. The apparatus according to claim 10, wherein said inherent risk is determined by defining a likelihood of a breach of the particular compliance obligation and an impact of a breach of the particular compliance obligation and determining the inherent risk based on the defined likelihood of breach and defined impact of breach.

12. The apparatus according to claim 10, wherein said risk assessment includes defining a quality of risk management for said particular compliance obligation.

13. The apparatus according to claim 12, wherein said risk assessment includes determining a residual risk based on the defined quality of risk management and the determined inherent risk.

14. The apparatus according to claim 9, wherein said computer-based graphical user interface further enables the user to review all risk assessments for a particular reporting entity that is defined to be an assessing reporting unit, and to assign a residual risk rating for each of one or more categories of compliance obligations related to the particular reporting entity.

15. The apparatus according to claim 9, wherein said computer-based graphical user interface further enables the user to review all risk assessments for a particular reporting entity that is defined to be a consolidating reporting unit, and to assign a residual risk rating for each of one or more categories of compliance obligations related to the particular reporting entity.

16. A method for managing risk in an organization comprising:
entering and storing data in a relational database defining one or more reporting entities within the organization;
entering and storing data in a relational database defining one or more products or services and associating each of the one or more products or services with at least one of the one or more reporting entities;
entering and storing data in a relational database defining one or more compliance obligations and associating each of the one or more compliance obligations with at least one of the one or more products or services; and
enabling a user to perform a risk assessment of a particular compliance obligation by assigning a risk rating to the particular compliance obligation of the one or more compliance obligations related to a particular product or service of the one or more products and services associated with a particular reporting entity of the one or more reporting entities.

17. The method according to claim 16, wherein said risk assessment includes determining an inherent risk for said particular compliance obligation.

18. The method according to claim 17, wherein determining the inherent risk includes:
defining a likelihood of a breach of the particular compliance obligation;
defining an impact of a breach of the particular compliance obligation;
determining the inherent risk based on the defined likelihood of breach and defined impact of breach; and
displaying the determined inherent risk.

19. The method according to claim 17, wherein said risk assessment includes:
defining a quality of risk management for said particular compliance obligation;
determining a residual risk based on the defined quality of risk management and the determined inherent risk; and
displaying the determined residual risk.

20. The method according to claim 16, further comprising:
displaying all risk assessments for a particular reporting entity that is defined to be an assessing reporting unit; and
enabling a user to assign a residual risk rating for each of one or more categories of compliance obligations related to the particular reporting entity.

21. The method according to claim 20, further comprising:
displaying all risk assessments for a particular reporting entity that is defined to be a consolidating reporting unit; and
enabling a user to assign a residual risk rating for each of one or more categories of compliance obligations related to the particular reporting entity.

22. The method according to claim 16, further comprising:
identifying an immediate parent among the one or more reporting entities, if existing, of each of the one or more reporting entities;
identifying a assessing reporting unit among the one or more reporting entities, on which assessing reporting unit a risk assessment must be performed regarding one or more compliance obligations related to one or more products or services associated with the reporting entity;
identifying a consolidating reporting unit among the one or more reporting entities, to which one or more risk ratings may be assigned through a consolidated review of one or more component ratings compiled from two or more assessing reporting units based on one or more categories of compliance obligations, rather than on one or more specific compliance obligations; and
cross-referencing a secondary reporting entity among the one or more reporting entities to a primary reporting entity among the one or more reporting entities.

23. An apparatus for managing risk within an organization comprising:
an enterprise builder module including a relational database and a processor coupled to the relational database, wherein the processor executes a graphical user interface to enable a user to enter and store data regarding one or more reporting entities within the organization;
a products and services catalog module coupled to the enterprise builder module and including a relational database and a processor coupled to the relational database, wherein the processor executes a graphical user interface to enable a user to enter and store data regarding one or more products or services within the organization and to associate each of the one or more products or services with at least one of the one or more reporting entities defined in the enterprise builder module;
a compliance obligation inventory module coupled to the products and services catalog module and including a relational database and a processor coupled to the relational database, wherein the processor executes a graphical user interface to enable a user to enter and store data regarding one or more compliance obligations and to relate each of the one or more compliance obligations to at least one product or service of the one or more products or services defined in the products and services catalog module; and
a compliance risk assessment module coupled to the enterprise builder module, the products and services catalogue module and the compliance obligation inventory module and including a relational database and a processor to:
conduct a risk assessment for unique combinations of products or services, compliance obligations and reporting units;
aggregate risk assessments over an entire reporting unit; and
consolidate risk assessments over multiple reporting units.
